(19) United States
(12) Patent Application Publication
(10) Pub. No.: US 2019/0196555 A1
(43) Pub. Date: Jun. 27, 2019

(54) MULTIPLE DONOR ANTENNA REPEATER

(71) Applicant: WILSON ELECTRONICS, LLC, St. George, UT (US)

(72) Inventors: Michael James Mouser, Wylie, TX (US); Patrick Lee Cook, Cedar City, UT (US); Christopher Ken Ashworth, St. George, UT (US); Casey James Nordgran, Washington, UT (US); Eddie F. Iglesias, Hurricane, UT (US)

(21) Appl. No.: 16/293,389

(22) Filed: Mar. 5, 2019

Related U.S. Application Data
(63) Continuation-in-part of application No. 16/011,475, filed on Jun. 18, 2018.
(60) Provisional application No. 62/521,103, filed on Jun. 16, 2017.

(51) Int. Cl. G06F 1/16; H04B 7/155

(52) U.S. Cl. CPC G06F 1/1698; G06F 1/1626; H04B 7/15542; H04B 7/15507; G06F 1/1632

(57) ABSTRACT

A repeater system including one or more donor antennas, one or more server antennas and a repeater integrated with a pole.

### RELATED APPLICATIONS

The present application is a continuation-in-part of U.S. patent application Ser. No. 16/011,475, filed Jun. 18, 2018 with a docket number of 3969-121.NP, which claims the benefit of U.S. Provisional Patent Application No. 62/521,103 filed Jun. 16, 2017 with a docket number of 3969-121.PROV, the entire specifications of which are hereby incorporated by reference in their entirety for all purposes.

### BACKGROUND

Wireless communication systems, such as cellular telephone systems, have become common throughout the world. A wireless repeater or booster is a radio frequency (RF) device used to amplify wireless communication signals in both uplink and downlink communication channels, as illustrated in FIG. 1. The uplink channel is generally referred to as the direction from one or more user equipment 110 to a base station 120. The downlink channel is generally referred to as the direction from the base station 120 to the user equipment 110. For a wireless telephone system, the base station 120 may be a cell tower, and the user equipment 110 may be a smart phone, tablet, laptop, desktop computer, multimedia device such as a television or gaming system, cellular internet of things (CIoT) device, or other types of computing device. The repeater 130 typically includes one or more signal amplifiers, one or more duplexers and/or couplers, one or more filters and other circuits coupled between two or more antennas. The antennas can include one or more user-side antennas 140 and one or more service-side antennas 150.

The repeater system may include a plurality of separate elements such as the antennas, cables, repeater unit and mounting elements for each, which can make installation complicated for users. In addition, constraints imposed by government agencies, industry standards, or similar regulatory entities may limit the amount of amplification (gain), the maximum output power, the output noise, and other parameters associated with the operation of the repeater. Therefore, there is a continuing need for improved wireless repeaters.

### DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1a depicts a wireless network repeater, in accordance with an example;

FIG. 1b is a perspective view of a cradle, with a user equipment (UE) removed from the cradle in accordance with an example;

FIG. 1c is a perspective view of a cradle, with a user equipment (UE) carried by the cradle in accordance with an example;

FIG. 1d is a schematic view of a repeater system in accordance with an example;

FIGS. 2a and 2b depict a repeater system, in accordance with an example;

FIGS. 3a and 3b depict a repeater system, in accordance with another example;

FIGS. 4a and 4b depict a repeater system, in accordance with another example;

FIGS. 5a and 5b depict a repeater system, in accordance with another example;

FIGS. 6a and 6b depict a repeater system, in accordance with another example;

FIG. 7 depicts a repeater system, in accordance with another example; and

FIGS. 8a, 8b and 8c depict a repeater system, in accordance with another example; and

FIG. 9 depicts a ratchet mount, in accordance with an example;

FIG. 10 illustrates a handheld booster in communication with a wireless device in accordance with an example;

FIG. 11 illustrates a wireless device in accordance with an example;

FIG. 12a illustrates a repeater with a receive diversity antenna port in accordance with an example;

FIG. 12b illustrates a multiband repeater with a receive diversity antenna port in accordance with an example;

FIG. 12c illustrates a repeater with a receive diversity antenna port in accordance with an example;

FIG. 12d illustrates a repeater with a receive diversity antenna port in accordance with an example;

FIG. 12e illustrates a repeater with a receive diversity antenna port in accordance with an example;

FIG. 12f illustrates a multiband repeater with a receive diversity antenna port in accordance with an example;

FIG. 12g illustrates a repeater with a receive diversity antenna port in accordance with an example;

FIG. 12h illustrates a repeater with a receive diversity antenna port in accordance with an example;

FIG. 13a illustrates a multiband repeater with a receive diversity antenna port in accordance with an example;

FIGS. 13b to 13e illustrate multi-filter packages in accordance with an example;

FIGS. 13f to 13i illustrate multi-filter packages in accordance with an example;

FIG. 13j illustrates a multiband repeater with a receive diversity antenna port in accordance with an example;

FIG. 13k illustrates a multiband repeater with a receive diversity antenna port in accordance with an example;

FIG. 13l illustrates a multiband repeater with a receive diversity antenna port in accordance with an example;

FIG. 14 depicts a repeater in accordance with an example;

FIG. 15 depicts a repeater in accordance with an example;

FIG. 16 depicts a repeater in accordance with an example;

FIG. 17 depicts a repeater in accordance with an example; and

FIG. 18 depicts a repeater in accordance with an example.

Reference will now be made to the exemplary embodiments illustrated, and specific language will be used herein to describe the same. It will nevertheless be understood that no limitation of the scope of the technology is thereby intended.

### DETAILED DESCRIPTION OF THE INVENTION

Before the present technology is disclosed and described, it is to be understood that this technology is not limited to the particular structures, process actions, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating actions and operations and do not necessarily indicate a particular order or sequence.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

In one aspect, a repeater system can include a pole with one or more donor antennas, one or more server antennas and a repeater integrated into the pole. The one or more donor antennas can be located toward the top of the pole, and the one or more server antennas can be located toward the bottom of the pole. In one example embodiment, the one or more donor antennas can be advantageously located at the top of the pole to increase a reception of uplink and downlink wireless communication signals between the repeater and one or more base stations. The one or more donor antennas located toward the top of the pole and the one or more server antennas located toward the bottom of the pole, or vice versa, can also reduce oscillations in the repeater resulting from signals transmitted by the one or more donor antennas being received at the one or more server antennas and feedback to the repeater, or vice versa. Installation and setup can be simplified with the one or more donor antennas, the one or more server antennas and the repeater integrated into the pole. The pole with the one or more donor antennas, the one or more server antennas and the repeater integrated therein also enables the repeater system to be portable. Additional example embodiments of the repeater system will be described in the proceeding paragraphs.

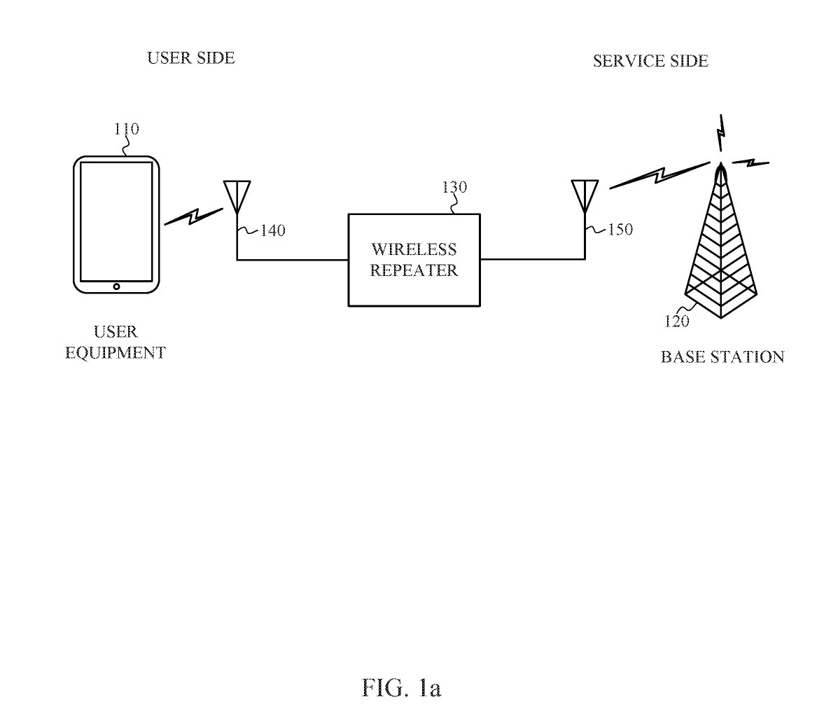

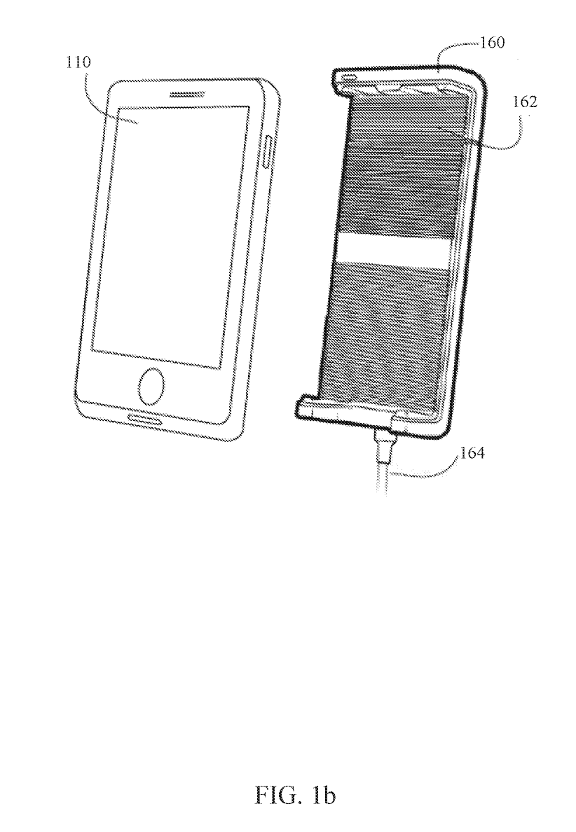

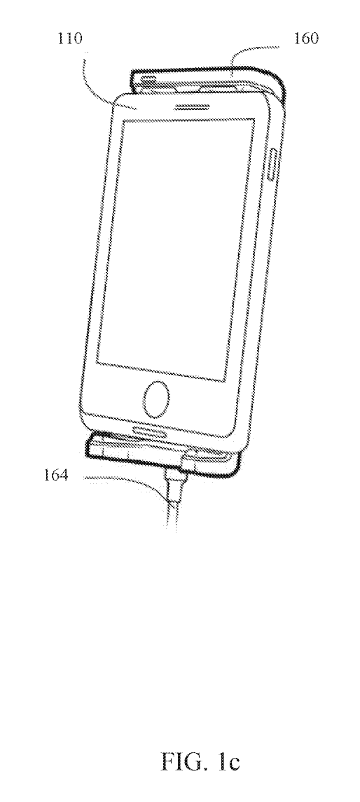

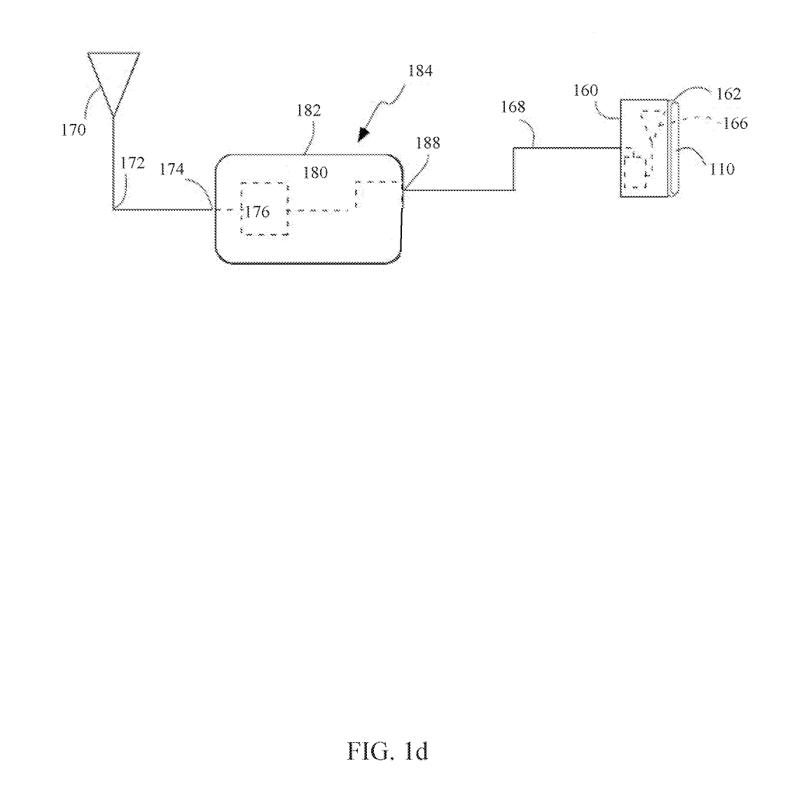

FIG. 1b depicts an example of a cradle with a user equipment (UE) removed from the cradle 160 and FIG. 1c depicts an example of a UE 110 carried by the cradle 160. The cradle 160 can have an interface 162 capable of selectively carrying a UE 110. The interface 162 can removably receive, hold and carry a UE 110. The interface 162 can be sized and shaped to hold and grip the UE 110. The cradle 160 can also have an RF signal coupler such as a server antenna, to wirelessly couple the one or more RF communication signals to the UE 110 when carried by the cradle 160. The interface 162 can be capable of spacing the UE 110 with respect to the RF signal coupler or server antenna, and aligning, or positioning and orienting, the UE 110, and its RF antennas, with the RF signal coupler or server antenna. In one aspect, a back of the interface 162 can abut to the UE 110 to space the UE 110 with respect to the RF signal coupler or the server antenna. In another aspect, fingers, sides or ends can align, or position and orient, the UE 110 with respect to the RF signal coupler or server antenna. The cradle 160 can be coupled to a repeater and/or a signal splitter by co-axial cables 164. In one example, the maximum gain of the coupled repeater can be 23 dB. The maximum gains can be set to different levels, depending on government regulations or system requirements. In addition, in one aspect, the maximum range of the cradle 160 and/or the server antenna or the signal coupler can be 8 inches or 20 cm from a user for radiation safety reasons. The maximum gain of the repeater can automatically adjust based on whether the UE is placed in the cradle or not.

FIG. 1d depicts an example of a repeater system 184 or signal booster in accordance with an example. The repeater system 184 can boost or amplify one or more radio frequency (RF) communication signals between a donor antenna 170 and a server antenna 166. The donor antenna 170 can be an exterior donor antenna disposed outside of a vehicle or structure. In one aspect, the server antenna 166 can be a signal coupler carried by and disposed in a cradle 160 associated with the repeater system 184. The cradle 160 can hold a UE 110. The cradle 160 can have an interface 162.

The repeater system 184 can comprise a repeater 180, the cradle 160 with the server antenna 166, and the donor antenna 170. The repeater 180 can comprise a bi-directional amplifier (BDA) 176 to amplify the one or more RF communication signals. The repeater 180 can have a housing 182. The donor antenna 170 can be coupled to the repeater 180 via a coaxial cable 172 to a donor port 174. The server port 188 can be coupled to the repeater 180 via a coaxial cable 168.

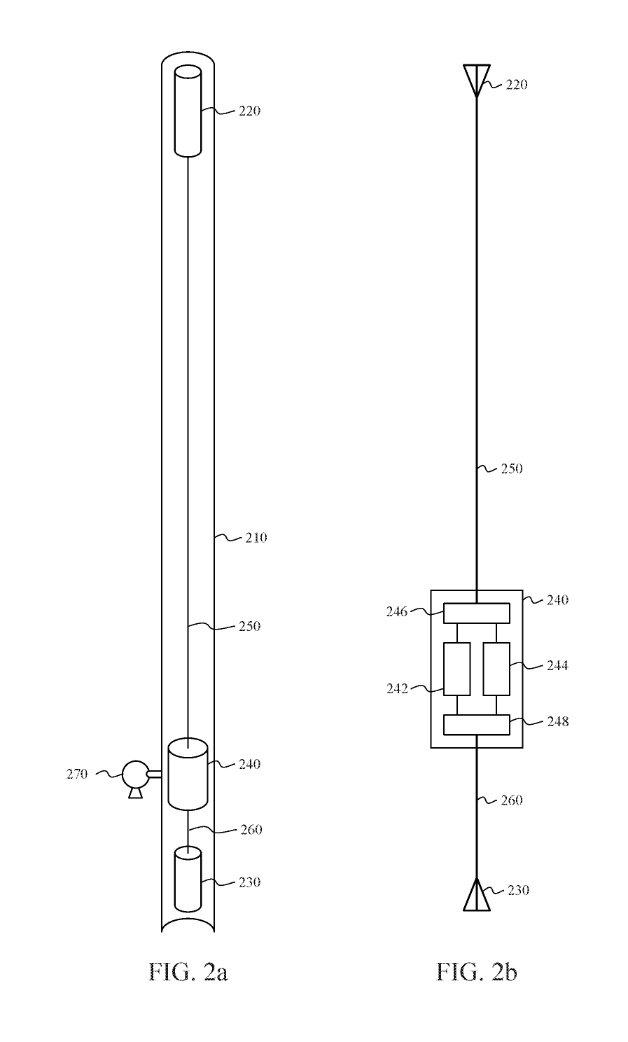

FIGS. 2a and 2b depict a repeater system, in accordance with an example. The repeater system can include a pole 210, one or more donor antennas 220, one or more server antennas 230, and a repeater 240. In the mechanical illustration of FIG. 2a, the repeater system can include a pole 210, a donor antenna 220, a server antenna 230, and a repeater 240. In one aspect, the donor antenna 220 can be configured to transmit and receive uplink and downlink signals between the repeater 240 and one or more base stations. The server antenna 230 can be configured to transmit and receive uplink and downlink signals between the repeater 240 and one or more user devices. The spacing between the donor antennas 220 and the server antennas 230 can vary. Although, the repeater system is described with reference to one pole 210, one donor antenna 220, one server antenna 230, and a repeater 240, it is to be appreciated that multiple repeater systems can be implemented in parallel to provide for multiple input multiple output (MIMO) repeater systems.

In one example, a MIMO system can include a single repeater 240 and two or more donor antennas 220 and two or more server antennas 230. The two or more antennas may be located in a single pole 210 or may be positioned in multiple adjacent poles, with the antennas in each adjacent pole communicatively coupled to a server 240. The server may be carried by one pole in the server system, or may be positioned outside of each of the poles. Alternatively, a MIMO system can be formed using multiple repeater systems, with each repeater system comprising a pole 210 that includes a donor antenna 220, a repeater 240, and a server antenna 230.

In one aspect, the repeater 240 can be communicatively coupled between the donor antenna 220 and the server antenna 230. In one instance, the repeater 240 can be communicatively coupled by respective cables 250, 260 between the repeater 240 and the donor antenna 220, and between the repeater 240 and the server antenna 230, respectively. The cables 250, 260 can be coaxial cables to reduce coupling between the donor antenna 220 and the server antenna 230.

In one aspect, the repeater 240 can be configured to amplify one or more RF communication signals, as illustrated in the circuit illustration of FIG. 2b. The repeater 240 can, for example, amplify various types of RF signals, such as cellular telephone, WiFi, or AM/FM radio signals. In one instance, an uplink amplifier 242 can be configured to amplify signals in one or more uplink bands, and a downlink amplifier 244 can be configured to amplify signals in one or more downlink bands. One or more duplexers and/or couplers 246, 248 can be configured to multiplex, demultiplex and/or couple the uplink and downlink signals between the uplink and downlink amplifiers 242, 244 and the donor antenna 220, and between the uplink and downlink amplifiers 242, 244 and the server antenna 230. In another instance, one or more bi-direction amplifiers can be configured to amplify both uplink and downlink signals of one or more carrier bands. In one instance, the RF communication signals can be cellular telephone RF signals, such as a Third-Generation Partnership Project (3GPP) Long Term Evolved (LTE) uplink and downlink signals when operating in a frequency division duplex (FDD) mode. In one instance, the uplink 3GPP LTE signals may operate in an uplink portion of a selected FDD frequency band and the downlink 3GPP LTE signal may operate in a downlink portion of the selected FDD frequency band. In one instance, the repeater can be configured to operate in one or more FDD bands or time division duplex (TDD) bands including any of 3GPP LTE frequency bands 1 through 85, 3GPP 5G frequency bands 1 through 86, 3GPP 5G frequency bands 257 through 261, or other frequency bands, as disclosed in 3GPP TS 36.104 V16.0.0 (January 2019) or 3GPP TS 38.104 v15.4.0 (January 2019). In addition, the signal booster 120 can boost time division duplexing (TDD) and/or frequency division duplexing (FDD) signals.

Referring again to FIG. 2a, the pole 210 can be any long, relatively slender mechanical support structure. The pole 210 can have a form factor of a cylinder (right circular, elliptic, parabolic, hyperbolic), rectangular prism, triangular prism, pentagonal prism, hexagonal prism, or the like. In one aspect, the pole 210 can be non-conductive. In another aspect, the pole 210 can include one or more metallic portions, such as one or more of caps, fasteners and/or adapters. For example, the pole 210 can include a metal cap coupled to an electrical ground for lightning protection.

In one aspect, the donor antenna 220, server antenna 230 and repeater 240 are carried by the pole 210. In one instance, the server antenna 230 and the repeater 240 can be fixably mounted to a first side of the pole 210 and the donor antenna 220 can be fixably mounted to a second side of the pole 210 that is opposite to the first side of the pole 210. The donor antenna 220 mounted at the second side of the pole 210 can correspond to the top of the pole. Mounting the server antenna 230 and repeater 240 at the second side of the pole 210 can correspond to the bottom of the pole 210. It is to be appreciated that with the server antenna 230 and repeater 240 mounted toward the bottom of the pole and the donor antenna 220 mounted towards the top of the pole 210, in most cases there will be increased mass at the bottom of the pole 210 resulting in a lower center of gravity. The lower center of gravity can resist torque on the pole 210 from wind when the pole is positioned in a vertical direction. In another instance, the donor antenna 220 and the repeater 240 can be fixably mounted to a first side of the pole 210, and the server antenna 230 can be fixably mounted to a second side of the pole 210 that is opposite to the first side of the pole 210. Mounting the donor antenna 220 and the repeater 240 near each other at the first side of the pole 210 can advantageously reduce transmission losses. In one instance, the donor antenna 220, the server antenna 230, and the repeater 240 are encompassed by the pole 210. The donor antenna 220, the server antenna 230 and the repeater 240 can be encompassed by the pole 210, by integrating the donor antenna 220, the server antenna 230 and the repeater 240 with the pole 210, or mounting the donor antenna 220, the server antenna 230 and the repeater 240 inside the pole 210. In one embodiment, the pole can be constructed to be substantially water resistant to provide environmental protections to the server antenna 230, donor antenna 220, and/or repeater 240.

In one aspect, a radiation pattern of the donor antenna 220 can be configured to reduce radiation directed toward the server antenna 230 to minimize feedback from the server antenna 230, through the repeater 240, to the donor antenna 220. A radiation pattern of the server antenna 230 can also be configured to reduce radiation directed toward the donor antenna 220 to minimize feedback from the donor antenna 220, through the repeater 240, to the server antenna 230. In one instance, the donor antenna 220 and the server antenna 230 can be located at a fixed distance from each other to reduce feedback based on the radiation pattern of the donor antenna 220 and the serve antenna 230. The repeater system can also include a radiation shield carried by the pole 210 and located between the donor antenna 220 and the server antenna 230 to reduce radiation communicated between the donor antenna 220 and the server antenna 230. In one instance, the donor and/or server antenna 220, 230 can be directional antennas to reduce radiation communicated between the donor antenna 220 and the server antenna 230. The direction of each antenna can be electrically or mechanically steerable to direct the radiation pattern of the donor and/or server antenna 220, 230. For example, the donor antenna can be steerable, wherein the downlink signal strength from one or more base stations are measured and the radiation pattern for the uplink signal is steered in the direction of the strongest downlink signal. In another instance, the donor and/or server antenna 220, 230 can be omnidirectional antennas.

In one aspect, the repeater system can also include a mounting apparatus 270 for securing the pole 210 to a vehicle or structure. The mounting apparatus 270 can be a ratchet mount, a ram mount, a tripod, a stand, or the like. The mounting apparatus 270 can be fixed or movable. In one instance, the mounting apparatus 270, such as a ratchet mount, enables the pole 210 to be rotated to a vertical direction for use with the donor antenna 220 located near a top of the pole 210, and rotated to a horizontal direction for stowage. In one instance, the mounting apparatus 270 allows the pole 210 to be rotatably and/or removably mounted to a marine vessel. In another instance, the mounting apparatus 270 allows the pole 210 to be rotatably and/or removably mounted to a vehicle, such as an emergency response vehicle. The spacing between the mounting apparatus 270 and one or more of the repeater 240, the donor antenna 220 and/or the server antenna 230 can vary based on system requirements.

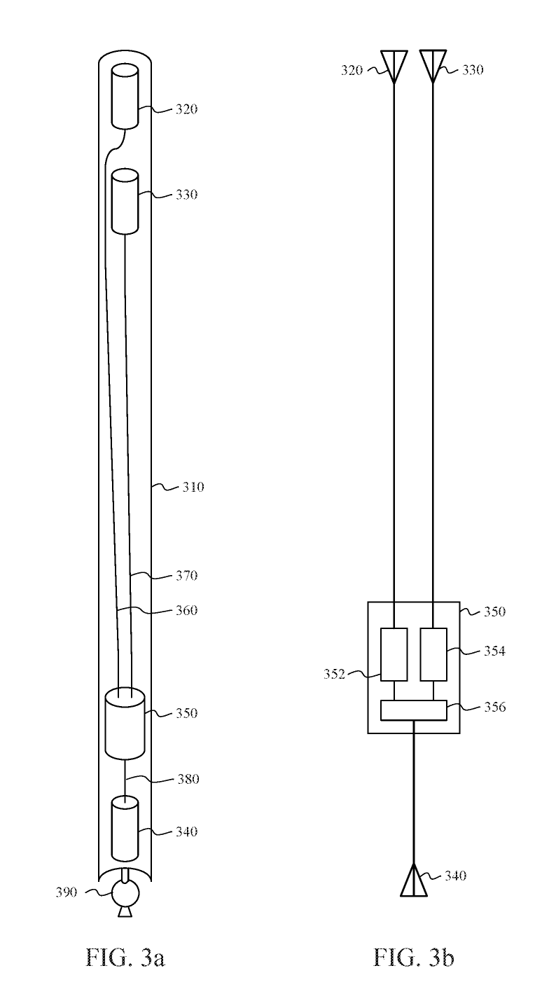

FIGS. 3a and 3b depict a repeater system, in accordance with another example. In the mechanical illustration of FIG. 3a, the repeater system can include a pole 310, an uplink donor antenna 320, a downlink donor antenna 330, a server antenna 340, and a repeater 350. In one aspect, the uplink donor antenna 320 can be configured to transmit uplink signals from the repeater 350 to one or more base stations. The downlink donor antenna 330 can be configured to receive downlink signals from one or more base stations. The server antenna 340 can be configured to transmit and receive uplink and downlink signals between the repeater 350 and one or more user devices.

In one aspect, the repeater 350 can be electrically coupled between the uplink and downlink donor antennas 320, 330 and the server antenna 340. In one instance, the repeater 350 can be electrically coupled by respective cables 360, 370, 380 between the repeater 350 and the uplink and downlink donor antennas 320, 330, and between the repeater 350 and the server antenna 340. The cables 360, 370, 380 can be coaxial cables to reduce coupling between the uplink and downlink donor antennas 320, 330, and the server antenna 340.

In one aspect, the repeater 350 can be configured to amplify one or more RF communication signals, as illustrated in the circuit illustration of FIG. 3b. The repeater 350 can, for example, amplify various types of RF signals, such as cellular telephone, WiFi, or AM/FM radio signals. In one instance, an uplink amplifier 352 can be configured to amplify signals in one or more uplink bands, and a downlink amplifier 354 can be configured to amplify signals in one or more downlink bands. One or more duplexers and/or couplers 356 can be configured to multiplex, demultiplex and or couple the uplink and downlink signals between the uplink and downlink amplifiers 352, 354 and the uplink and downlink donor antennas 320, 330 respectively, and between the uplink and downlink amplifiers 352, 354 and the server antenna 340. However, with the use of uplink and downlink antennas 320, 330, the duplexer or coupler between the uplink and downlink amplifiers 352, 354 and the uplink and downlink donor antennas 320, 330 can be eliminated. Eliminating the duplexer or coupler between the amplifiers 352, 354 and the uplink and downlink antennas 320, 330 can reduce the insertion loss by 2-3 decibels (dBs), thereby increasing output power by 2-3 dB and decreasing the noise factor by 2-3 db.

Referring again to FIG. 3a, the pole 310 can be any long, relatively slender mechanical support structure. The pole 310 can have a form factor of a cylinder (right circular, elliptic, parabolic, hyperbolic), rectangular prism, triangular prism, pentagonal prism, hexagonal prism, or the like. In one aspect, the pole 310 can be non-conductive. In another aspect, the pole 310 can include one or more metallic portions, such as one or more of caps, fasteners and/or adapters. For example, the pole 310 can include a metal cap coupled to an electrical ground for lightning protection.

In one aspect, the uplink and downlink donor antennas 320, 330, server antenna 340 and repeater 350 are carried by the pole 310. In one instance, the server antenna 340 and the repeater 350 can be fixably mounted to a first side of the pole 310 and the uplink and downlink donor antenna 320, 330 can be fixably mounted to a second side of the pole 310 that is opposite to the first side of the pole 310. The uplink and downlink donor antennas 320, 330 mounted at the second side of the pole 310 can correspond to the top of the pole 310. Mounting the server antenna 340 and repeater 350 at the second side of the pole 310 can correspond to the bottom of the pole. It is to be appreciated that with the server antenna 340 and repeater 350 mounted toward the bottom of the pole 310 and the uplink and downlink donor antennas 320, 330 mounted toward the top of the pole 320, in most cases there will be increased mass at the bottom of the pole 210 resulting in a lower center of gravity. The lower center of gravity can resist torque on the pole 310 from wind. In another instance, the uplink and downlink donor antennas 320, 330 and the repeater 340 can be fixably mounted to a first side of the pole 310, and the server antenna 340 can be fixably mounted to a second side of the pole 310 that is opposite to the first side of the pole 310. Mounting the uplink and downlink donor antenna 320, 330, and the repeater 340 near each other at the first side of the pole 310 can advantageously reduce transmission losses. In one instance, the uplink and downlink donor antennas 320, 330, the server antenna 340, and the repeater 350, are encompassed by the pole 310. The uplink and downlink donor antennas 320, 330, the server antenna 340 and the repeater 350 can be encompassed by the pole 310, by integrating the uplink and downlink donor antennas 320, 330, the server antenna 340 and the repeater 350 with the pole 310, or mounting the uplink and downlink donor antennas 320, 330, the server antenna 340, and the repeater 350 inside the pole.

In one aspect, a radiation pattern of the uplink donor antenna 320 can be configured to reduce radiation directed toward the server antenna 340 to minimize feedback from the server antenna 340, through the repeater 350, to the uplink donor antenna 320. A radiation pattern of the server antenna 340 can also be configured to reduce radiation directed toward the downlink donor antenna 330 to minimize feedback from the downlink donor antenna 330, through the repeater 350, to the server antenna 230. In one instance, the uplink and downlink donor antennas 320, 330 and the server antenna 340 can be located at fixed distances from each other to reduce feedback based on their radiation patterns. The repeater system can also include a radiation shield carried by the pole 310 and located between the uplink and downlink donor antennas 320, 330 and the server antenna 340. In one instance, one or more of the uplink donor antenna 320, the downlink donor antenna 330 and/or server antenna 340 can be directional antennas. The directional antenna can be electrically or mechanically steerable to direct the radiation pattern of the uplink donor antenna 320, downlink donor antenna 330 and/or server antenna 340. For example, the donor antenna can be steerable, wherein the downlink signal strength from one or more base stations are measured and the radiation pattern for the uplink signal is steered in the direction of the strongest downlink signal. In another instance, one or more of the uplink donor antenna 320, downlink donor antenna 330 and/or server antenna 340 can be omnidirectional antennas.

In one aspect, the repeater system can also include a mounting apparatus 390 for securing the pole 310 to a vehicle or structure. The mounting apparatus 390 can be a ratchet mount, a ram mount, a tripod, a stand, or the like. The mounting apparatus 390 can be fixed or movable. In one instance, the mounting apparatus 390, such as a ratchet mount, enables the pole 310 to be rotated to a vertical direction for use with the uplink and downlink donor antennas 320, 330 located near a top of the pole 310, and rotated to a horizontal direction for stowage. In one instance, the mounting apparatus 390 allows the pole 310 to be rotatably and/or removably mounted to a marine vessel. In another instance, the mounting apparatus 390 allows the pole 310 to be rotatably and/or removably mounted to a vehicle, such as an emergency response vehicle.

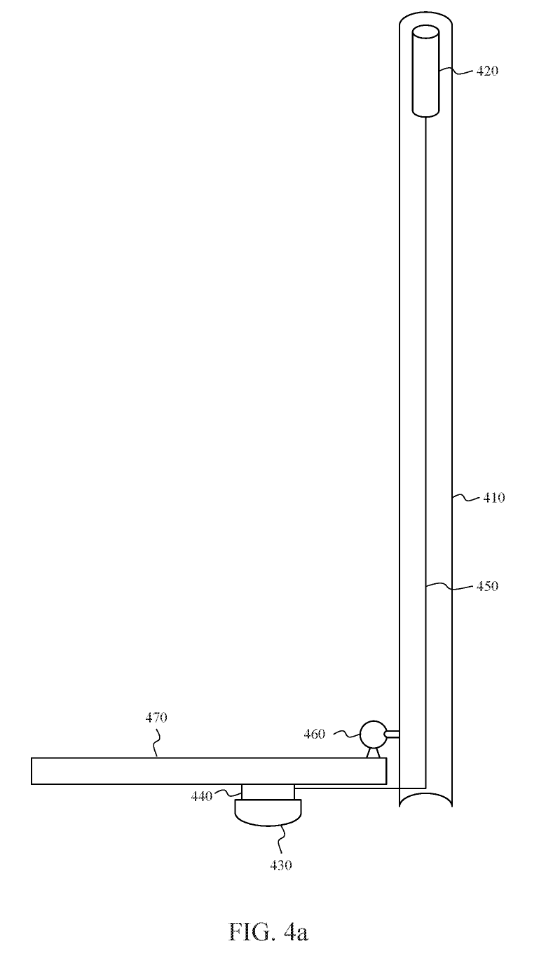

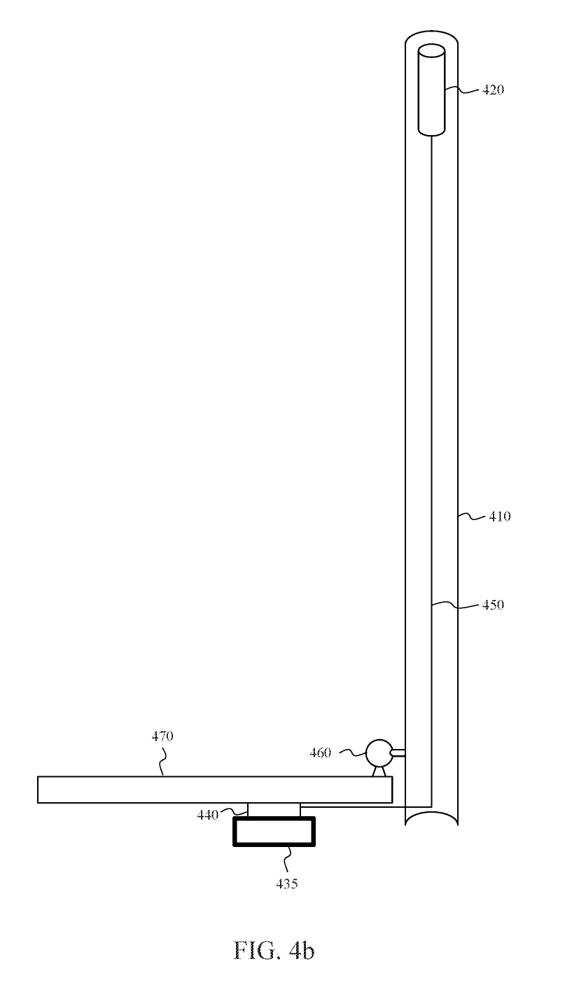

FIG. 4a depicts a repeater system, in accordance with another example. The repeater system can include a pole 410, a donor antenna 420, a server antenna 430, and a repeater 440. In one aspect, the donor antenna 420 can be configured to transmit and receive uplink and downlink signals between the repeater 440 and one or more base stations. The server antenna 430 can be configured to transmit and receive uplink and downlink signals between the repeater 440 and one or more user devices.

In one aspect, the repeater 440 can be electrically coupled between the donor antenna 420 and the server antenna 430. In one instance, the repeater 440 can be electrically coupled to the donor antenna 420 by a cable 450. The cable 450 can be a coaxial cable to reduce coupling between the donor antenna 420 and the server antenna 430.

The pole 410 can be any long, relatively slender mechanical support structure. The pole 410 can have a form factor of a cylinder (right circular, elliptic, parabolic, hyperbolic), rectangular prism, triangular prism, pentagonal prism, hexagonal prism, or the like. In one aspect, the pole 410 can be non-conductive. In another aspect, the pole 410 can include one or more metallic portions, such as one or more of caps, fasteners and/or adapters. For example, the pole 410 can include a metal cap coupled to an electrical ground for lightning protection.

In one aspect, the donor antenna 420 can be carried by the pole 410. In one instance, the server antenna 430 and the repeater 440 can be removably couplable to a first side of the pole 410 and the donor antenna 420 can be fixably mounted to a second side of the pole 410 that is opposite to the first side of the pole 420. The donor antenna 420 mounted at the second side of the pole 410 can correspond to the top of the pole. The server antenna 430 and repeater 440 can be removed from the first side of the pole 410 and mounted on a structure 460 in a desired location adjacent to the pole 410. For example, the server antenna 430 and repeater 440 can be removed from the pole 410 and mounted in a crew compartment of a marine vessel. In another example, the server antenna 430 and repeater 440 can be removed from the pole 410 and mounted in an emergency response command center or on an emergency response vehicle. In one instance, the donor antenna 420 is encompassed by the pole 410. The donor antenna 420 can be encompassed by the pole 410, by integrating the donor antenna 420 with the pole 410, or mounting the donor antenna 420 inside the pole 410.

In one aspect, a radiation pattern of the donor antenna 420 can be configured to reduce radiation directed toward the server antenna 430 to minimize feedback from the server antenna 430, through the repeater 440, to the donor antenna 420. A radiation pattern of the server antenna 430 can also be configured to reduce radiation directed toward the donor antenna 420 to minimize feedback from the donor antenna 420, through the repeater 440, to the server antenna 430. The repeater system can also include a radiation shield carried by the pole 410 and located between the donor antenna 420 and the server antenna 430. In one instance, the donor and/or server antenna 420, 430 can be directional antennas. The direction antenna can be electrically or mechanically steerable to direct the radiation pattern of the donor and/or server antenna 420, 430. For example, the donor antenna 420 can be steerable, wherein the downlink signal strength from one or more base stations are measured and the radiation pattern for the uplink signal is steered in the direction of the strongest downlink signal. In another instance, the donor and/or server antenna 420, 430 can be omnidirectional antennas.

In one aspect, the repeater system can also include a mounting apparatus 460 for securing the pole 410 to a vehicle 470 or structure. The mounting apparatus 460 can be a ratchet mount, a ram mount, a tripod, a stand, or the like. The mounting apparatus 460 can be fixed or movable. In one instance, the mounting apparatus 460, such as a ratchet mount, enables the pole 410 to be rotated to a vertical direction for use with the donor antenna 420 located near a top of the pole 410, and rotated to a horizontal direction for stowage. In one instance, the mounting apparatus 460 allows the pole 410 to be rotatably and/or removably mounted to a marine vessel. In another instance, the mounting apparatus 460 allows the pole 410 to be rotatably and/or removably mounted to a vehicle, such as an emergency response vehicle.

FIG. 4b depicts a repeater system, in accordance with another example. The repeater system can include a pole 410, a donor antenna 420, a cradle 435, and a repeater 440. In one aspect, the repeater system can also include a mounting apparatus 460 for securing the pole 410 to a vehicle 470 or structure. In one aspect, the donor antenna 420 can be configured to transmit and receive uplink and downlink signals between the repeater 440 and one or more base stations. The cradle 435 can be carried about the pole 410, i.e. coupled to the pole 410, coupled adjacent to the pole 410, or within a fixed radius of up to 20 feet from the pole 410. The cradle 435 can have an interface capable of selectively carrying a UE and a server antenna. The server antenna can be configured to wirelessly couple one or more radio frequency (RF) communication signals to a UE carried by the interface of the cradle 435. The cradle 435 can be coupled to the repeater 440 via a coaxial cable with a length of between 0.5 feet and 40 feet. The repeater 440 can be coupled to the donor antenna 420 via a coaxial cable 450. The repeater can be integrated with the cradle. Alternatively, the repeater can be separate from the cradle and connected to the server antenna in the cradle via a wired or wireless connection. The maximum gain of the repeater can automatically adjust based on whether the UE is placed in the cradle or not.

In one aspect, the maximum gain of repeater can be 23 decibels (dB) when the cradle is carrying a UE. Alternatively, a greater or lesser gain may be used based on government standards and regulations for the country in which the repeaters is configured to operate. In addition, in one aspect, the minimum distance of the cradle 435 and/or the server antenna from a user can be 8 inches or 20 centimeters (cm). In another aspect, the maximum gain of the cradle 435 and/or the server antenna and/or the repeater can be 50 dB when the cradle 435 is not carrying the UE and the UE is within a radius of up to 20 feet of the server antenna. The maximum gain of the repeater can automatically adjust based on whether the UE is placed in the cradle or not. Thus the repeater system can provide a signal boost to the UE and signal coverage to a larger area, such as the area covered by a recreational vehicle (RV). In another aspect, the maximum gain of the server antenna and/or the repeater can be between 65-72 dB when the cradle 435 is not carrying the UE and the server antenna is at a fixed location. Use of the cradle 435 coupled to the server antenna at a lower gain, i.e. 23 dB or 50 dB, can limit antenna-to-antenna feedback, such as feedback between the server antenna and the donor antenna, that can occur at higher gain levels, i.e. 65-72 dB.

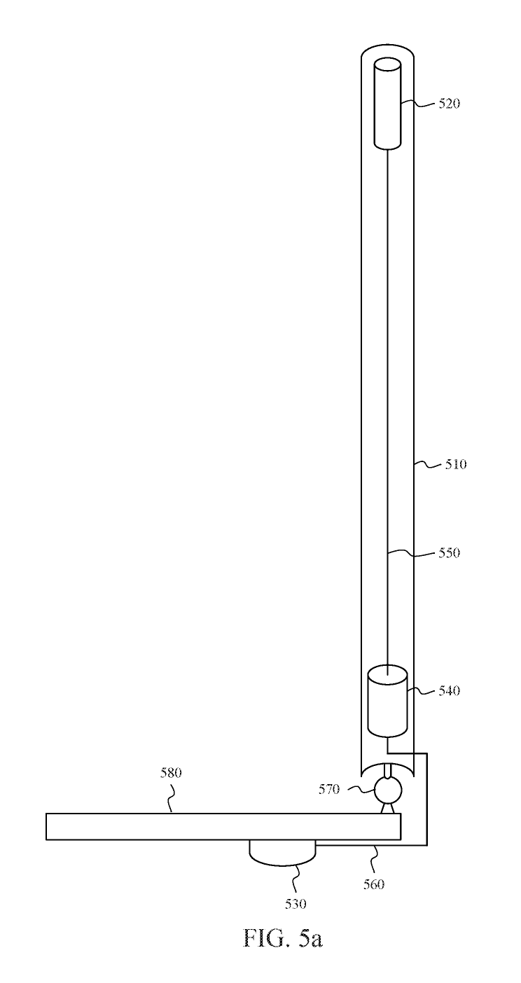

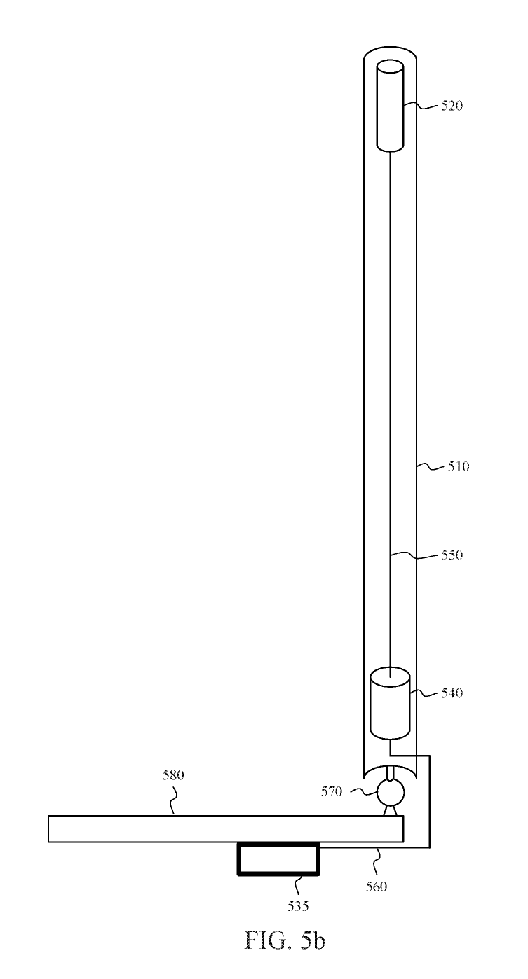

FIG. 5 depicts a repeater system, in accordance with another example. The repeater system can include a pole 510, a donor antenna 520, a server antenna 530, and a repeater 540. In one aspect, the donor antenna 520 can be configured to transmit and receive uplink and downlink signals between the repeater 540 and one or more base stations. The server antenna 530 can be configured to transmit and receive uplink and downlink signals between the repeater 540 and one or more user devices.

In one aspect, the repeater 540 can be electrically coupled between the donor antenna 520 and the server antenna 530. In one instance, the repeater 540 can be electrically coupled by respective cables 550, 560 between the repeater 540 and the donor antenna 520, and between the repeater 540 and the server antenna 530. The cables 550, 560 can be coaxial cables to reduce coupling between the donor antenna 520 and the server antenna 530.

The pole 510 can be any long, relatively slender mechanical support structure. The pole 510 can have a form factor of a cylinder (right circular, elliptic, parabolic, hyperbolic), rectangular prism, triangular prism, pentagonal prism, hexagonal prism, or the like. In one aspect, the pole 510 can be non-conductive. In another aspect, the pole 10 can include one or more metallic portions, such as one or more of caps, fasteners and/or adapters. For example, the pole 510 can include a metal cap coupled to an electrical ground for lightning protection.

In one aspect, the donor antenna 520 and repeater 540 are carried by the pole 510. In one instance, the repeater 540 can be fixably mounted to a first side of the pole 510 and the donor antenna 520 can be fixably mounted to a second side of the pole 510 that is opposite to the first side of the pole 510. The donor antenna 520 mounted at the second side of the pole 510 can correspond to the top of the pole. Mounting the repeater 540 at the second side of the pole 510 can correspond to the bottom of the pole 510. It is to be appreciated that with the repeater 540 mounted toward the bottom of the pole and the donor antenna 520 mounted toward the top of the pole 510, in most cases there will be increased mass at the bottom of the pole 510 resulting in a lower center of gravity. The lower center of gravity can resist torque on the pole 510 from wind. The server antenna 530 can optionally be removably couplable to the first side of the pole 510. The server antenna 530 can, therefore, be removed from the first side of the pole 510 and mounted on a structure 570 in a desired location adjacent the pole 510. For example, the server antenna 530 can be removed from the pole 510 and mounted in a crew compartment of a marine vessel. In another example, the server antenna 530 can be removed from the pole 510 and mounted in an emergency response command center or on an emergency response vehicle. In another instance, the donor antenna 520 and the repeater 540 can be fixably mounted to a first side of the pole 510, and the server antenna 530 can be removably couplable to a second side of the pole 510 that is opposite to the first side of the pole 510. Mounting the donor antenna 520 and the repeater 540 near each other at the first side of the pole 210 can advantageous reduce transmission losses. In one instance, the donor antenna 520, and the repeater 540 are encompassed by the pole 210. The donor antenna 520 and the repeater 540 can be encompassed by the pole 510, by integrating the donor antenna 520 and the repeater 540 with the pole 510, or mounting the donor antenna 520 and the repeater 540 inside the pole 510.

In one aspect, a radiation pattern of the donor antenna 520 can be configured to reduce radiation directed toward the server antenna 530 to minimize feedback from the server antenna 530, through the repeater 540, to the donor antenna 520. A radiation pattern of the server antenna 530 can also be configured to reduce radiation directed toward the donor antenna 520 to minimize feedback from the donor antenna 520, through the repeater 540, to the server antenna 530. The repeater system can also include a radiation shield carried by the pole 510 and located between the donor antenna 520 and the server antenna 530. In one instance, the donor and/or server antenna 520, 530 can be directional antennas. The direction antenna can be electrically or mechanically steerable to direct the radiation pattern of the donor and/or server antenna 520, 530. For example, the donor antenna can be steerable, wherein the downlink signal strength from one or more base stations are measured and the radiation pattern for the uplink signal is steered in the direction of the strongest downlink signal. In another instance, the donor and/or server antenna 520, 530 can be omnidirectional antennas.

In one aspect, the repeater system can also include a mounting apparatus 570 for securing the pole 510 to a vehicle 580 or structure. The mounting apparatus 570 can be a ratchet mount, a ram mount, a tripod, a stand, or the like. The mounting apparatus 570 can be fixed or movable. In one instance, the mounting apparatus 570, such as a ratchet mount, enables the pole 510 to be rotated to a vertical direction for use with the donor antenna 520 located near a top of the pole 510, and rotated to a horizontal direction for stowage. In one instance, the mounting apparatus 570 allows the pole 510 to be rotatably and/or removably mounted to a marine vessel. In another instance, the mounting apparatus 570 allows the pole 510 to be rotatably and/or removably mounted to a vehicle, such as an emergency response vehicle.

FIG. 5b depicts a repeater system, in accordance with another example. The repeater system can include a pole 510, a donor antenna 520, a cradle 535, and a repeater 540. In one aspect, the repeater system can also include a mounting apparatus 570 for securing the pole 510 to a vehicle 580 or structure. In one aspect, the donor antenna 520 can be configured to transmit and receive uplink and downlink signals between the repeater 540 and one or more base stations. The cradle 535 can be carried about the pole 510, i.e. coupled to the pole 510, coupled adjacent to the pole 510, or within a fixed radius of up to 40 feet from the pole 510. The cradle 535 can have an interface capable of selectively carrying a UE and a server antenna. The server antenna can be configured to wirelessly couple one or more radio frequency (RF) communication signals to a UE carried by the interface of the cradle 535. The cradle 535 can be coupled to the repeater 540 via a coaxial cable with a length of between 0.5 feet and 40 feet. The repeater 540 can be coupled to the donor antenna 520 via a coaxial cable 550.

In one aspect, the maximum gain of the repeater can be 23 decibels (dB), or another desired level based on a government regulation or standard, when the cradle is carrying a UE. In addition, in one aspect, the maximum range of the cradle 535 and/or the server antenna can be 8 inches or 20 centimeters (cm) based on the gain of 23 dB. In another aspect, the maximum gain of the cradle 535 and/or the server antenna and/or the repeater can be 50 dB when the cradle 535 is not carrying the UE and the UE is within a radius of up to 20 feet of the server antenna. Thus the repeater system can provide a signal boost to the UE and signal coverage to a larger area, such as the area covered by a recreational vehicle (RV). In another aspect, the maximum gain of the server antenna and/or the repeater can be between 65-72 dB when the cradle 535 is not carrying the UE and the server antenna is at a fixed location. Use of the cradle 535 coupled to the server antenna at a lower gain, i.e. 23 dB or 50 dB, can limit antenna-to-antenna feedback, such as feedback between the server antenna and the donor antenna, that can occur at higher gain levels, i.e. 65-72 dB. The maximum gain of the repeater can automatically adjust based on whether the UE is placed in the cradle or not.

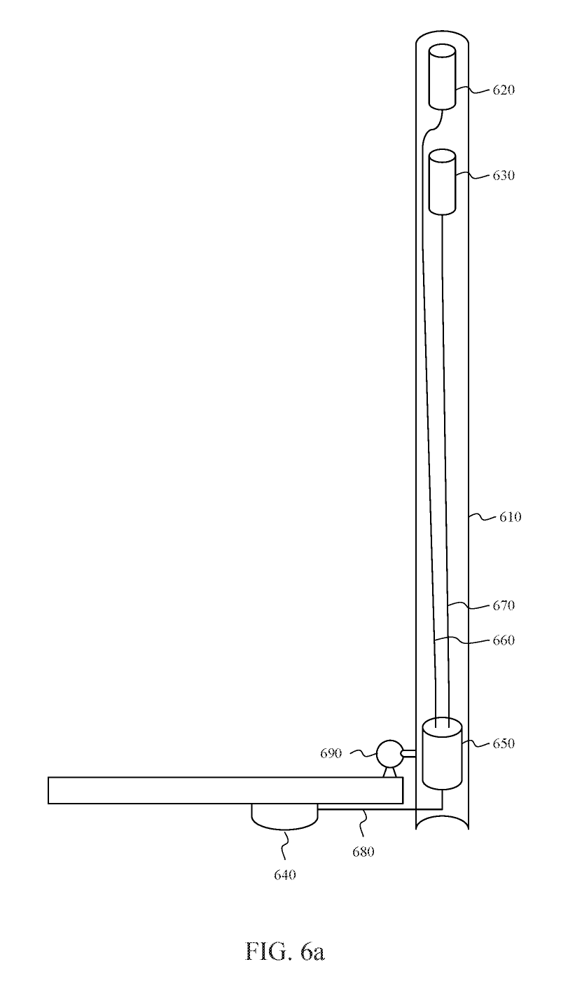

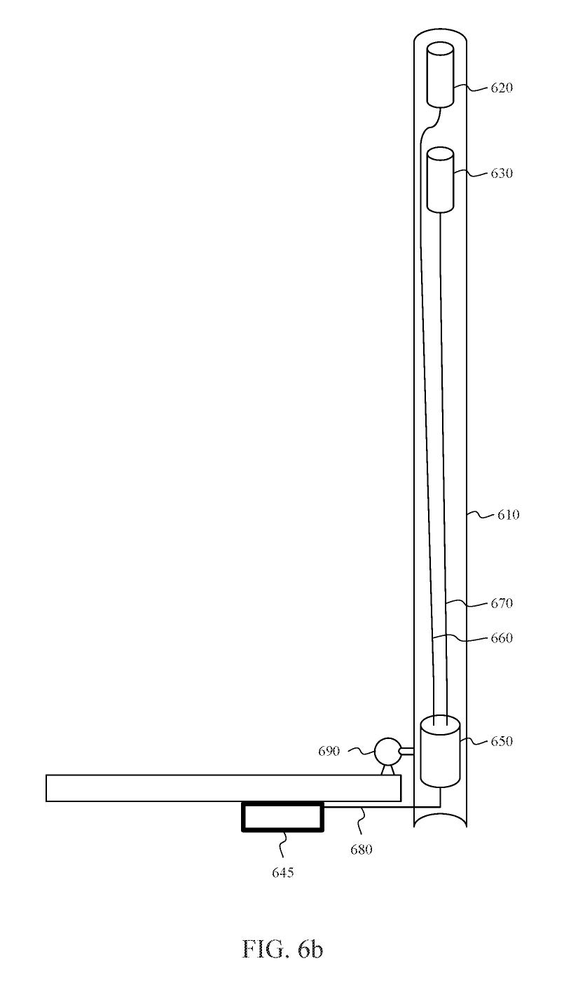

FIG. 6 depicts a repeater system, in accordance with another example. The repeater system can include a pole 610, an uplink donor antenna 620, a downlink donor antenna 630, a server antenna 640, and a repeater 650. In one aspect, the uplink donor antenna 620 can be configured to transmit uplink signals from the repeater 650 to one or more base stations. The downlink donor antenna 630 can be configured to receive downlink signals from one or more based stations. The server antenna 640 can be configured to transmit and receive uplink and downlink signals between the repeater 650 and one or more user devices.

In one aspect, the repeater 650 can be electrically coupled between the uplink and downlink donor antennas 620, 630 and the server antenna 640. In one instance, the repeater 650 can be electrically coupled by respective cables 660, 670, 680 between the repeater 650 and the uplink and downlink donor antennas 620, 630, and between the repeater 650 and the server antenna 640. The cables 660, 670, 680 can be coaxial cables to reduce coupling between the uplink and downlink donor antennas 620, 630, and the server antenna 640.

In one aspect, the pole 610 can be any long, relatively slender mechanical support structure. The pole 610 can have a form factor of a cylinder (right circular, elliptic, parabolic, hyperbolic), rectangular prism, triangular prism, pentagonal prism, hexagonal prism, or the like. In one aspect, the pole 610 can be non-conductive. In another aspect, the pole 610 can include one or more metallic portions, such as one or more of caps, fasteners and/or adapters. For example, the pole 610 can include a metal cap coupled to an electrical ground for lightning protection.

In one aspect, the uplink and downlink donor antennas 620, 630 and repeater 650 can be carried by the pole 610. In one instance, the repeater 650 can be fixably mounted to a first side of the pole 610 and the uplink and downlink donor antenna 620, 630 can be fixably mounted to a second side of the pole 610 that is opposite to the first side of the pole 10. The uplink and downlink donor antennas 620, 630 mounted at the second side of the pole 210 can correspond to the top of the pole 610. Mounting the repeater 650 at the second side of the pole 610 can correspond to the bottom of the pole. It is to be appreciated that with the repeater 650 mounted toward the bottom of the pole 610 and the uplink and downlink donor antennas 620, 630 mounted toward the top of the pole 620, in most cases there will be increased mass at the bottom of the pole 610 resulting in a lower center of gravity and resistance to torque on the pole 610 from wind. The server antenna 630 can optionally be removably couplable to the first side of the pole 610. The server antenna 630 can, therefore, be removed from the first side of the pole 610 and mounted on a structure in a desired location adjacent the pole 610. For example, the server antenna 630 can be removed from the pole 610 and mounted in a crew compartment of a marine vessel. In another example, the server antenna 630 can be removed from the pole 610 and mounted on an emergency response command center. In another instance, the uplink and downlink donor antennas 620, 630 and the repeater 650 can be fixably mounted to a first side of the pole 610, and the server antenna 630 can be removably couplable to a second side of the pole 610 that is opposite to the first side of the pole 610. Mounting the uplink and downlink donor antenna 620, 630 and the repeater 650 near each other at the first side of the pole 610 can advantageously reduce transmission losses. In one instance, the uplink and downlink donor antennas 620, 630 and the repeater 650, are encompassed by the pole 610. The uplink and downlink donor antennas 620, 630 and the repeater 650 can be encompassed by the pole 610, by integrating the uplink and downlink donor antennas 620, 630 and the repeater 650 with the pole 610, or mounting the uplink and downlink donor antennas 620, 630 and the repeater 360 inside the pole.

In one aspect, a radiation pattern of the uplink donor antenna 620 can be configured to reduce radiation directed toward the server antenna 640 to minimize feedback from the server antenna 640, through the repeater 650, to the uplink donor antenna 620. A radiation pattern of the server antenna 640 can also be configured to reduce radiation directed toward the downlink donor antenna 630 to minimize feedback from the downlink donor antenna 630, through the repeater 650, to the server antenna 630. In one instance, the uplink and downlink donor antennas 620, 630 and the server antenna 640 can be located at fixed distances from each other to reduce feedback based on their radiation patterns. The repeater system can also include a radiation shield carried by the pole 610 and located between the uplink and downlink donor antennas 620, 630 and the server antenna 640. In one instance, one or more of the uplink donor antenna 620, the downlink donor antenna 630 and/or server antenna 640 can be directional antennas. The directional antenna can be electrically or mechanically steerable to direct the radiation pattern of the uplink donor antenna 620, downlink donor antenna 630 and/or server antenna 640. For example, the donor antenna can be steerable, wherein the downlink signal strength from one or more base stations are measured and the radiation pattern for the uplink signal is steered in the direction of the strongest downlink signal. In another instance, one or more of the uplink donor antenna 620, downlink donor antenna 630 and/or server antenna 640 can be omnidirectional antennas.

In one aspect, the repeater system can also include a mounting apparatus 690 for securing the pole 610 to a vehicle or structure. The mounting apparatus 690 can be a ratchet mount, a ram mount, a tripod, a stand, or the like. The mounting apparatus 690 can be fixed or movable. In one instance, the mounting apparatus 690, such as a ratchet mount, enables the pole 610 to be rotated to a vertical direction for use with the uplink and downlink donor antennas 620, 630 located near a top of the pole 610, and rotated to a horizontal direction for stowage. In one instance, the mounting apparatus 690 allows the pole 610 to be rotatably and/or removably mounted to a marine vessel. In another instance, the mounting apparatus 690 allows the pole 610 to be rotatably and/or removably mounted to a vehicle, such as an emergency response vehicle.

FIG. 6b depicts a repeater system, in accordance with another example. The repeater system can include a pole 610, an uplink donor antenna 620, a downlink donor antenna 630, a cradle 645, and a repeater 650. In one aspect, the repeater system can also include a mounting apparatus 690 for securing the pole 610 to a vehicle 680 or structure. In one aspect, the uplink donor antenna 620 and the downlink donor antenna 630 can be configured to transmit and receive uplink and downlink signals between the repeater 650 and one or more base stations. The cradle 645 can be carried about the pole 610, i.e. coupled to the pole 610, coupled adjacent to the pole 610, or within a fixed radius of up to 20 feet from the pole 610. The cradle 645 can have an interface capable of selectively carrying a UE and a server antenna. The server antenna can be configured to wirelessly couple one or more radio frequency (RF) communication signals to a UE carried by the interface of the cradle 645. The cradle 645 can be coupled to the repeater 650 via a coaxial cable with a length of between 0.5 feet and 40 feet. The repeater 650 can be coupled to the uplink donor antenna 620 or downlink donor antenna 630 via a coaxial cable 660 and 670, respectively.

In one aspect, the maximum gain of the repeater can be 23 decibels (dB), or another desired level based on a government regulation or standard, when the cradle is carrying a UE. In addition, in one aspect, the maximum range of the cradle 645 and/or the server antenna and/or the repeater can be 8 inches or 20 centimeters (cm), based on the gain of 23 dB. In another aspect, the maximum gain of the cradle 645 and/or the server antenna and/or the repeater can be 50 dB when the cradle 645 is not carrying the UE and the UE is within a radius of up to 20 feet of the server antenna. Thus the repeater system can provide a signal boost to the UE and signal coverage to a larger area, such as a recreational vehicle (RV). In another aspect, the maximum gain of the server antenna and/or the repeater can be between 65-72 dB when the cradle 645 is not carrying the UE and the server antenna is at a fixed location. Use of the cradle 645 coupled to the server antenna at a lower gain, i.e. 23 dB or 50 dB, can limit antenna-to-antenna feedback, such as feedback between the server antenna and the donor antenna, that can occur at higher gain levels, i.e. 65-72 dB. The maximum gain of the repeater can automatically adjust based on whether the UE is placed in the cradle or not.

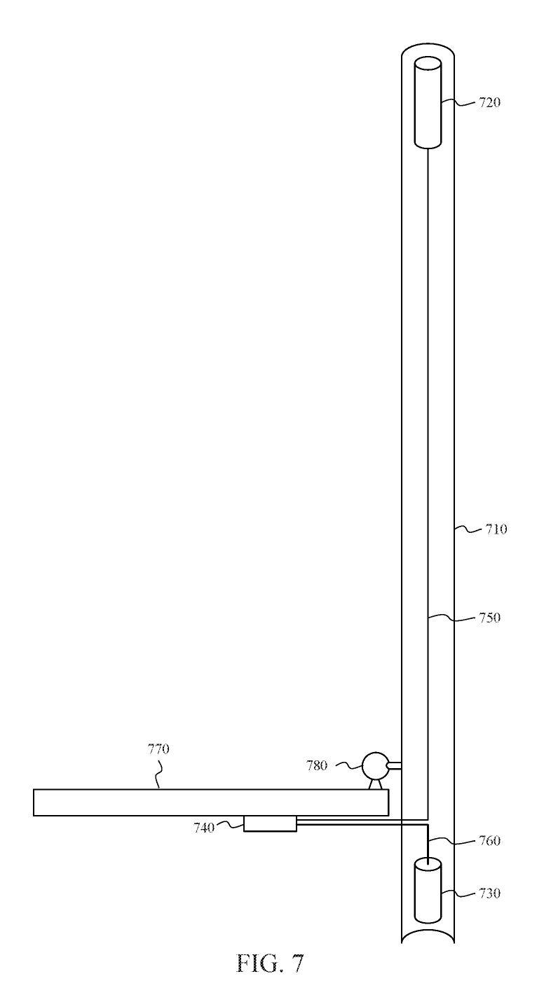

FIG. 7 depicts a repeater system, in accordance with another example. The repeater system can include a pole 710, a donor antenna 720, a server antenna 730, and a repeater 740. In one aspect, the donor antenna 720 can be configured to transmit and receive uplink and downlink signals between the repeater 740 and one or more base stations. The server antenna 730 can be configured to transmit and receive uplink and downlink signals between the repeater 740 and one or more user devices.

In one aspect, the repeater 740 can be electrically coupled between the donor antenna 720 and the server antenna 730. In one instance, the repeater 740 can be electrically coupled to the donor antenna 720 by a first cable 750 and to the server antenna 730 by a second cable 760. The cables 750, 760 can be coaxial cable to reduce coupling between the donor antenna 720 and the server antenna 730.

The pole 710 can be any long, relatively slender mechanical support structure. The pole 710 can have a form factor of a cylinder (right circular, elliptic, parabolic, hyperbolic), rectangular prism, triangular prism, pentagonal prism, hexagonal prism, or the like. In one aspect, the pole 710 can be non-conductive. In another aspect, the pole 710 can include one or more metallic portions, such as one or more of caps, fasteners and/or adapters. For example, the pole 710 can include a metal cap coupled to an electrical ground for lightning protection.

In one aspect, the donor antenna 720 and server antenna 730 can be carried by the pole 710. In one instance, the server antenna 730 can be fixably mounted to a first side of the pole 710 and the donor antenna 720 can be fixably mounted to a second side of the pole 710 that is opposite to the first side of the pole 720. The donor antenna 720 mounted at the second side of the pole 710 can correspond to the top of the pole. The repeater 740 can be adapted for mounting on a structure 770 in a desired location adjacent to the pole 710. For example, repeater 740 can be mounted in a crew compartment of a marine vessel. In another example, the repeater 740 can be mounted in an emergency response command center or on an emergency response vehicle. In one instance, the donor antenna 720 and server antenna 730 are encompassed by the pole 710. The donor antenna 720 and server antenna 730 can be encompassed by the pole 710, by integrating the donor antenna 720 and server antenna 730 with the pole 710, or mounting the donor antenna 720 and server antenna 730 inside the pole 710.

In one aspect, a radiation pattern of the donor antenna 720 can be configured to reduce radiation directed toward the server antenna 730 to minimize feedback from the server antenna 730, through the repeater 740, to the donor antenna 720. A radiation pattern of the server antenna 730 can also be configured to reduce radiation directed toward the donor antenna 720 to minimize feedback from the donor antenna 720, through the repeater 740, to the server antenna 730. The repeater system can also include a radiation shield carried by the pole 710 and located between the donor antenna 720 and the server antenna 730. In one instance, the donor and/or server antenna 720, 730 can be directional antennas. The direction antenna can be electrically or mechanically steerable to direct the radiation pattern of the donor and/or server antenna 720, 730. For example, the donor antenna 720 can be steerable, wherein the downlink signal strength from one or more base stations are measured and the radiation pattern for the uplink signal is steered in the direction of the strongest downlink signal. In another instance, the donor and/or server antenna 720, 730 can be omnidirectional antennas.

In one aspect, the repeater system can also include a mounting apparatus 780 for securing the pole 710 to a vehicle 770 or structure. The mounting apparatus 780 can be a ratchet mount, a ram mount, a tripod, a stand, or the like. The mounting apparatus 780 can be fixed or movable. In one instance, the mounting apparatus 780, such as a ratchet mount, enables the pole 710 to be rotated to a vertical direction for use with the donor antenna 720 located near a top of the pole 710, and rotated to a horizontal direction for stowage. In one instance, the mounting apparatus 780 allows the pole 710 to be rotatably and/or removably mounted to a marine vessel. In another instance, the mounting apparatus 780 allows the pole 710 to be rotatably and/or removably mounted to a vehicle, such as an emergency response vehicle.

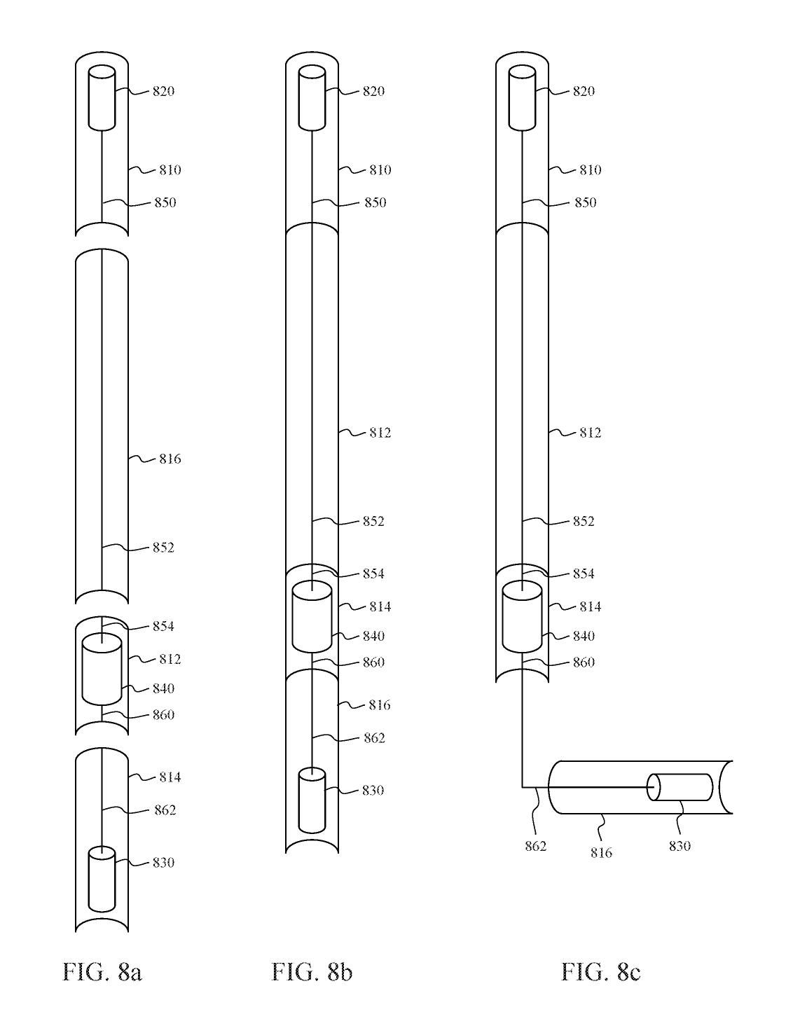

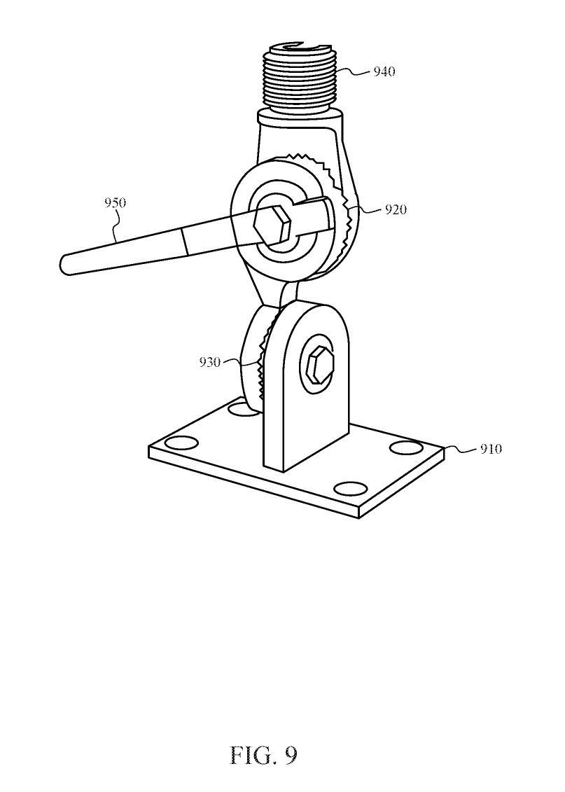

FIGS. 8a, 8b and 8c depict a repeater system, in accordance with another example. The repeater system can include a pole 810-816, one or more donor antennas 820, one or more server antennas 830, and a repeater 840. In one aspect, as illustrated in FIG. 8, the one or more donor antennas 820 can be configured to transmit and receive uplink and downlink signals between the repeater 840 and one or more base stations. The one or more server antennas 830 can be configured to transmit and receive uplink and downlink signals between the repeater 840 and one or more user devices.

In one aspect, the repeater 840 can be electrically coupled between the one or more donor antennas 820 and the one or more server antennas 830. In one instance, the repeater 840 can be electrically coupled by one or more cables 850-854, between the repeater 840 and the one or more donor antennas 820, and one or more cables 860-862 between the repeater 840 and the one or more server antennas 830. The cables 850-854, 860-862 can be coaxial cables to reduce coupling between the donor antenna 820 and the server antenna 830. The corresponding sections of cables 850-854, 860-862 can be coupled together by respective cable connectors.

The pole 810-816 can be any long, relatively slender mechanical support structure. The pole 810-816 can have a form factor of a cylinder (right circular, elliptic, parabolic, hyperbolic), rectangular prism, triangular prism, pentagonal prism, hexagonal prism, or the like. In one aspect, the pole 810-816 can include a plurality of sections that can be removably couplable together, as illustrated in FIGS. 8a and 8b. The sections of the pole 810-816 can be removably couplable by one or more locking or non-locking, screw-on, snap together, quarter twist or the like couplers. The couplers can be a conductive material such as a metal, or a non-conductive material such as a plastic. In one aspect, the pole 810-816 can be non-conductive. In another aspect, the pole 810-816 can include one or more metallic portions, such as one or more of caps, fasteners and/or adapters. For example, the pole 810-816 can include a metal cap coupled to an electrical ground for lightning protection.

In one implementation, the one or more donor antennas 820 can be carried by a first section of the pole 810, the repeater 840 can be carried by a second section of the pole 812, and the one or more server antennas 830 can be carried by a third section of the pole 816. The pole 810-816 can also include one or more additional sections, such as an extension section 816. The one or more extension sections 816 can increase the height of the one or more donor antennas 820 to increase reception between the repeater 840 and one or more base stations. The one or more extension sections 816 can also increase isolation to minimize feedback from the donor antenna 820, through the repeater 840, to the server antenna 830, and/or from the server antenna 830, through the repeater 840 to the donor antenna 820. In another implementation, the one or more donor antennas 820 and the repeater 840 can be carried by a first section of the pole, and the one or more server antennas 830 can be carried by a second section of the pole.

In one aspect, the section of the pole 814 including the one or more server antennas 830 can optionally be removably couplable to permit the section of the pole 814 including the one or more server antennas 830 to be mounted on a structure in a desired location, as illustrated in FIG. 8c. For example, the bottom section of the pole 814 including the one or more server antennas 830 can be removed and mounted in a crew compartment of a marine vessel. In another example, the bottom section of the pole 814 including the one or more server antennas 830 can be removed and mounted in a mobile emergency response command center or on an emergency response vehicle. In one aspect, the one or more donor antennas 820, the one or more serve antennas 830 and the repeater 840 can be encompassed by respective sections of the pole 810-816, by integrating the one or more donor antennas 820, the one or more server antennas 830 and the repeater 840 with respective sections the pole 810-816, or mounting the one or more donor antennas 820, the one or more server antennas 830 and the repeater 840 inside the respective sections of the pole 810-816.

In one aspect, a radiation pattern of the one or more donor antennas 820 can be configured to reduce radiation directed toward the one or more server antennas 830 to minimize feedback. A radiation pattern of the one or more server antennas 830 can also be configured to reduce radiation directed toward the one or more donor antennas 820 to minimize feedback. The repeater system can also include a radiation shield carried by the pole 810-816 and located between the one or more donor antennas 820 and the one or more server antennas 830. In one instance, one or more of the donor antennas 820 and/or one or more of the server antennas 830 can be directional antennas. The direction antenna can be electrically or mechanically steerable to direct the radiation pattern of the one or more donor and/or server antennas 820, 830. For example, the donor antenna can be steerable, wherein the downlink signal strength from one or more base stations are measured and the radiation pattern for the uplink signal is steered in the direction of the strongest downlink signal. In another instance, the one or more donor antennas 820 and/or the one or more server antennas 830 can be omnidirectional antennas.

In one aspect, the repeater system can also include a mounting apparatus for securing one or more sections of the pole 810-816 to a vehicle or structure. The mounting apparatus can be a ratchet mount, a ram mount, a tripod, a stand, or the like. The mounting apparatus can be fixed or movable. In one instance, the mounting apparatus, such as a ratchet mount, can enable one or more sections of the pole 810-816 to be rotated to a vertical direction for use with the donor antenna 820 located near a top of the pole 810, and rotated to a horizontal direction for stowage. In one instance, the mounting apparatus allows the pole 810-816 to be rotatably and/or removably mounted to a marine vessel. In another instance, the mounting apparatus allows the pole 810-816 to be rotatably and/or removably mounted to a vehicle, such as an emergency response vehicle.

FIG. 9 depicts a ratchet mount, in accordance with an example. The ratchet mount can be utilized to secure the pole of the repeater system to a vehicle or structure. The ratchet mount can include a base 910, one or more swiveling ratchet points 920, 930, and a threaded coupler 940. The threaded coupler 940 can removably couple to the pole, and the base 910 can be affixed to the vehicle or structure. The one or more swiveling ratchet points 920, 930 can each include a plurality of teeth on mating surfaces that are engaged by rotation of a handle 950 or other tightening means. The one or more swiveling ratchet points 920, 930 can be configured for quickly raising and lowering the pole one or more directions of rotation.

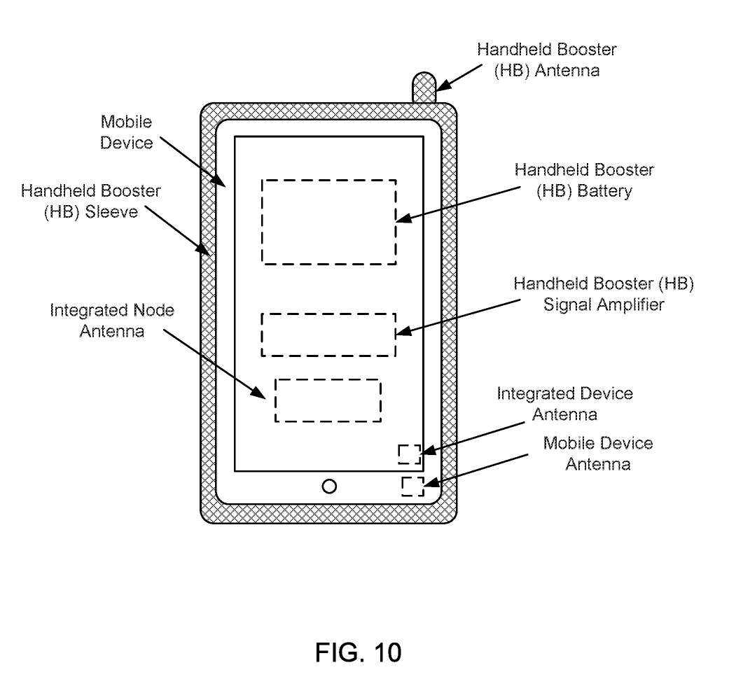

While various embodiments described herein, and illustrated in FIGS. 1-9, have been described with respect to a repeater with a donor antenna and a server antenna, this is not intended to be limiting. A repeater can also be accomplished using a handheld booster, as illustrated in FIG. 10. The handheld booster can include an integrated server antenna and one or more integrated donor antennas.

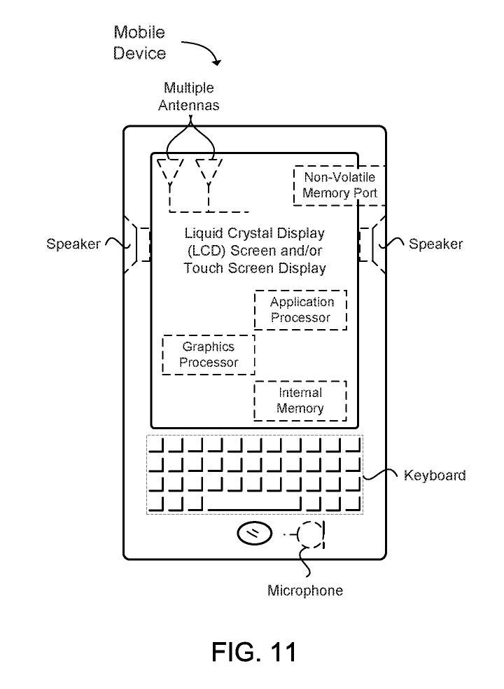

FIG. 11 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband processing unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard such as, but not limited to, 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN. The wireless device can also comprise a wireless modem. The wireless modem can comprise, for example, a wireless radio transceiver and baseband circuitry (e.g., a baseband processor). The wireless modem can, in one example, modulate signals that the wireless device transmits via the one or more antennas and demodulate signals that the wireless device receives via the one or more antennas.

FIG. 11 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be integrated with the wireless device or wirelessly connected to the wireless device to provide additional user input. A virtual keyboard can also be provided using the touch screen.

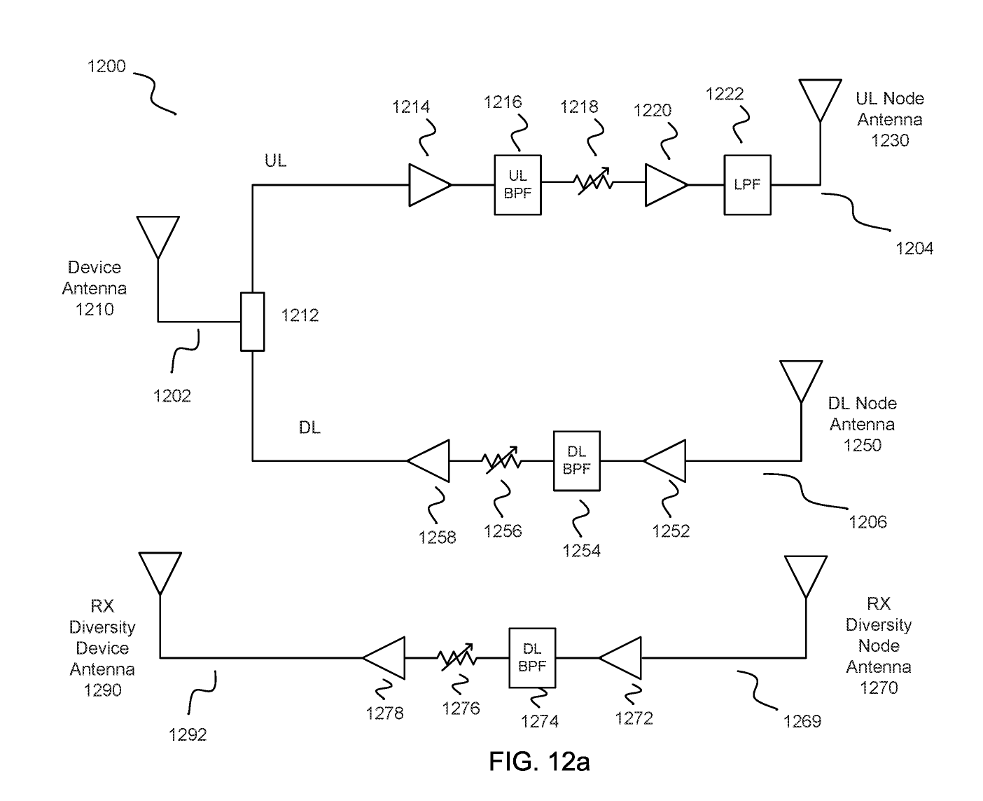

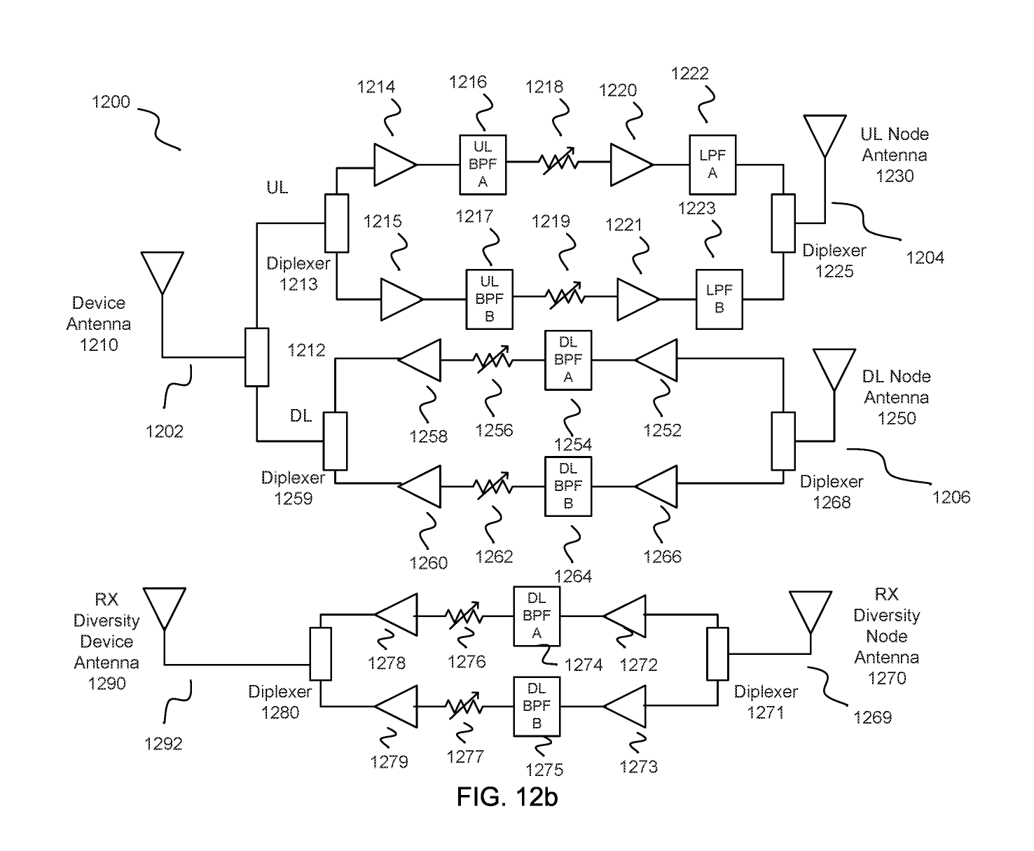

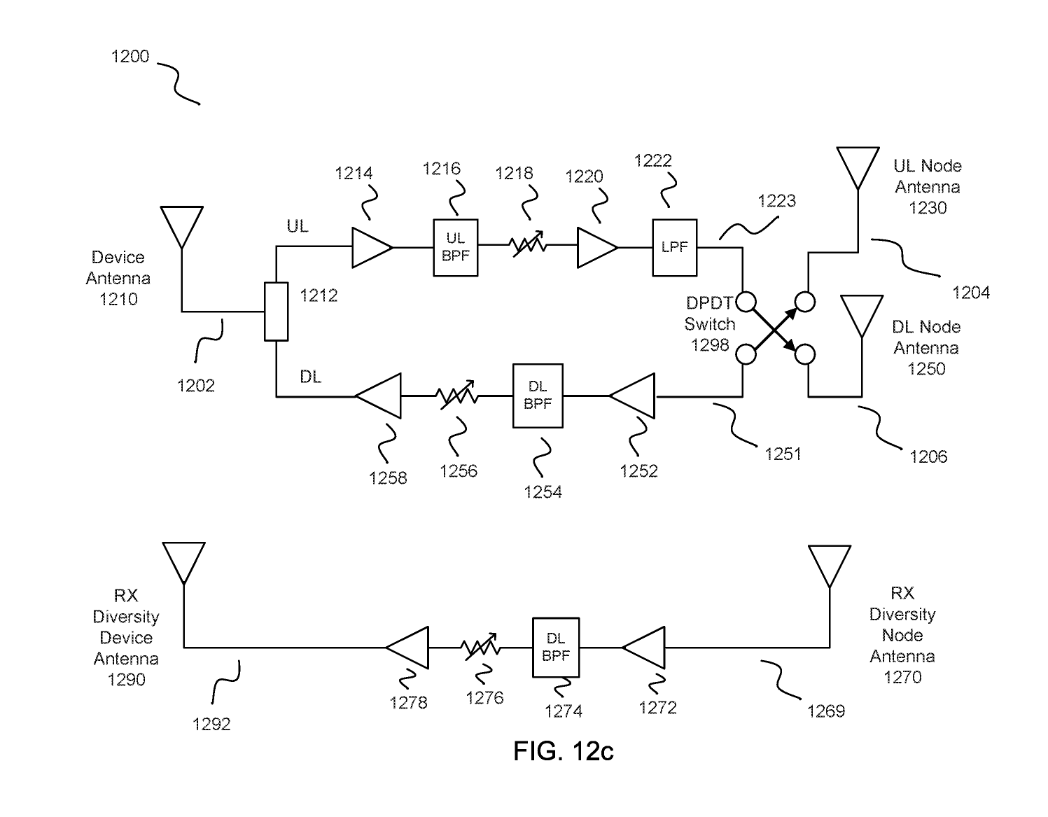

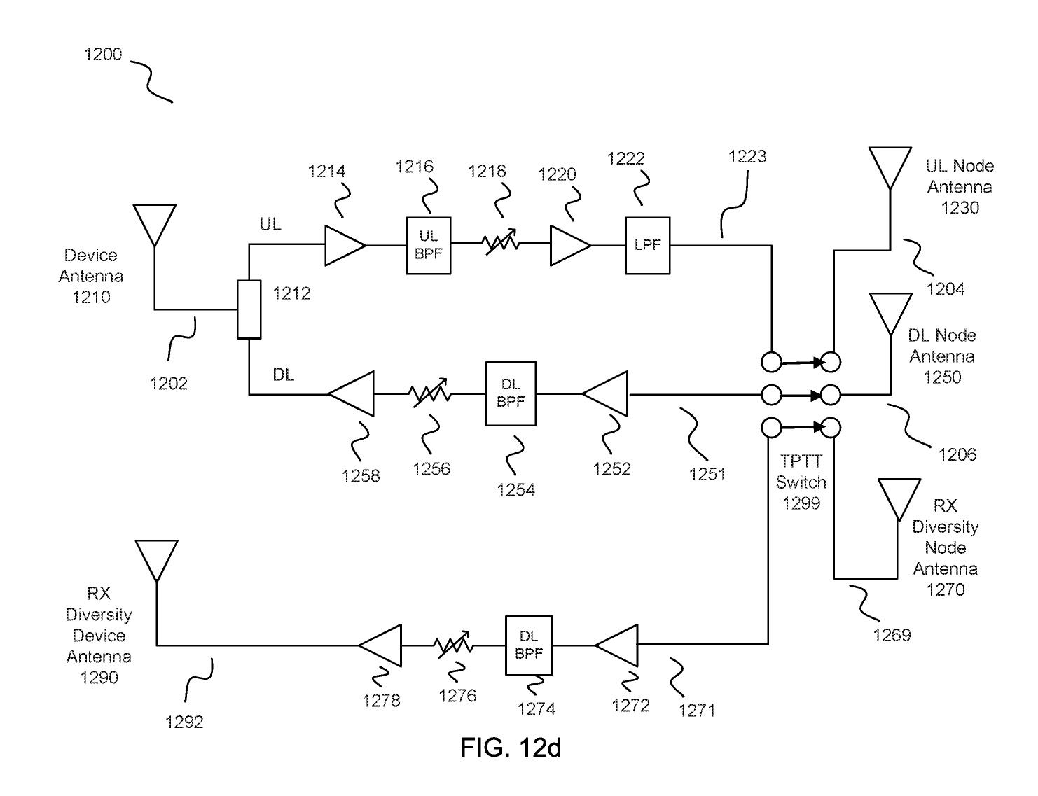

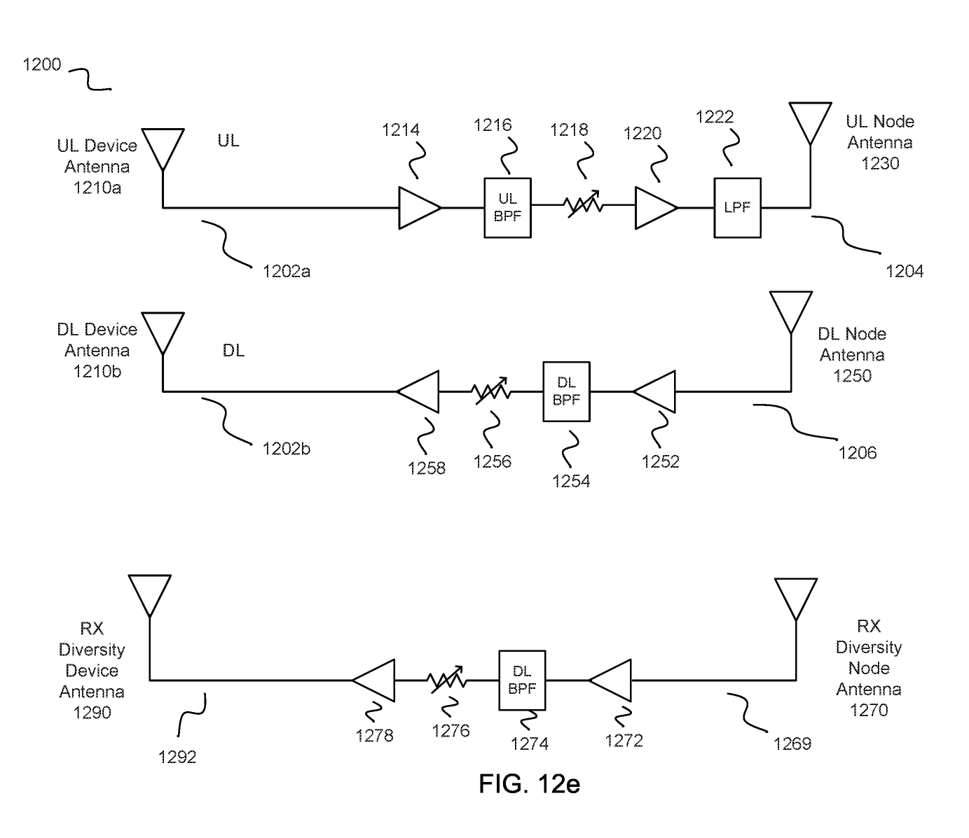

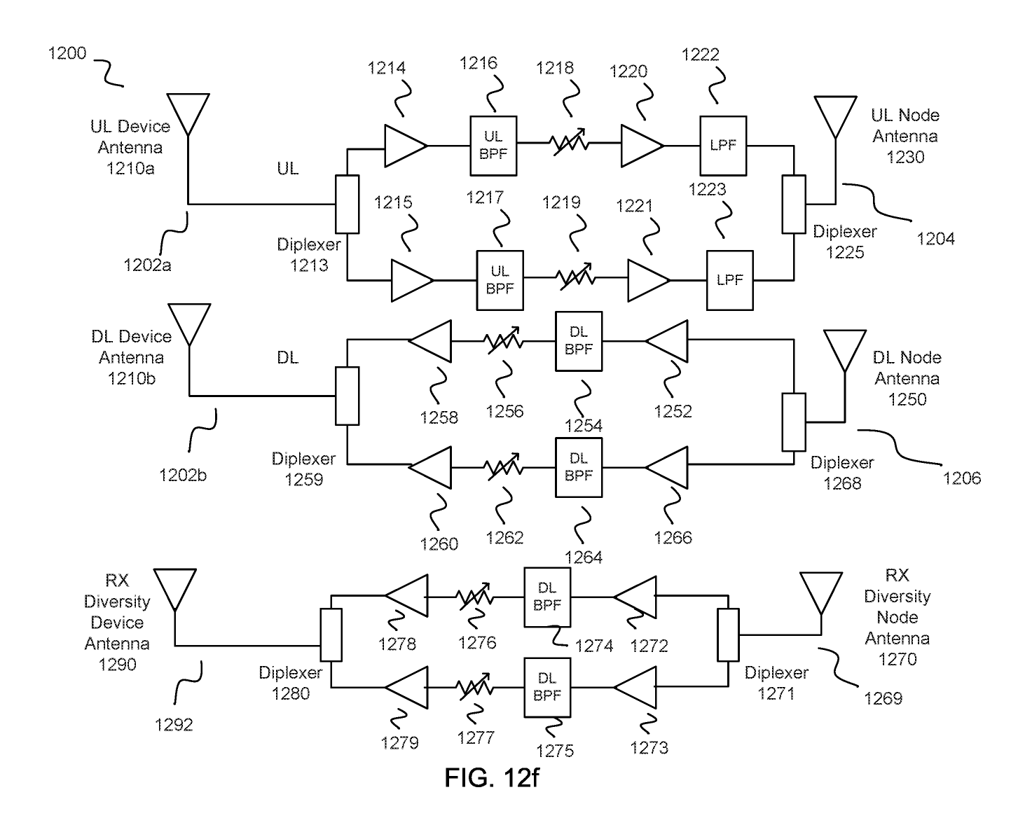

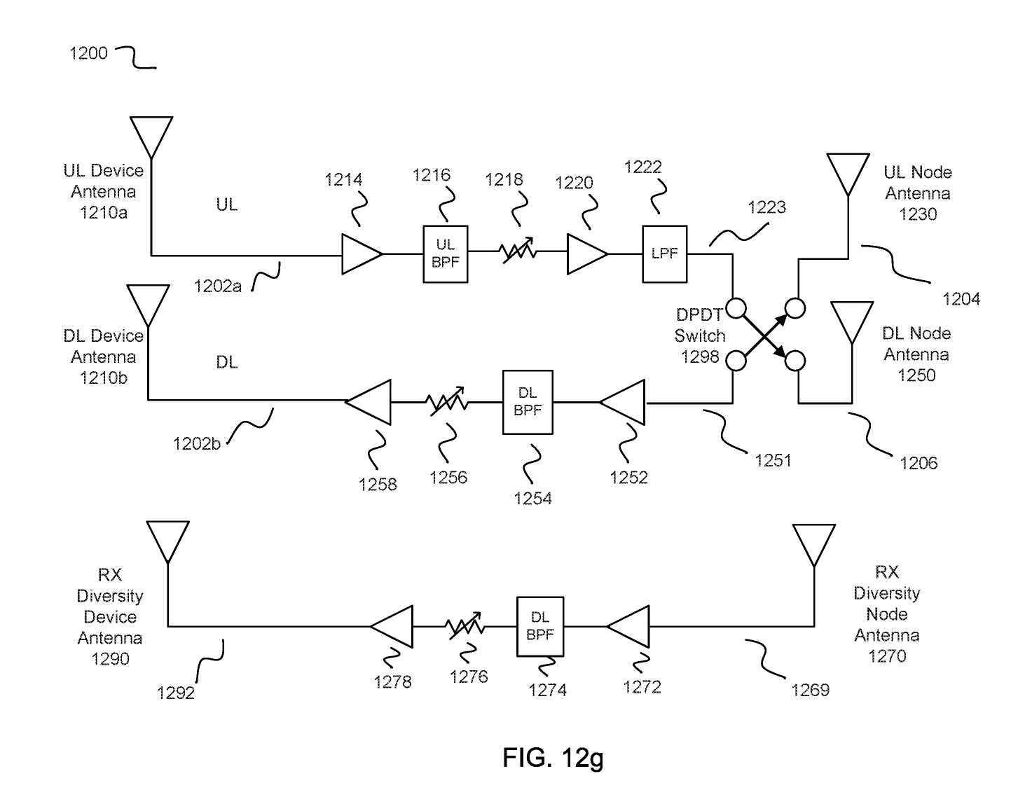

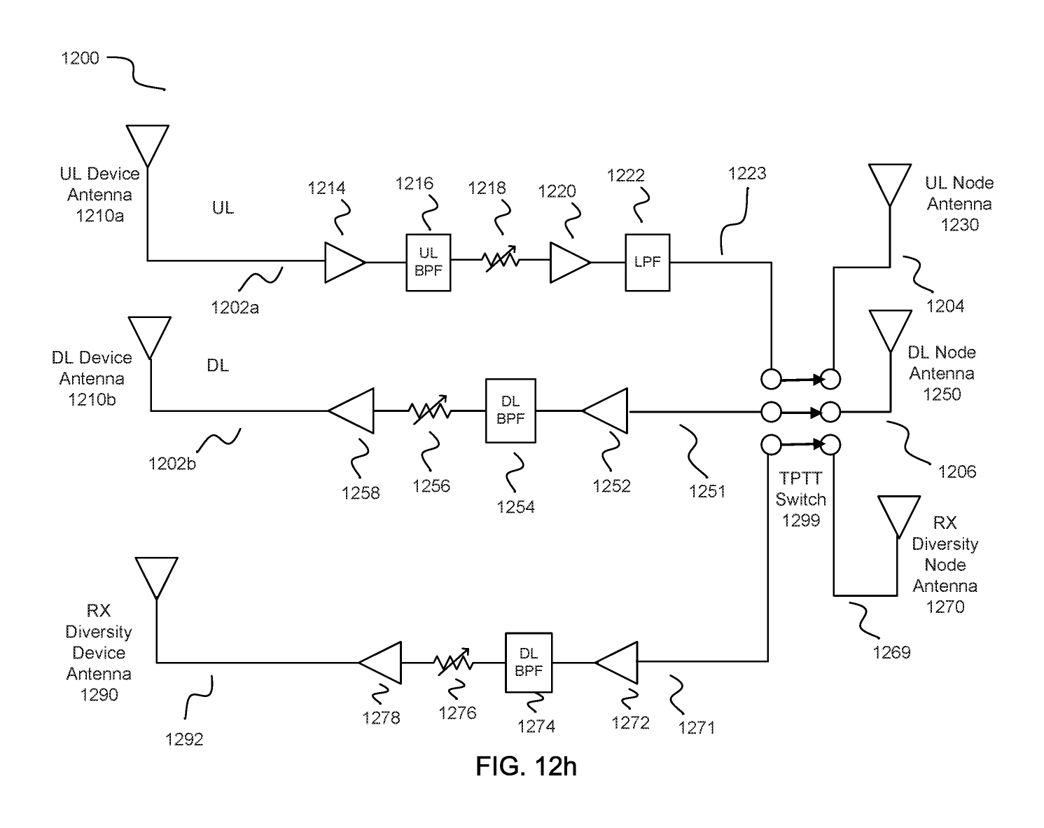

In another example, as illustrated in FIG. 12a, a repeater can comprise a separate uplink node port and a downlink node port. The uplink node port can be configured to be coupled to an uplink node port. Similarly, the downlink node port can be configured to be coupled to a downlink node antenna. The use of two separate node ports can eliminate or reduce loss that typically occurs in a diplexer, duplexer, and/or multiplexer that is used to couple an uplink path with a downlink path at a single node. In addition, a receive diversity antenna port can be coupled to a receive diversity amplification and filtering path to enable the repeater 1200 to be configured to be coupled to a receive diversity device antenna 1290 and a receive diversity node antenna 1270. The receive diversity amplification and filtering path can allow a downlink signal to be amplified from the receive diversity node antenna to optimize reception of a downlink signal transmitted from a base station to a user device having a diversity antenna to allow the user device to use spatial diversity in receiving the downlink signal.

In another example, the use of a separate UL node antenna, DL node antenna, and RX diversity node antenna can optimize the output power over the band because the antenna load impedance can change less frequently due to a lower quality (Q) factor. In one example, impedance matching can be difficult with filters, especially over wide bandwidths, because of the high Q factor that varies over frequency more frequently. As such, the output of a power amplifier can be optimized when coupled to common output impedance (e.g., separate antennas) instead of a varying output impedance (e.g., filters).

In another example, coupling a filter to the output of the power amplifier can increase the chances of a filter breaking. In one example, surface acoustic wave (SAW) filters or bulk acoustic wave (BAW) filters can only have a maximum input power of about 28-32 decibel-milliwatts (dBm) before breaking. In one example, ceramic filters can only have a maximum input power of about 36 dBm before breaking. Removing the filter from the output of the power amplifier by using separate antennas can reduce the chances of filter breakage and allow the use of higher-power PAs.

In the example of FIG. 12a, a bi-directional inside antenna port 1202 or bi-directional device antenna port 1202 can be configured to be coupled to an integrated device antenna 1210 or a bi-directional inside antenna 1210. The integrated device antenna 1210 can receive an UL signal from a UE. The bi-directional inside antenna port 1202 can be configured to be coupled to a duplexer 1212. The duplexer 1212 can split into an UL path and a DL path. While a duplexer is illustrated in FIG. 12a, it is not intended to be limiting. A duplexer, as used in FIGS. 12a-d, and 12f, can be a duplexer, a diplexer, a multiplexer, a circulator, or a splitter.

In another example, the UL path can comprise one or more of a low-noise amplifier 1214, an UL band-pass filter (BPF) 1216, a variable attenuator 1218, a power amplifier (PA) 1220, or a low-pass filter (LPF) 1222. The low-noise amplifier 1214 can be an UL low-noise amplifier, the variable attenuator 1218 can be an UL variable attenuator, the power amplifier 1220 can be an UL power amplifier, and the low-pass filter 1222 can be an UL low-pass filter or low-order filtering. In another example, the power amplifier 1220 can comprise a variable gain power amplifier, a fixed-gain power amplifier, or a gain block. In another example, the LPF 1222 can be configured to be coupled between the power amplifier 1220 and an UL outside antenna port 1204 or UL node antenna port 1204 to filter harmonics emitted by the power amplifier 1220. While a low pass filter is described in this example, it is not intended to be limiting. A low-order filter can be used to filter the harmonics. The low order filter can include one or more high pass filter poles and one or more low pass filter poles. The low-order filter can be configured to have low loss since it is located after the power amplifier 1220.

In another example, the power amplifier 1220 can be configured to be coupled directly to the UL outside antenna port 1204 without filtering between the power amplifier 1220 and the UL outside antenna port. In another example, the UL BPF 1216 can be an FDD UL BPF configured to pass one or more of 3GPP FDD frequency bands 2, 4, 5, 12, 13, 17, 25, 26, or 71. In another example, the UL BPF 1216 can be an FDD UL BPF configured to pass one or more of 3GPP LTE FDD frequency bands 1-28, 30, 31, 65, 66, 68, 70-74, or 85. In another example, the UL BPF 1216 can be an LTE or 5G FDD UL BPF configured to pass a selected channel within an LTE or 5G 3GPP FDD band. In another example, the UL BPF 1216 can be an LTE or 5G FDD UL BPF configured to pass a selected frequency range within an LTE or 5G 3GPP FDD band.

In another example, after traveling on the UL path, the UL signal can be amplified and filtered in accordance with the type of amplifiers and BPFs included on the UL path. The UL signal can be directed to an UL node antenna port 1204. The UL signal can be directed from the UL node antenna port 1204 to an integrated UL node antenna 1230 or an UL outside antenna 1230. The UL node antenna 1230 can be an omnidirectional antenna or a directional antenna. The UL outside antenna 1230 can communicate the amplified and/or filtered UL signal to a base station.

In another example, an integrated DL node antenna port 1206 or DL outside antenna port 1206 can be configured to be coupled to an integrated DL node antenna 1250 or a DL outside antenna 1250. The integrated DL node antenna 1250 can be an omnidirectional antenna or directional antenna. The integrated DL node antenna 1250 can receive a DL signal from a base station. The DL outside antenna port 1206 can be configured to be coupled to a low-noise amplifier 1252.

In another example, the DL path can comprise one or more of the low-noise amplifier 1252, a DL band-pass filter (BPF) 1254, a variable attenuator 1256, or a power amplifier (PA) 1258. The low-noise amplifier 1252 can be a DL low-noise amplifier, the variable attenuator 1256 can be a DL variable attenuator, and the power amplifier 1258 can be a DL power amplifier. In another example, the power amplifier 1258 can comprise a variable gain power amplifier, a fixed-gain power amplifier, or a gain block. In another example, the low-noise amplifier 1252 can be configured to be coupled directly to a DL outside antenna port 1206 without filtering between the low-noise amplifier 1252 and the DL outside antenna port. In another example, the DL BPF 1254 can be an FDD DL BPF configured to pass one or more of 3GPP FDD frequency bands 2, 4, 5, 12, 13, 17, 25, 26, or 71. In another example, the DL BPF 1254 can be an FDD DL BPF configured to pass one or more of 3GPP FDD frequency bands 1-28, 30, 31, 65, 66, 68, 70-74, or 85. In another example, the DL BPF 1254 can be an FDD DL BPF configured to pass a selected channel within a 3GPP FDD band. In another example, the DL BPF 1254 can be an FDD DL BPF configured to pass a selected frequency range within a 3GPP FDD band.

In another example, after traveling on the DL path, the DL signal can be amplified and filtered in accordance with the type of amplifiers and BPFs included on the DL path. The DL signal can be directed from the power amplifier 1258 to a duplexer 1212. The DL signal can be directed from the duplexer 1212 to an integrated device antenna 1210 or a bi-directional inside antenna 1210. The integrated device antenna 1210 can communicate the amplified and/or filtered DL signal to a UE.

In another example, a receive diversity DL outside antenna port 1269 or receive diversity DL node antenna port 1269 or receive diversity DL donor antenna port 1269 can be configured to be coupled to a receive diversity DL outside antenna 1270 or receive diversity DL node antenna 1270 or receive diversity DL donor antenna 1270. The receive diversity DL node antenna 1270 can be an omnidirectional antenna or directional antenna. The receive diversity DL node antenna 1270 can receive a DL signal from a base station. The receive diversity DL outside antenna port 1269 can be configured to be coupled to a low-noise amplifier 1272.

In another example, the receive diversity DL path can comprise one or more of the low-noise amplifier 1272, a DL band-pass filter (BPF) 1274, a variable attenuator 1276, or a power amplifier (PA) 1278. The low-noise amplifier 1272 can be a DL low-noise amplifier, the variable attenuator 1276 can be a DL variable attenuator, and the power amplifier 1278 can be a DL power amplifier. In another example, the power amplifier 1278 can comprise a variable gain power amplifier, a fixed-gain power amplifier, or a gain block. In another example, the low-noise amplifier 1272 can be configured to be coupled directly to a receive diversity DL outside antenna port 1269 without filtering between the low-noise amplifier 1272 and the receive diversity DL outside antenna port 1269. In another example, the DL BPF 1274 can be an FDD DL BPF configured to pass one or more of 3GPP FDD frequency bands 2, 4, 5, 12, 13, 17, 25, 26, or 71. In another example, the DL BPF 1274 can be an FDD DL BPF configured to pass one or more of 3GPP FDD frequency bands 1-28, 30, 31, 65, 66, 68, 70-74, or 85. In another example, the DL BPF 1274 can be an FDD DL BPF configured to pass a selected channel within a 3GPP FDD band. In another example, the DL BPF 1274 can be an FDD DL BPF configured to pass a selected frequency range within a 3GPP FDD band. In another example, in an alternative, the receive diversity DL path can comprise the receive diversity DL outside antenna port 1269 coupled to a bypass path coupled between the receive diversity DL inside antenna port 1292 and the receive diversity DL outside antenna port 1269. The bypass path can be configured to not amplify or filter signals traveling on the bypass path.

In another example, after traveling on the receive diversity DL path, the receive diversity signal can be amplified and filtered in accordance with the type of amplifiers and BPFs included on the receive diversity DL path. In another example, in an alternative, the receive diversity signal can travel on a bypass path coupled between the receive diversity DL inside antenna port 1292 and the receive diversity DL outside antenna port 1269, wherein the bypass path does not amplify or filter the receive diversity signal. The receive diversity signal can be directed from the power amplifier 1278 to a receive diversity device antenna port 1292 or a receive diversity downlink inside antenna port 1292. The receive diversity device antenna port 1292 or a receive diversity downlink inside antenna port 1292 can be configured to be coupled to receive diversity device antenna 1290 or a receive diversity downlink inside antenna 1290. The receive diversity device antenna 1290 can communicate the amplified and/or filtered or bypassed receive diversity signal to a UE.

In another example, as illustrated in FIG. 12b, a multiband repeater can comprise a receive diversity antenna port. In this example, a bi-directional inside antenna port 1202 or bi-directional device antenna port 1202 can be configured to be coupled to an integrated device antenna 1210 or a bi-directional inside antenna 1210. The integrated device antenna 1210 can receive an UL signal from a UE. The bi-directional inside antenna port 1202 can be configured to be coupled to a duplexer 1212. The duplexer 1212 can split into an UL path and a DL path. In another example, the UL path can further comprise a first UL path and a second UL path. A diplexer 1213 can direct an UL signal to the first UL path or the second UL path. The diplexer 1213 can be a duplexer, a common direction duplexer, a diplexer, a multiplexer, a circulator, or a splitter.

In another example, a first UL path can comprise one or more of a low-noise amplifier 1214, an UL band-pass filter (BPF) 1216, a variable attenuator 1218, a power amplifier (PA) 1220, or a low-pass filter (LPF) 1222. The low-noise amplifier 1214 can be an UL low-noise amplifier, the variable attenuator 1218 can be an UL variable attenuator, the power amplifier 1220 can be a UL power amplifier, and the low-pass filter 1222 can be an UL low-pass filter or low-order filtering. In another example, the power amplifier 1220 can comprise a variable gain power amplifier, a fixed-gain power amplifier, or a gain block. In another example, the LPF can be configured to be coupled between the power amplifier 1220 and an UL outside antenna port 1204 or UL node antenna port 1204 to filter harmonics emitted by the power amplifier 1220. While a low pass filter is described in this example, it is not intended to be limiting. A low-order filter can be used to filter the harmonics. The low order filter can include one or more high pass filter poles and one or more low pass filter poles. The low-order filter can be configured to have low loss since it is located after the power amplifier 1220. In another example, the power amplifier 1220 can be configured to be coupled directly to the UL outside antenna port 1204 without filtering between the power amplifier 1220 and the UL outside antenna port. In another example, the UL BPF 1216 can be an FDD UL BPF configured to pass one or more of 3GPP FDD frequency bands 2, 4, 5, 12, 13, 17, 25, 26, or 71. In another example, the UL BPF 1216 can be an FDD UL BPF configured to pass one or more of 3GPP FDD frequency bands 1-28, 30, 31, 65, 66, 68, 70-74, or 85. In another example, the UL BPF 1216 can be an FDD UL BPF configured to pass a selected channel within a 3GPP FDD band. In another example, the UL BPF 1216 can be an FDD UL BPF configured to pass a selected frequency range within a 3GPP FDD band.

In another example, a second UL path can comprise one or more of a low-noise amplifier 1215, an UL band-pass filter (BPF) 1217, a variable attenuator 1219, a power amplifier (PA) 1221, or a low-pass filter (LPF) 1223. The low-noise amplifier 1215 can be an UL low-noise amplifier, the variable attenuator 1219 can be an UL variable attenuator, the power amplifier 1221 can be a UL power amplifier, and the low-pass filter 1223 can be an UL low-pass filter or low-order filtering. In another example, the power amplifier 1221 can comprise a variable gain power amplifier, a fixed-gain power amplifier, or a gain block.

In another example, the LPF 1223 can be configured to be coupled between the power amplifier 1221 and an UL outside antenna port 1204 or UL node antenna port 1204 to filter harmonics emitted by the power amplifier 1221. While a low pass filter is described in this example, it is not intended to be limiting. A low-order filter can be used to filter the harmonics. The low order filter can include one or more high pass filter poles and one or more low pass filter poles. The low-order filter can be configured to have low loss since it is located after the power amplifier 1221. In another example, the power amplifier 1221 can be configured to be coupled to the UL outside antenna port 1204 without filtering between the power amplifier 1221 and the UL outside antenna port 1204. In another example, the UL BPF 1217 can be an FDD UL BPF configured to pass one or more of 3GPP FDD frequency bands 2, 4, 5, 12, 13, 17, 25, 26, or 71, wherein the one or more 3GPP frequency bands passed on the second UL path can be different from the 3GPP frequency bands passed on the first UL path. In another example, the UL BPF 1217 can be an FDD UL BPF configured to pass one or more of 3GPP FDD frequency bands 1-28, 30, 31, 65, 66, 68, 70-74, or 85, wherein the one or more 3GPP frequency bands passed on the second UL path can be different from the 3GPP frequency bands passed on the first UL path.

In another example, the UL BPF 1217 can be an FDD UL BPF configured to pass a selected channel within a 3GPP FDD band, wherein the selected channel passed on the second UL path can be different from the selected channel passed on the first UL path. In another example, the UL BPF 1217 can be an FDD UL BPF configured to pass a selected frequency range within a 3GPP FDD band, wherein the selected frequency range passed on the second UL path can be different from the selected frequency range passed on the first UL path.

In another example, after traveling on the first or second UL paths, the UL signal on the first UL path and the UL signal on the second UL path can be amplified and filtered in accordance with the type of amplifiers and BPFs included on the first UL path or the second UL path. The signal from the first UL path and the signal from the second UL path can be directed to a diplexer 1225. The diplexer 1225 can be a duplexer, a common direction duplexer, a diplexer, a multiplexer, a circulator, or a splitter. From the diplexer 1225, the combined UL signal can be directed to an UL node antenna port 1204. The UL signal can be directed from the UL node antenna port 1204 to an integrated UL node antenna 1230 or an UL outside antenna 1230. The UL node antenna 1230 can be an omnidirectional antenna or a directional antenna. The UL outside antenna 1230 can communicate the amplified and/or filtered UL signal to a base station.

In another example, an integrated DL node antenna port 1206 or DL outside antenna port 1206 can be configured to be coupled to an integrated DL node antenna 1250 or a DL outside antenna 1250. The integrated DL node antenna 1250 can be an omnidirectional antenna or directional antenna. The integrated DL node antenna 1250 can receive a DL signal from a base station. The DL outside antenna port 1206 can be configured to be coupled to a diplexer 1268 that can be configured to direct a DL signal on a first DL path or a second DL path. The diplexer 1268 can be a duplexer, a common direction duplexer, a diplexer, a multiplexer, a circulator, or a splitter.

In another example, the first DL path can comprise one or more of a low-noise amplifier 1252, a DL band-pass filter (BPF) 1254, a variable attenuator 1256, or a power amplifier (PA) 1258. The low-noise amplifier 1251 can be a DL low-noise amplifier, the variable attenuator 1256 can be a DL variable attenuator, and the power amplifier 1258 can be a DL power amplifier. In another example, the power amplifier 1258 can comprise a variable gain power amplifier, a fixed-gain power amplifier, or a gain block. In another example, the low-noise amplifier 1252 can be configured to be coupled to a DL outside antenna port 1206 without filtering between the low-noise amplifier 1252 and the DL outside antenna port. In another example, the DL BPF 1254 can be an FDD DL BPF configured to pass one or more of 3GPP FDD frequency bands 2, 4, 5, 12, 13, 17, 25, 26, or 71. In another example, the DL BPF 1254 can be an FDD DL BPF configured to pass one or more of 3GPP FDD frequency bands 1-28, 30, 31, 65, 66, 68, 70-74, or 85. In another example, the DL BPF 1254 can be an FDD DL BPF configured to pass a selected channel within a 3GPP FDD band. In another example, the DL BPF 1254 can be an FDD DL BPF configured to pass a selected frequency range within a 3GPP FDD band.

In another example, the second DL path can comprise one or more of a low-noise amplifier 1266, a DL band-pass filter (BPF) 1264, a variable attenuator 1262, or a power amplifier (PA) 1260. The low-noise amplifier 1266 can be a DL low-noise amplifier, the variable attenuator 1262 can be a DL variable attenuator, and the power amplifier 1260 can be a DL power amplifier. In another example, the power amplifier 1260 can comprise a variable gain power amplifier, a fixed-gain power amplifier, or a gain block. In another example, the low-noise amplifier 1266 can be configured to be coupled to a DL outside antenna port 1206 without filtering between the low-noise amplifier 1266 and the DL outside antenna port 1206. In another example, the DL BPF 1264 can be an FDD DL BPF configured to pass one or more of 3GPP FDD frequency bands 2, 4, 5, 12, 13, 17, 25, 26, or 71, wherein the one or more 3GPP frequency bands passed on the second DL path can be different from the 3GPP frequency bands passed on the first DL path. In another example, the DL BPF 1264 can be an FDD DL BPF configured to pass one or more of 3GPP FDD frequency bands 1-28, 30, 31, 65, 66, 68, 70-74, or 85, wherein the one or more 3GPP frequency bands passed on the second DL path can be different from the 3GPP frequency bands passed on the first DL path. In another example, the DL BPF 1264 can be an FDD DL BPF configured to pass a selected channel within a 3GPP FDD band, wherein the selected channel passed on the second DL path can be different from the selected channel passed on the first DL path. In another example, the DL BPF 1264 can be an FDD DL BPF configured to pass a selected frequency range within a 3GPP FDD band, wherein the selected frequency range passed on the second DL path can be different from the selected frequency range passed on the first DL path.

In another example, after traveling on the first DL path or the second DL path, the DL signal on the first DL path and the DL signal on the second DL path can be amplified and filtered in accordance with the type of amplifiers and BPFs included on the first DL path and the second DL path. The signal from the first DL path and the signal from the second DL path can be directed to a diplexer 1259. The diplexer 1259 can be a duplexer, a common direction duplexer, a diplexer, a multiplexer, a circulator, or a splitter. From the diplexer 1259, the combined DL signal can be directed to a duplexer 1212. The DL signal can be directed from the duplexer 1212 to an integrated device antenna 1210 or a bi-directional inside antenna 1210. The integrated device antenna 1210 can communicate the amplified and/or filtered DL signal to a UE.

In another example, a receive diversity DL outside antenna port 1269 or receive diversity DL node antenna port 1269 or receive diversity DL donor antenna port 1269 can be configured to be coupled to a receive diversity DL outside antenna 1270 or receive diversity DL node antenna 1270 or receive diversity DL donor antenna 1270. The receive diversity DL node antenna 1270 can be an omnidirectional antenna or directional antenna. The receive diversity DL node antenna 1270 can receive a DL signal from a base station. The receive diversity DL outside antenna port 1269 can be configured to be coupled to a diplexer 1271 that can be configured to direct a DL signal on a first receive diversity DL path or a second received diversity DL path. The diplexer 1271 can be a duplexer, a common direction duplexer, a diplexer, a multiplexer, a circulator, or a splitter.

In another example, the first receive diversity DL path can comprise one or more of a low-noise amplifier 1272, a DL band-pass filter (BPF) 1274, a variable attenuator 1276, or a power amplifier (PA) 1278. The low-noise amplifier 1272 can be a DL low-noise amplifier, the variable attenuator 1276 can be a DL variable attenuator, and the power amplifier 1278 can be a DL power amplifier. In another example, the power amplifier 1278 can comprise a variable gain power amplifier, a fixed-gain power amplifier, or a gain block. In another example, the low-noise amplifier 1272 can be configured to be coupled directly to a receive diversity DL outside antenna port 1269 without filtering between the low-noise amplifier 1272 and the receive diversity DL outside antenna port 1269. In another example, the DL BPF 1274 can be an FDD DL BPF configured to pass one or more of 3GPP FDD frequency bands 2, 4, 5, 12, 13, 17, 25, 26, or 71. In another example, the DL BPF 1274 can be an FDD DL BPF configured to pass one or more of 3GPP FDD frequency bands 1-28, 30, 31, 65, 66, 68, 70-74, or 85. In another example, the DL BPF 1274 can be an FDD DL BPF configured to pass a selected channel within a 3GPP FDD band. In another example, the DL BPF 1274 can be an FDD DL BPF configured to pass a selected frequency range within a 3GPP FDD band. In another example, in an alternative, the receive diversity DL path can comprise the receive diversity DL outside antenna port 1269 coupled to a bypass path coupled between the receive diversity DL inside antenna port 1292 and the receive diversity DL outside antenna port 1269. The bypass path can be configured to not amplify or filter signals traveling on the bypass path.

In another example, the second receive diversity DL path can comprise one or more of a low-noise amplifier 1273, a DL band-pass filter (BPF) 1275, a variable attenuator 1277, or a power amplifier (PA) 1279. The low-noise amplifier 1273 can be a DL low-noise amplifier, the variable attenuator 1277 can be a DL variable attenuator, and the power amplifier 1279 can be a DL power amplifier. In another example, the power amplifier 1279 can comprise a variable gain power amplifier, a fixed-gain power amplifier, or a gain block. In another example, the low-noise amplifier 1273 can be configured to be coupled directly to a receive diversity DL outside antenna port 1269 without filtering between the low-noise amplifier 1273 and the receive diversity DL outside antenna port 1269. In another example, the DL BPF 1275 can be an FDD DL BPF configured to pass one or more of 3GPP FDD frequency bands 2, 4, 5, 12, 13, 17, 25, 26, or 71, wherein the one or more 3GPP frequency bands passed on the second receive diversity DL path can be different from the 3GPP frequency bands passed on the first receive diversity DL path. In another example, the DL BPF 1275 can be an FDD DL BPF configured to pass one or more of 3GPP FDD frequency bands 1-28, 30, 31, 65, 66, 68, 70-74, or 85, wherein the one or more 3GPP frequency bands passed on the second receive diversity DL path can be different from the 3GPP frequency bands passed on the first receive diversity DL path. In another example, the DL BPF 1275 can be an FDD DL BPF configured to pass a selected channel within a 3GPP FDD band, wherein the selected channel passed on the second receive diversity DL path can be different from the selected channel passed on the first receive diversity DL path. In another example, the DL BPF 1275 can be an FDD DL BPF configured to pass a selected frequency range within a 3GPP FDD band, wherein the selected frequency range passed on the second receive diversity DL path can be different from the selected frequency range passed on the first receive diversity DL path. In another example, in an alternative, the receive diversity DL path can comprise the receive diversity DL outside antenna port 1269 coupled to a bypass path coupled between the receive diversity DL inside antenna port 1292 and the receive diversity DL outside antenna port 1269. The bypass path can be configured to not amplify or filter signals traveling on the bypass path.

In another example, after traveling on the first receive diversity DL path or the second receive diversity DL path, the receive diversity signal on the first receive diversity DL path and the DL signal on the second receive diversity DL path can be amplified and filtered in accordance with the type of amplifiers and BPFs included on the first receive diversity DL path and the second receive diversity DL path. The signal from the first receive diversity DL path and the signal from the second receive diversity DL path can be directed to a diplexer 1280. The diplexer 1280 can be a duplexer, a common direction duplexer, a diplexer, a multiplexer, a circulator, or a splitter. From the diplexer 1280, the combined receive diversity DL signal can be directed to a receive diversity device antenna port 1292 or a receive diversity downlink inside antenna port 1292. In another example, in an alternative, the receive diversity signal can travel on a bypass path coupled between the receive diversity DL inside antenna port 1292 and the receive diversity DL outside antenna port 1269, wherein the bypass path does not amplify or filter the receive diversity signal. The receive diversity device antenna port 1292 or a receive diversity downlink inside antenna port 1292 can be configured to be coupled to a receive diversity device antenna 1290 or a receive diversity downlink inside antenna 1290. The receive diversity device antenna 1290 can communicate the amplified and/or filtered or bypassed receive diversity DL signal to a UE.

In another example, as illustrated in FIG. 12c, a repeater can comprise a double-pole double-throw (DPDT) switch 1298. The output 1223 of the UL path can be configured to be coupled to the DPDT switch 1298. The DPDT switch 1298 can be configured to be coupled to an UL node antenna port 1204. The DL node antenna port 1206 can be configured to be coupled to the DPDT switch 1298. The DPDT switch 1298 can be configured to be coupled to an input 1251 of the DL path.

In another example, the DPDT switch 1298 can be configured to: allow the UL node antenna port 1204 to be coupled to the input 1251 of the DL path, and allow the DL node antenna port 1206 to be coupled to the output 1223 of the UL path. The UL node antenna port 1204 and the DL node antenna port can be switched based on whether the repeater is UL-limited or DL-limited. A repeater can be UL-limited when there is an insufficient power from the repeater to the base station. A repeater can be DL-limited when there is insufficient power from the base station to the repeater.

In one example, switching from the UL node antenna port 1204 to the DL node antenna port 1206 can allow the uplink amplification and filtering path to use the DL node antenna port 1206 when the repeater is UL-limited. In one example, switching from the DL node antenna port 1206 to the UL node antenna port 1204 can allow the downlink amplification and filtering path to use the UL node antenna port 1204 when the repeater is DL-limited. In one example, this kind of switching can increase the level of power from the repeater to the base station (when the repeater is UL-limited) and increase the level of power from the base station to the repeater (when the repeater is DL-limited) by using spatial diversity or polarization diversity.

In another example, as illustrated in FIG. 12d, a repeater can comprise a triple-pole triple-throw (TPTT) switch 1299. The output 1223 of the UL path can be configured to be coupled to the TPTT switch 1299. The TPTT switch 1299 can be configured to be coupled to an UL node antenna port 1204. The DL node antenna port 1206 can be configured to be coupled to the TPTT switch 1299. The TPTT switch 1299 can be configured to be coupled to an input 1251 of the DL path. The receive diversity node antenna port 1269 can be configured to be coupled to the TPTT switch 1299. The TPTT switch 1299 can be configured to be coupled to an input 1271 of the receive diversity DL path.

In another example, the TPTT switch 1299 can be configured to: allow the UL node antenna port 1204 to be coupled to the input 1251 of the DL path; allow the UL node antenna port 1204 to be coupled to the input 1271 of the receive diversity DL path. In another example, the TPTT switch 1299 can be configured to: allow the DL node antenna port 1206 to be coupled to the output 1223 of the UL path; allow the DL node antenna port 1206 to be coupled to the input 1271 of the receive diversity DL path. In another example, the TPTT switch 1299 can be configured to: allow the receive diversity node antenna port 1269 to be coupled to the input 1251 of the DL path; allow the receive diversity node antenna port 1269 to be coupled to the output 1223 of the UL path.

In one example, the UL node antenna port 1204, the DL node antenna port, and the receive diversity node antenna port 1269 can be switched based on whether the repeater is UL-limited or DL-limited. A repeater can be UL-limited when there is a low level of power from the repeater to the base station. A repeater can be DL-limited when there is a low level of power from the base station to the repeater. As previously discussed, antenna port switching can increase the level of power from the repeater to the base station (when the repeater is UL-limited) and increase the level of power from the base station to the repeater (when the repeater is DL-limited) by using spatial diversity or polarization diversity.

In another example, as illustrated in FIG. 12e, FIG. 12g, and FIG. 12h, a repeater can comprise an integrated UL device antenna port 1202a or an integrated UL inside antenna port 1202a. The integrated UL device antenna port 1202a can be configured to be coupled to an integrated UL device antenna 1210a or an integrated UL inside antenna 1210a. The integrated UL device antenna port 1202a can be configured to be coupled to an input of a low-noise amplifier 1214.

In another example, a repeater can comprise an integrated DL device antenna port 1202b or an integrated DL inside antenna port 1202b. The integrated DL device antenna port 1202b can be configured to be coupled to an integrated DL device antenna 1210b or an integrated DL inside antenna 1210b. The integrated DL device antenna port 1202b can be configured to be coupled to an output of a power amplifier 1258.

In another example, as illustrated in FIG. 12f, a multiband repeater can comprise an integrated UL device antenna port 1202a or an integrated UL inside antenna port 1202a. The integrated UL device antenna port 1202a can be configured to be coupled to an integrated UL device antenna 1210a or an integrated UL inside antenna 1210a. The integrated UL device antenna port 1202a can be configured to be coupled to an input of a diplexer 1213.

In another example, a repeater can comprise an integrated DL device antenna port 1202b or an integrated DL inside antenna port 1202b. The integrated DL device antenna port 1202b can be configured to be coupled to an integrated DL device antenna 1210b or an integrated DL inside antenna 1210b. The integrated DL device antenna port 1202b can be configured to be coupled to an output of a diplexer 1259.

In one configuration, two or more BPFs can be stacked together or connected to form a multi-filter package (e.g., a SISO filter package). The multi-filter package can also be referred to as a dual-common port multi-bandpass filter. The dual-common port multi-bandpass filter can also include a dual-common port multi-low pass filter (LPF) or a dual-common port multi-high pass filter (HPF). Each of the BPFs within the multi-filter package can be configured to pass a selected frequency, such as an uplink band of a selected frequency band, or a downlink band of the selected frequency band. The multi-filter package can have a first common port and a second common port (e.g., on a left and right side of the multi-filter package, respectively). In an example in which the multi-filter package includes two BPFs that are stacked together in a single package, a first common port can have a first signal trace that connects the first common port to an input of a first BPF and an input of a second BPF. Similarly, a second signal trace can connect a second common port to an output of the first BPF and an output of the second BPF. In this example, the two BPFs can be positioned close to each other (e.g., less than 1 millimeter (mm) from each other for SAW/BAW filters or less than 10 mm for ceramic filters), and the two BPFs can be designed such that one of the BPFs can have a lower return loss in a selected frequency band (i.e. passband), while the other BPF can have a higher return loss (or poor return loss) on that same frequency band (i.e., stopband).

Thus, when an input signal enters the multi-filter package, the input signal can effectively “see” both of the BPFs. The signal can effectively travel towards a first BPF and a second BPF in the multi-filter package. However, the signal will take the path with the lower return loss or lower resistance between the available paths. In other words, when a passband signal enters the multi-filter package, the signal will effectively “see a wall” on one side of the multi-filter package (which corresponds to the path with higher return loss or higher resistance) and an open path on the other side of the multi-filter package (which corresponds to a path with a lower return loss or lower resistance).

While the term “input” and “output” are used with respect to a BPF, the terms are not intended to be limiting. A BPF may be configured to have a signal enter the input of the BPF and exit the output. Alternatively, a signal may enter the output of the BPF and exit the input. Thus, the terms “input” and “output” may be used interchangeably.

In one example, the BPFs in the multi-filter package can include SAW filters, BAW filters, ceramic filters, high pass filters (HPF), low pass filters (LPF), and/or discrete filters (e.g., composed of capacitors and inductors).

In one example, an input signal can have a signal associated with a selected frequency band. For example, a band 2 uplink (UL) signal can include a signal within the 3GPP LTE band 2 UL frequency range. A multi-filter package can include a band 2 UL bandpass filter, configured to pass signals within a frequency range of the band 2 UL range, and reject signals outside of this band. The multi-filter package can also include a band 4 UL bandpass filter, configured to pass signals within a frequency range of the 3GPP LTE band 4 UL frequency range, and reject signals outside of this band.

As an example, the multi-filter package can include a B 1 UL BPF and a B2 UL BPF. If the signal that enters the multi-filter package is a B1 UL signal, the signal can pass through the B1 UL BPF in the multi-filter package due to the lower return loss that is designed in the B1 UL BPF for the frequency range of the B1 UL signal. Similarly, if the signal that enters the multi-filter package is a B2 UL signal, the signal can pass through the B2 UL BPF in the multi-filter package due to the lower return loss that is designed in the B2 UL BPF for the frequency range of the B2 UL signal. In addition, if the B1 UL signal or the B2 UL signal were to go to the B2 UL BPF or the B1 UL BPF, respectively, the UL signal would get reflected back and would then pass through the appropriate UL BPF.

In one example, the multi-filter package can include electrically short wires or signal traces that connect the first common port and the second common port to the first and second BPFs. In other words, the path from the first common port to the input of the first and second BPFs, and the path from the second common port to the output of the first and second BPFs can be electrically short. In one example, if the wires or signal traces were to become electrically long, the wires or signal traces can create phase and reflection problems. Thus, by keeping the wires or signal traces electrically short, these problems can be avoided and the signal can only travel on an incorrect path for a reduced period of time.

In one example, the electrically short wires or signal traces in the multi-filter package can be shorter than 1/10^{th} or 1/20^{th} or 1/100^{th} of a wavelength of the signal the electrically short wires are carrying. In one example, a 1 GHz wavelength is 300 mm, and the electrically short wires or signal traces can be shorter than 3 mm. Since the wires or signal traces are considerably shorter than the wavelength, an incoming signal can effectively see multiple paths at the same time, and the incoming signal can travel on a path with lower return loss or lower resistance.

In one example, the multi-filter package can include multiple separate bandpass filters, with each bandpass filter configured for a separate frequency band. Each separate frequency band can have a guard band between the frequency band (i.e. the frequency bands are non-adjacent). Each of the bandpass filters can be designed to have an input that is impedance matched to a first common port, and an output that is impedance matched to a second common port.

In another example, it can be difficult for multiple different bandpass filters, each with different passbands, to each be impedance matched to a common port. To overcome that limitation, the multi-filter package can include one or more matching networks. For example, a matching network can be coupled to inputs of two or more BPFs in the multi-filter package. A separate matching network can be coupled to the outputs of two or more BPFs in the multi-filter package. The matching network(s) can each be a separate module that is external to the BPFs, but within the multi-filter package. The matching network(s) can include series inductors and/or shunt capacitors, which can function to impedance match the inputs of the BPFs in the multi-filter package to the first common port and/or impedance match the outputs of the BPFs in the multi-filter package to the second common port. The impedance matching can be between a common port and each individual BPF port. In other words, each BPF can be matched to a common port, and not to other BPFs. The impedance matching provided by the matching network(s) can enable a signal to travel through a BPF on a lower return loss path in the multi-filter package and bypass a BPF on a higher return loss path of the multi-filter package. Depending on the combination of BPFs in the multi-filter package, the matching implementation can be designed accordingly.

As used herein, the term “connected” typically refers to two devices that are directly electrically connected. The term “communicatively coupled” or “coupled” refers to two devices that are electrically connected, with additional electrical components located between the two devices. However, the terms are meant to be descriptive and are not intended to be limiting. The terms “coupled”, “communicatively coupled”, and “connected” may be used interchangeably.

In one configuration, two or more sets of BPFs can be packaged together or connected to form a multi-common port multi-filter package (e.g., a DISO filter package). For example, a first set of BPFs consisting of two or more BPFs can be connected to a second set of BPFs consisting of one or more BPFs. The first set of BPFs can include DL BPFs and the second set of BPFs can include UL BPFs, or vice versa. The multi-filter package can include a first common port that connects to the first and second set of BPFs, a second common port that connects to the first set of BPFs and a third common port that connects to the second set of BPFs. The wires or signal traces that connect the first, second, and third common ports to each BPF in the first and second sets of BPFs, respectively, can be electrically short. In addition, the multi-filter package can include a matching network that is coupled to the first set of BPFs in the multi-filter package and/or a matching network that is coupled to the second set of BPFs in the multi-filter package.

As an example, the multi-filter package can include a first set of BPFs that includes a B2 UL BPF and a B4 UL BPF, as well as a second set of BPFs that includes a B12 DL BPF and a B13 DL BPF. Due to the matching network(s) and the electrically short wires or signal traces, a signal that enters the multi-filter package can pass through an appropriate BPF and bypass the other BPFs in the multi-filter package. For example, an UL signal will pass through one of the UL BPFs with a passband within the signal's band, and bypass the DL BPFs. Similarly, a DL signal will pass through one of the DL BPFs associated with the signal's band, and bypass the UL BPFs. Furthermore, due to the use of matching network(s) and the electrically short wires or signal traces, an UL signal can pass through an appropriate UL BPF and bypass other UL BPFs in the multi-filter package, and similarly, a DL signal can pass through an appropriate DL BPF and bypass other DL BPFs in other frequency bands in the multi-filter package.

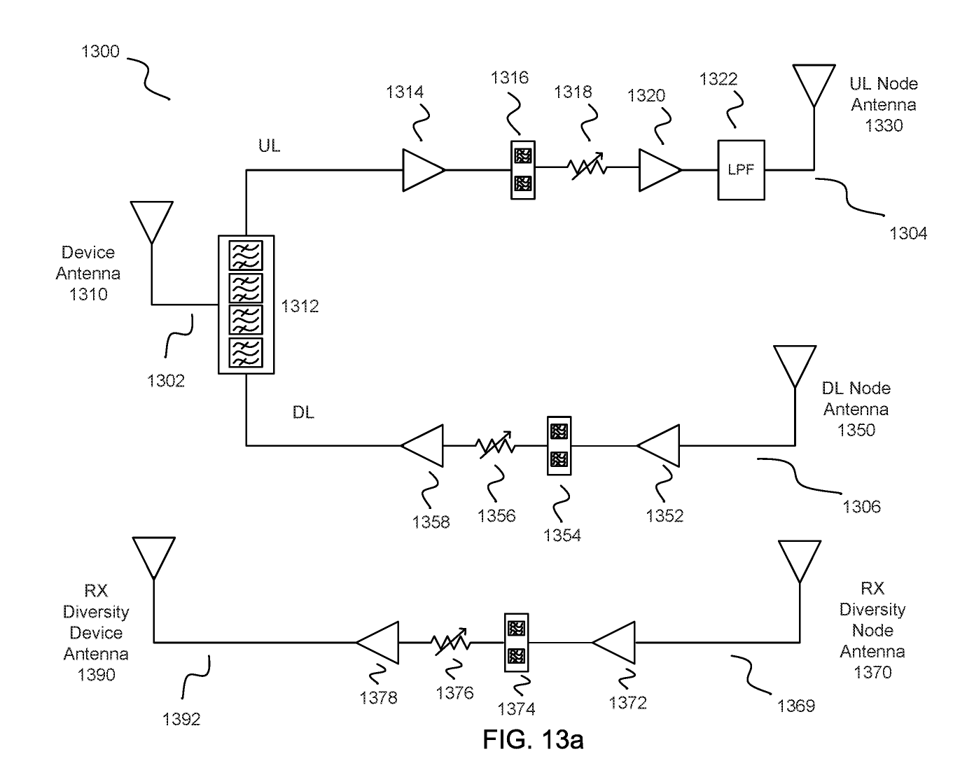

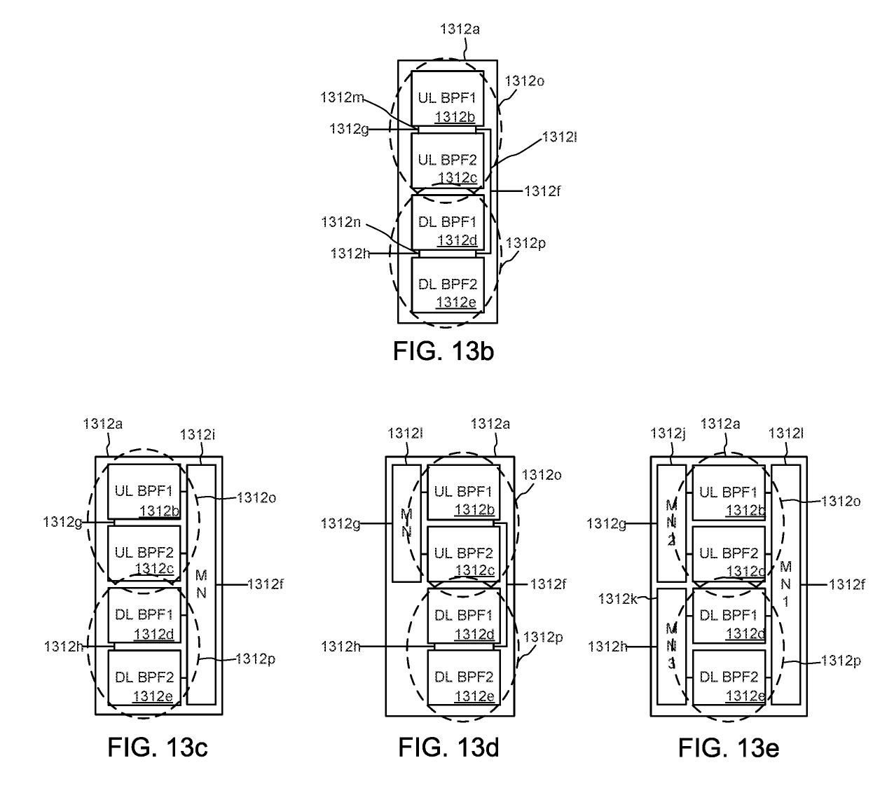

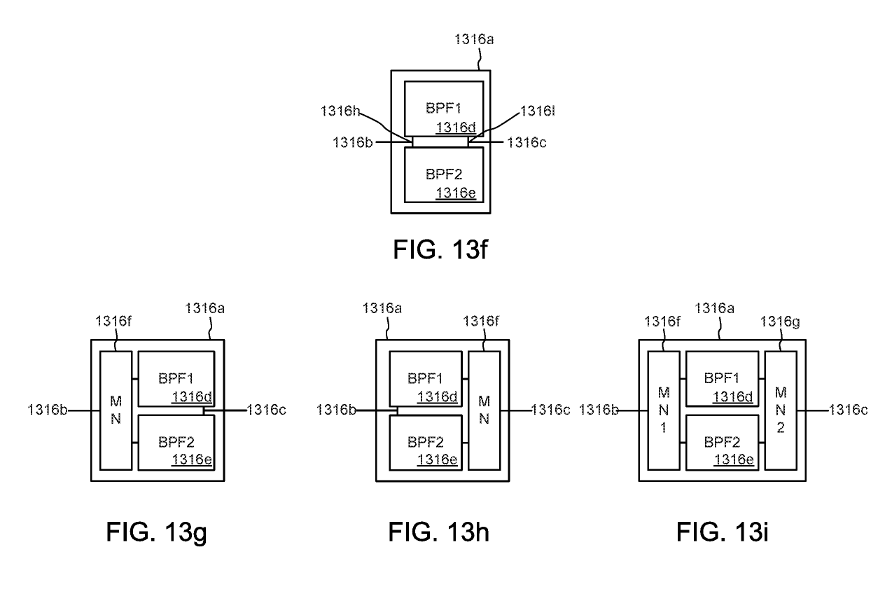

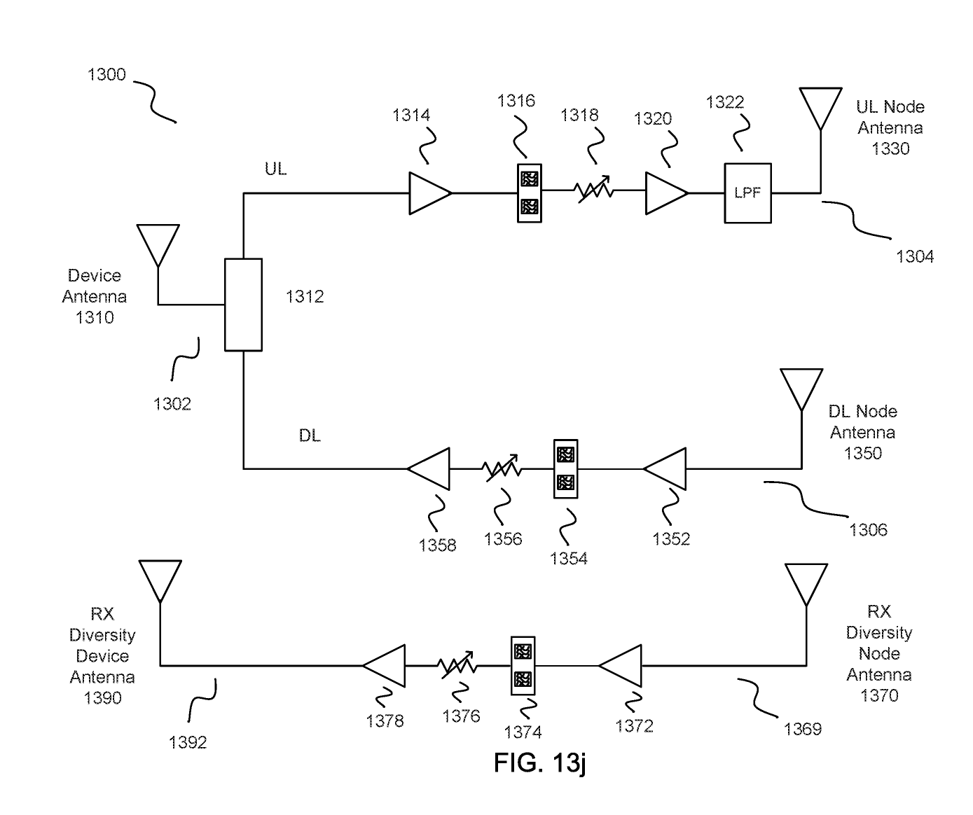

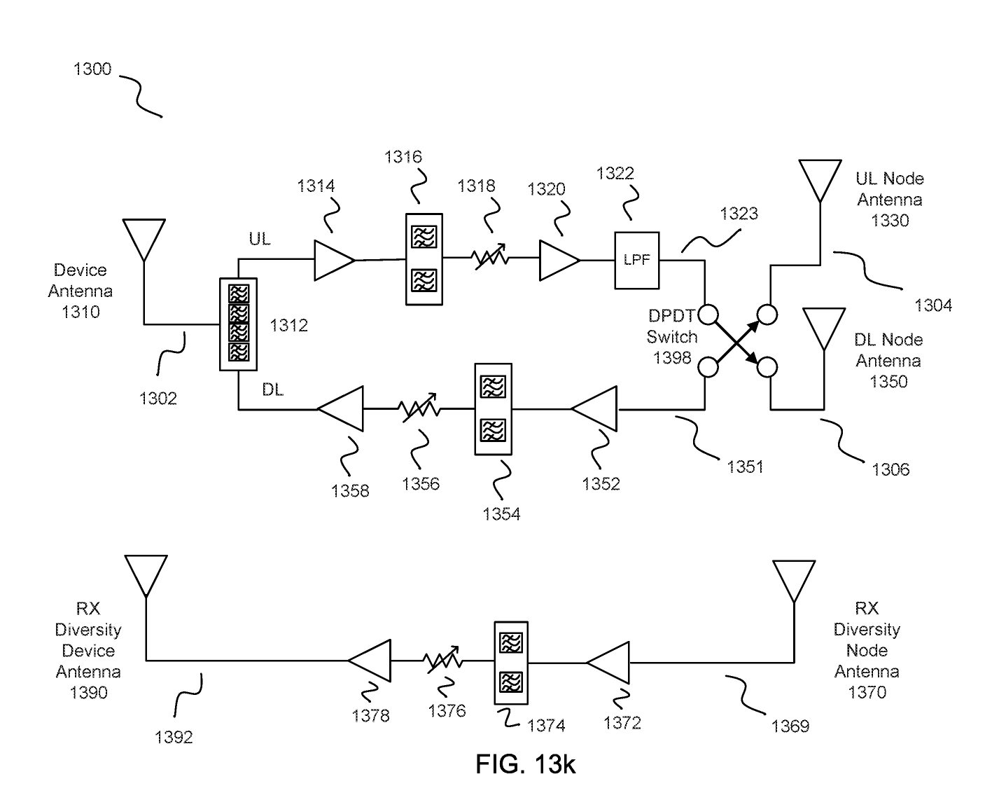

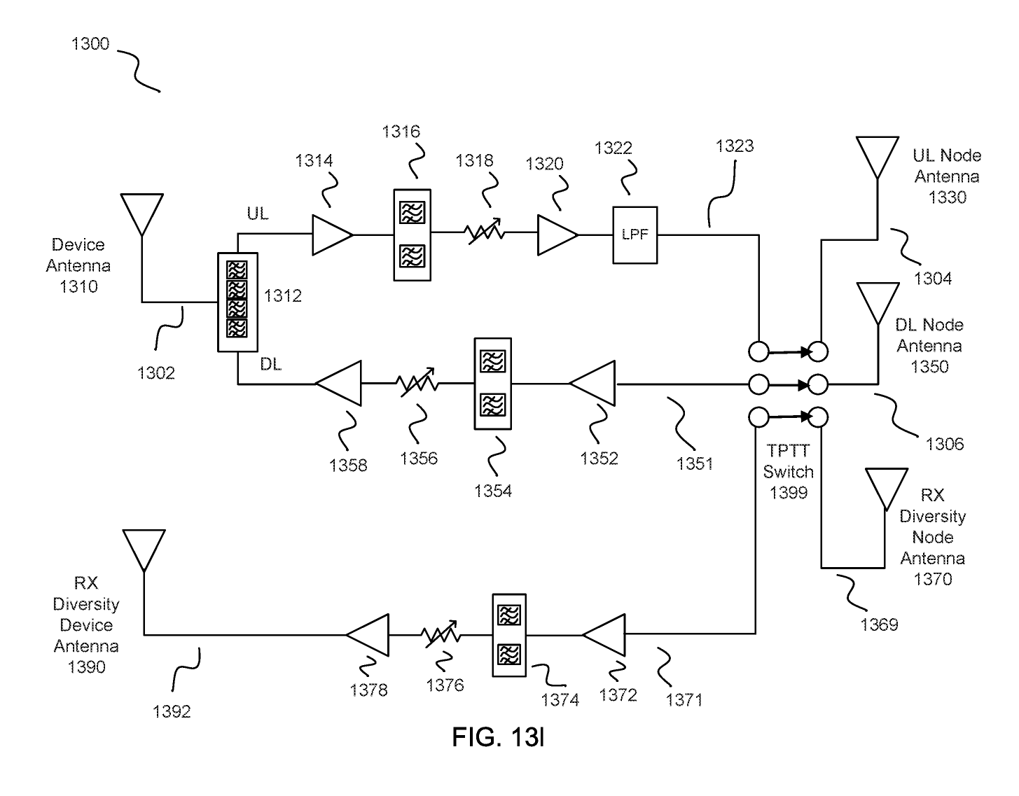

In another example, as illustrated in FIG. 13a, a multiband repeater can comprise a receive diversity antenna port. In this example, a bi-directional inside antenna port 1302 or bi-directional device antenna port 1302 can be configured to be coupled to an integrated device antenna 1310 or a bi-directional inside antenna 1310. In another example, in an alternative, the bi-directional inside antenna port 1302 can be replaced by an UL inside antenna port and a DL inside antenna port, wherein the UL inside antenna port is separate from the DL inside antenna port, and the UL inside antenna port can be further configured to be coupled to an UL inside antenna and the DL inside antenna port can be further configured to be coupled to a DL inside antenna.

The integrated device antenna 1310 can receive an UL signal from a UE. The bi-directional inside antenna port 1302 can be configured to be coupled to a multi-common port multi-filter package 1312. In another example, in an alternative, the bi-directional inside antenna port 1302 can be configured to be coupled to a splitter. The multi-common port multi-filter package 1312 can direct a signal into an UL path or from a DL path. In one example, the multi-common port multi-filter package 1312 can be used to separate the UL and DL paths. The separation of the UL and DL paths using the multi-common port multi-filter package 1312 can be used to separate the UL and DL paths with lower loss and higher UL to DL isolation than using a splitter. In addition, in this example, the multi-common port multi-filter package 1312 can be modified to have fewer outputs for a multiband repeater. For example, in a repeater having two uplink bands and two downlink bands, the multi-common port multi-filter package 1312 can have two outputs, rather than four outputs that would be typical when using a multiplexer. The signals in the UL and DL can be combined into common UL ports and DL ports, respectively. The combining can be achieved through impedance matching at the filter outputs in the multi-common port multi-filter package.

FIGS. 13b to 13e illustrate examples of multi-common port multi-filter packages. One or more multi-filter package(s) 1312a can be included in a repeater (i.e. signal booster or bidirectional amplifier). The multi-filter package 1312a can be communicatively coupled to a first interface port of the repeater. As shown in FIG. 13b, the multi-filter package 1312a can include a first common port 1312f, a second common port 1312g, and a third common port 1312h. The first common port 1312f can be communicatively coupled to the first interface port of the repeater. The first common port 1312f can also be communicatively coupled to a first set of filters 1312o in the multi-filter package 1312a, such as a first UL BPF (UL BPF1) 1312b and a second UL BPF (UL BPF2) 1312c, as well as to a second set of filters 1312p in the multi-filter package 1312a, such as a first DL BPF (DL BPF1) 1312d and a second DL BPF (DL BPF2) 1312e. Furthermore, the second common port 1312g can be communicatively coupled to a second interface port of the repeater and the first set of filters 1312o in the multi-filter package 1312a. The third common port 1312h can be communicatively coupled to the second interface port of the repeater and the second set of filters 1312p in the multi-filter package 1312a.

In one example, as shown in FIG. 13b, the multi-filter package 1312a can include a first signal trace 1312l, a second signal trace 1312m and a third signal trace 1312n. The first signal trace 1312l can be coupled between the first common port 1312f, and each filter in the first set of filters 1312o and each filter in the second set of filters 1312p in the multi-filter package 1312a. The second signal trace 1312m can be coupled between the second common port 1312g, and each filter in the first set of filters 1312o in the multi-filter package 1312a. The third signal trace 1312n can be coupled between the third common port 1312h, and each filter in the second set of filters 1312p in the multi-filter package 1312a.

In one example, a length of the first signal trace 1312l from the first common port 1312f to each filter in the first set of filters 1312o and the second set of filters 1312p in the multi-filter package 1312a can have a substantially equal length (e.g., less than 10 mm +/−0.5 mm or less than 5 mm +/−0.25 mm). In another example, a length of the second signal trace 1312m from the second common port 1312g to each filter in the first set of filters 1312o in the multi-filter package 1312a can have a substantially equal length (e.g., less than 5 mm +/−0.25 mm). In yet another example, a length of the third signal trace 1312n from the third common port 1312h to each filter in the second set of filters 1312p in the multi-filter package 1312a can have a substantially equal length (e.g., less than 5 mm +/−0.25 mm). In a further example, a length of each of the first signal trace 1312l, the second signal trace 1312m and the third signal trace 1312n can be less than 10 mm +/−0.5 mm or less than 5 mm +/−0.25 mm.

In one example, as shown in FIG. 13c, the first common port 1312f can be coupled to a matching network 1312i. The matching network 1312i can be coupled to the first set of filters 1312o in the multi-filter package 1312a, such as the first UL BPF (UL BPF1) 1312b and the second UL BPF (UL BPF2) 1312c, as well as the second set of filters 1312p in the multi-filter package 1312a, such as the first DL BPF (DL BPF1) 1312d and the second DL BPF (DL BPF2) 1312e. Each BPF in the multi-filter package 1312a can be configured to filter one or more bands in one or more signals. Each of the bands can be non-spectrally adjacent, as previously discussed. The matching network 1312i can be configured to provide impedance matching for the inputs/outputs of the first set of filters 1312o and the second set of filters 1312p in the multi-filter package 1312a with the first common port 1312f. Furthermore, in this example, the second common port 1312g and the third common port 1312h may not be coupled to matching networks. Accordingly, the input/outputs of the first set of BPFs 1312o can be impedance matched to the common port 1312i. The input/outputs of the second set of BPFs 1312p can be impedance matched to the third common port 1312h.

In one example, as shown in FIG. 13d, the second common port 1312g can be coupled to a matching network 1312i. In this example, the matching network 1312i can be coupled to and impedance matched with the inputs/outputs of the first set of filters 1312o in the multi-filter package 1312a, such as the first UL BPF (UL BPF1) 1312b and the second UL BPF (UL BPF2) 1312c. Alternatively, or in addition, the third common port 1312h can be coupled to the matching network 1312i. The matching network 1312i can be coupled to and impedance matched with the inputs/outputs of the second set of filters 1312p in the multi-filter package 1312a, such as the first DL BPF (DL BPF1) 1312d and the second DL BPF (DL BPF2) 1312e. In this example, the first common port 1312f and the third common port 1312h may not be coupled to matching networks. Accordingly, the first common port 1312f may be impedance matched directly to the inputs/outputs of the UL BPF1 1312b, UL BPF2 1312c, DL BPF1 1312d, and DL BPF2 1312e. In addition, the third common port 1312h may be impedance matched directly to the inputs/outputs of the DL BPF1 1312d and DL BPF2 1312e.

In one example, as shown in FIG. 13e, the first common port 1312f can be coupled to a first matching network 1312i, the second common port 1312g can be coupled to a second matching network 1312j, and the third common port 1312h can be coupled to a third matching network 1312k. The first matching network 1312i can be coupled to and impedance matched with the inputs/outputs of the first set of filters 1312o in the multi-filter package 1312a, such as the first UL BPF (UL BPF1) 1312b and the second UL BPF (UL BPF2) 1312c, as well as the second set of filters 1312p in the multi-filter package 1312a, such as the first DL BPF (DL BPF1) 1312d and the second DL BPF (DL BPF2) 1312e. The second matching network 1312j can be coupled to and impedance matched with the inputs/outputs of the first set of filters 1312o in the multi-filter package 1312a. The third matching network 1312k can be coupled to and impedance matched with the inputs/outputs of the second set of filters 1312p in the multi-filter package 1312a.

In one example, each filter in the multi-filter package 1312a can have an input that is impedance matched to one or more of a first, second, or third common port of the multi-filter package 1312a and/or each filter in the multi-filter package 1312a can have an output that is impedance matched to another of the first, second, or third common port in the multi-filter package 1312a.

In one configuration, as shown in FIGS. 13b to 13e, multi-filter package(s) 1312a can include a first impedance-matched filter set (e.g., the first set of filters 1312o), and a second impedance-matched filter set (e.g., the second set of filters 1312p). The first common port 1312f can be coupled to the first and the second impedance-matched filter sets, the second common port 1312g can be coupled to the first impedance-matched filter set, and the third common port 1312h can be coupled to the second impedance-matched filter set. In one example, the multi-filter package 1312a can include two or more impedance-matched uplink bandpass filters, with each uplink bandpass filter configured to pass one or more uplink bands, respectively, and two or more impedance-matched downlink bandpass filters, with each bandpass filter configured to pass one or more downlink bands, respectively. Accordingly, the multi-filter package 1312a can be configured to separately filter each of the bands of a signal with two or more downlink bands and two or more uplink bands.

In another example, an UL path can comprise one or more of a low-noise amplifier 1314, an UL dual-common port multi-bandpass filter 1316, a variable attenuator 1318, a power amplifier (PA) 1320, or a low-pass filter (LPF) 1322. The low-noise amplifier 1314 can be an UL low-noise amplifier, the variable attenuator 1318 can be an UL variable attenuator, the power amplifier 1320 can be an UL power amplifier, and the low-pass filter 1322 can be an UL low-pass filter or low-order filtering. In another example, the power amplifier 1320 can comprise a variable gain power amplifier, a fixed-gain power amplifier, or a gain block. In another example, the LPF 1322 can be configured to be coupled between the power amplifier 1320 and an UL outside antenna port 1304 or UL node antenna port 1304 to filter harmonics emitted by the power amplifier 1320. While a low pass filter is described in this example, it is not intended to be limiting. A low-order filter can be used to filter the harmonics. The low order filter can include one or more high pass filter poles and one or more low pass filter poles. The low-order filter can be configured to have low loss since it is located after the power amplifier 1320. In another example, the power amplifier 1320 can be configured to be coupled directly to the UL outside antenna port 1304 without filtering between the power amplifier 1320 and the UL outside antenna port 1304.

In another example, the UL dual-common port multi-bandpass filter 1316 can include a first bandpass filter for a first frequency (e.g., B1) a second band-pass filter for a second frequency (e.g., B2), and additional bandpass filters for additional bands, if desired. The UL dual-common port multi-bandpass filter 1316 can comprise a plurality of filters located in a single package. Each filter in the single package can be designed and configured to operate with other filters in the package. For example, each filter can be impedance matched with the other filters in the package to enable the filters to properly function within the same package. Each filter can be configured to provide a bandpass for a selected band that is non-frequency adjacent with the bandpass bands of other filters in the single package. The UL dual-common port multi-bandpass filter 1316 can be configured to pass two or more of 3GPP FDD frequency bands 2, 4, 5, 12, 13, 17, 25, 26, or 71. In another example, the UL dual-common port multi-bandpass filter 1316 can be configured to pass two or more of 3GPP FDD frequency bands 1-28, 30, 31, 65, 66, 68, 70-74, or 85. In another example, the UL dual-common port multi-bandpass filter 1316 can be configured to pass two or more selected channels within a 3GPP FDD band. In another example, the UL dual-common port multi-bandpass filter 1316 can be configured to pass two or more selected frequency ranges within a 3GPP FDD band.

FIGS. 13f to 13i illustrate examples of dual-common port multi-filter packages. One or more multi-filter package(s) 1316a can be included in a repeater (i.e. signal booster or bidirectional amplifier). The multi-filter package 1316a can be communicatively coupled to a first interface port of the repeater. The first interface port can communicate one or more signals that include multiple bands. Each signal may communicate a single band, or multiple bands.

As shown in FIG. 13f, the multi-filter package 1316a can include a first common port 1316b and a second common port 1316c. The first common port 1316b can be coupled to the first interface port and an input to two or more filters in the multi-filter package 1316a, such as a first BPF (BPF1) 1316d and a second BPF (BPF2) 1316e in the multi-filter package 1316e. The first BPF (BPF1) 1316d and the second BPF (BPF2) 1316e can be configured to filter one or more bands in one or more signals. The second common port 1316c can be coupled to a second interface port of the repeater, where the second interface can communicate the one or more signals, as well as to an output of the two or more filters in the multi-filter package 1316a.

In one example, as shown in FIG. 13f, the multi-filter package 1316a can include a first signal trace 1316h and a second signal trace 1316i. The first signal trace 1316h can be coupled between the first common port 1316b, and then divide to couple to the input of the two or more filters in the multi-filter package 1316a. Furthermore, the second signal trace 1316i can be coupled between the second common port 1316c, and then divide to couple to the output of the two or more filters in the multi-filter package 1316a.

In one example, a length of the first signal trace 1316h from the first common port 1316b to the input to each of the two or more filters in the multi-filter package 1316a can have a substantially equal length (e.g., less than 5 mm in length with a difference in length of less than +/−0.25 mm). In another example, a length of the second signal trace 1316i from the second common port 1316c to the output of each of the two or more filters in the multi-filter package 1316a can have a substantially equal length (e.g., less than 5 mm in length with a difference of less than +/−0.25 mm). In yet another example, a length of each of the first signal trace 1316h and the second signal trace 1316i can be less than 2 millimeters (mm) in length.

In one example, the multi-filter package 1316a can be associated with at least one of a high band frequency or a low band frequency.

In one example, as shown in FIG. 13f, the multi-filter package 1316a can include two or more impedance-matched uplink bandpass filters for two or more uplink bands, respectively. Alternatively, the multi-filter package 1316a can include two or more impedance-matched downlink bandpass filters for two or more downlink bands, respectively. The impedance-matched filters can each have an input 1316h that is impedance matched to the first common port 1316b, and an output 1316i that is impedance matched to the second common port 1316c.

In one example, as shown in FIG. 13g, the multi-filter package 1316a can include a matching network 1316f The matching network 1316f can be coupled to an input of the two or more filters in the multi-filter package 1316a, such as the first BPF (BPF1) 1316d and the second BPF (BPF2) 1316e in the multi-filter package 1316a. The matching network 1316f can be configured to impedance match the input of each of the two or more filters in the multi-filter package 1316a to the first common port 1316b.

In one example, as shown in FIG. 13h, the multi-filter package 1316a can include a matching network 1316f The matching network 1316f can be coupled to the output of the two or more filters in the multi-filter package 1316a, such as the first BPF (BPF1) 1316d and the second BPF (BPF2) 1316e in the multi-filter package 1316a. The matching network 1316f can be operable to impedance match the two or more filters in the multi-filter package 1316a.

In one example, each filter in the multi-filter package 1316a (e.g., the first BPF (BPF1) 1316d and the second BPF (BPF2) 1316e) can have an input that is impedance matched to inputs of other filters in the multi-filter package 1316a and/or each filter in the multi-filter package 1316a can have an output that is impedance matched to outputs of other filters in the multi-filter package 1316a.

In one example, as shown in FIG. 13i, the multi-filter package 1316a can include a first matching network 1316f and a second matching network 1316g. The first matching network 1316f can be coupled to the input of the two or more filters in the multi-filter package 1316a, such as the first BPF (BPF1) 1316d and the second BPF (BPF2) 1316e in the multi-filter package 1316a, and the second matching network 1316g can be coupled to the output of the two or more filters in the multi-filter package 1316a. Each of the matching networks can impedance match the input/output to the associated common port.

In one configuration, as shown in FIGS. 13f to 13i, multi-filter package(s) 1316a can include an impedance-matched filter set (e.g., the first BPF (BPF1) 1316d and the second BPF (BPF2) 1316e) with the first common port 1316b and the second common port 1316c.

In one example, the impedance-matched filter set can refer to a set of two or more filters in the multi-filter package 1316a, wherein each filter in the set can have filter input that is impedance matched with a common port and a filter output that is impedance matched with a separate common port. The impedance matching can be accomplished at the filter, or using an impedance matching network within the multi-filter package 1316a that is coupled to the set of two or more filters, to enable a single common input and a single common output for the impedance-matched filter set. Accordingly, the multi-filter package 1316a can be configured to separately filter each of the bands of a signal with two or more downlink bands or two or more uplink bands.

In one example, the uplink bands can be combined using the dual-common port multi-bandpass filters. Rather than using a separate UL amplifier and filter chain for each band, channel, or frequency range, a single amplifier chain can be used with the dual-common port multi-bandpass filters capable of filtering the multiple bands, channels, or frequency ranges. This line-sharing technique simplifies the architecture, the number of components, and the layout of the repeater. In addition, line-sharing due to the combined filters can allow for additional component sharing, such as RF amplifiers (gain blocks), RF attenuators, RF detectors, and the like. With fewer components, the repeater can have a higher overall reliability and a lower overall cost.

In another example, after traveling on the UL path, the UL signal on the UL path can be amplified and filtered in accordance with the type of amplifiers and dual-common port multi-bandpass filters included on the UL path. The signal from the UL path can be directed to an UL node antenna port 1304. The UL signal can be directed from the UL node antenna port 1304 to an integrated UL node antenna 1330 or an UL outside antenna 1330. The UL node antenna 1330 can be an omnidirectional antenna or a directional antenna. The UL outside antenna 1330 can communicate the amplified and/or filtered UL signal to a base station.

In another example, an integrated DL node antenna port 1306 or DL outside antenna port 1306 can be configured to be coupled to an integrated DL node antenna 1350 or a DL outside antenna 1350. The integrated DL node antenna 1350 can be an omnidirectional antenna or directional antenna. The integrated DL node antenna 1350 can receive a DL signal from a base station. The DL outside antenna port 1306 can be configured to be coupled to an input of a low-noise amplifier 1352.

In another example, the DL path can comprise one or more of a low-noise amplifier 1352, a DL dual-common port multi-bandpass filter 1354, a variable attenuator 1356, or a power amplifier (PA) 1358. The low-noise amplifier 1352 can be a DL low-noise amplifier, the variable attenuator 1356 can be a DL variable attenuator, and the power amplifier 1358 can be a DL power amplifier. In another example, the power amplifier 1358 can comprise a variable gain power amplifier, a fixed-gain power amplifier, or a gain block. In another example, the low-noise amplifier 1352 can be configured to be coupled to a DL outside antenna port 1306 without filtering between the low-noise amplifier 1352 and the DL outside antenna port 1306.

In another example, the DL dual-common port multi-bandpass filter 1354 can include a first bandpass filter for a first frequency (e.g., B1) a second band-pass filter for a second frequency (e.g., B2). The DL dual-common port multi-bandpass filter 1354 can comprise a plurality of filters located in a single package. Each filter in the single package can be designed and configured to operate with other filters in the package. For example, each filter can be impedance matched with the other filters in the package to enable the filters to properly function within the same package. Each filter can be configured to provide a bandpass for a selected band that is non-frequency adjacent with the bandpass bands of other filters in the single package. The DL dual-common port multi-bandpass filter 1354 can be configured to pass two or more of 3GPP FDD frequency bands 2, 4, 5, 12, 13, 17, 25, 26, or 71. In another example, the DL dual-common port multi-bandpass filter 1354 can be configured to pass two or more of 3GPP FDD frequency bands 1-28, 30, 31, 65, 66, 68, 70-74, or 85. In another example, the DL dual-common port multi-bandpass filter 1354 can be configured to pass two or more selected channels within a 3GPP FDD band. In another example, the DL dual-common port multi-bandpass filter 1354 can be configured to pass two or more selected frequency ranges within a 3GPP FDD band.

In one example, the downlink bands can be combined using the dual-common port multi-bandpass filters. Rather than using a separate DL amplifier and filter chain for each band, channel, or frequency range, a single amplifier chain can be used with the dual-common port multi-bandpass filters capable of filtering the multiple bands, channels, or frequency ranges. This line-sharing technique simplifies the architecture, the number of components, and the layout of the repeater. In addition, line-sharing due to the combined filters can allow for additional component sharing, such as RF amplifiers (gain blocks), RF attenuators, RF detectors, and the like. With fewer components, the repeater can have a higher overall reliability and a lower overall cost.

In another example, after traveling on the DL path, the DL signal on the DL path can be amplified and filtered in accordance with the type of amplifiers and dual-common port multi-bandpass filters included on the DL path. The signal from the DL path can be directed to the multi-common port multi-filter package 1312. From the multi-common port multi-filter package 1312, the DL signal can be directed to an integrated device antenna port 1302 or a bi-directional inside antenna port 1302.

In another example, a receive diversity DL outside antenna port 1369 or receive diversity DL node antenna port 1369 or receive diversity DL donor antenna port 1369 can be configured to be coupled to a receive diversity DL outside antenna 1370 or receive diversity DL node antenna 1370 or receive diversity DL donor antenna 1370. The receive diversity DL node antenna 1370 can be an omnidirectional antenna or directional antenna. The receive diversity DL node antenna 1370 can receive a DL signal from a base station. The receive diversity DL outside antenna port 1369 can be configured to be coupled to an input of a low-noise amplifier 1372.

In another example, the receive diversity DL path can comprise one or more of a low-noise amplifier 1372, a DL dual-common port multi-bandpass filter 1374, a variable attenuator 1376, or a power amplifier (PA) 1378. The low-noise amplifier 1372 can be a DL low-noise amplifier, the variable attenuator 1376 can be a DL variable attenuator, and the power amplifier 1378 can be a DL power amplifier. In another example, the power amplifier 1378 can comprise a variable gain power amplifier, a fixed-gain power amplifier, or a gain block. In another example, the low-noise amplifier 1372 can be configured to be coupled directly to a receive diversity DL outside antenna port 1369 without filtering between the low-noise amplifier 1372 and the receive diversity DL outside antenna port 1369.

In another example, the DL dual-common port multi-bandpass filter 1374 can include a first bandpass filter for a first frequency (e.g., B1) a second band-pass filter for a second frequency (e.g., B2). The DL dual-common port multi-bandpass filter 1374 can comprise a plurality of filters located in a single package. Each filter in the single package can be designed and configured to operate with other filters in the package. For example, each filter can be impedance matched with the other filters in the package to enable the filters to properly function within the same package. Each filter can be configured to provide a bandpass for a selected band that is non-frequency adjacent with the bandpass bands of other filters in the single package. The DL dual-common port multi-bandpass filter 1374 can be configured to pass two or more of 3GPP FDD frequency bands 2, 4, 5, 12, 13, 17, 25, 26, or 71. In another example, the DL dual-common port multi-bandpass filter 1374 can be configured to pass two or more of 3GPP FDD frequency bands 1-28, 30, 31, 65, 66, 68, 70-74, or 85. In another example, the DL dual-common port multi-bandpass filter 1374 can be configured to pass two or more selected channels within a 3GPP FDD band. In another example, the DL dual-common port multi-bandpass filter 1374 can be configured to pass two or more selected frequency ranges within a 3GPP FDD band.

In another example, after traveling on the receive diversity DL path, the receive diversity signal on the receive diversity DL path can be amplified and filtered in accordance with the type of amplifiers and dual-common port multi-bandpass filters included on the receive diversity DL path. The signal from the receive diversity DL path can be directed to a receive diversity device antenna port 1392 or a receive diversity downlink inside antenna port 1392. In another example, in an alternative, the receive diversity signal can travel on a bypass path coupled between the receive diversity DL inside antenna port 1392 and the receive diversity DL outside antenna port 1369, wherein the bypass path does not amplify or filter the receive diversity signal. The receive diversity device antenna port 1392 or a receive diversity downlink inside antenna port 1392 can be configured to be coupled to a receive diversity device antenna 1390 or a receive diversity downlink inside antenna 1390. The receive diversity device antenna 1390 can communicate the amplified and/or filtered or bypassed receive diversity DL signal to a UE.

In another example, as illustrated in FIG. 13j, the integrated device antenna 1310 can receive an UL signal from a UE. The bi-directional inside antenna port 1302 can be configured to be coupled to a splitter 1313. The splitter 1313 can be a diplexer, a multiplexer, or a multi-common port multi-filter package. The splitter 1313 can direct a signal into an UL path or from a DL path. In one example, the splitter 1313 can be used to separate the UL and DL paths.

In another example, as illustrated in FIG. 13k, a repeater can comprise a double-pole double-throw (DPDT) switch 1398. The output 1323 of the UL path can be configured to be coupled to the DPDT switch 1398. The DPDT switch 1398 can be configured to be coupled to an UL node antenna port 1304. The DL node antenna port 1306 can be configured to be coupled to the DPDT switch 1398. The DPDT switch 1398 can be configured to be coupled to an input 1351 of the DL path.

In another example, the DPDT switch 1398 can be configured to: allow the UL node antenna port 1304 to be coupled to the input 1351 of the DL path, and allow the DL node antenna port 1306 to be coupled to the output 1323 of the UL path. The UL node antenna port 1304 and the DL node antenna port can be switched based on whether the repeater is UL-limited or DL-limited. A repeater can be UL-limited when there is a low level of power from the repeater to the base station. A repeater can be DL-limited when there is a low level of power from the base station to the repeater.

In one example, switching from the UL node antenna port 1304 to the DL node antenna port 1306 can allow the uplink amplification and filtering path to use the DL node antenna port 1306 when the repeater is UL-limited. In one example, switching from the DL node antenna port 1306 to the UL node antenna port 1304 can allow the downlink amplification and filtering path to use the UL node antenna port 1304 when the repeater is DL-limited. In one example, this kind of switching can increase the level of power from the repeater to the base station (when the repeater is UL-limited) and increase the level of power from the base station to the repeater (when the repeater is DL-limited) by using spatial diversity or polarization diversity.

In another example, as illustrated in FIG. 13l, a repeater can comprise a triple-pole triple-throw (TPTT) switch 1399. The output 1323 of the UL path can be configured to be coupled to the TPTT switch 1399. The TPTT switch 1399 can be configured to be coupled to an UL node antenna port 1304. The DL node antenna port 1306 can be configured to be coupled to the TPTT switch 1399. The TPTT switch 1399 can be configured to be coupled to an input 1351 of the DL path. The receive diversity node antenna port 1369 can be configured to be coupled to the TPTT switch 1399. The TPTT switch 1399 can be configured to be coupled to an input 1371 of the receive diversity DL path.

In another example, the TPTT switch 1399 can be configured to: allow the UL node antenna port 1304 to be coupled to the input 1351 of the DL path; allow the UL node antenna port 1304 to be coupled to the input 1371 of the receive diversity DL path. In another example, the TPTT switch 1399 can be configured to: allow the DL node antenna port 1306 to be coupled to the output 1323 of the UL path; allow the DL node antenna port 1306 to be coupled to the input 1371 of the receive diversity DL path. In another example, the TPTT switch 1399 can be configured to: allow the receive diversity node antenna port 1369 to be coupled to the input 1351 of the DL path; allow the receive diversity node antenna port 1369 to be coupled to the output 1323 of the UL path.

In one example, the UL node antenna port 1304, the DL node antenna port, and the receive diversity node antenna port 1369 can be switched based on whether the repeater is UL-limited or DL-limited. A repeater can be UL-limited when there is a low level of power from the repeater to the base station. A repeater can be DL-limited when there is a low level of power from the base station to the repeater. In one example, this kind of antenna port switching can increase the level of power from the repeater to the base station (when the repeater is UL-limited) and increase the level of power from the base station to the repeater (when the repeater is DL-limited) by using spatial diversity or polarization diversity.

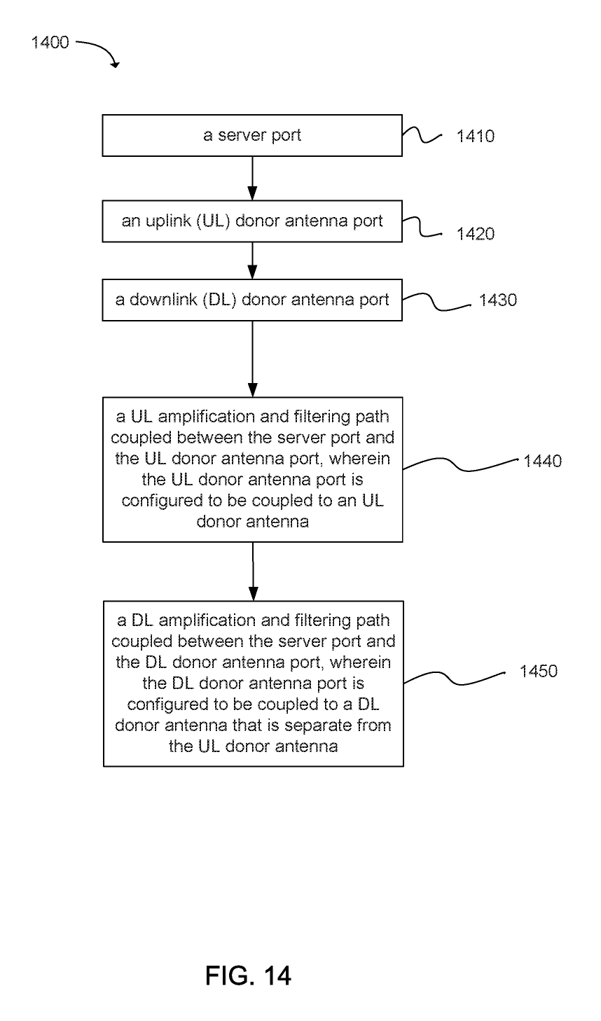

Another example provides an apparatus 1400 of a repeater, as shown in the flow chart in FIG. 14. The apparatus can comprise a server port, as shown in block 1410. The apparatus can further comprise an uplink (UL) donor antenna port, as shown in block 1420. The apparatus can further comprise a downlink (DL) donor antenna port, as shown in block 1430. The apparatus can further comprise a UL amplification and filtering path coupled between the server port and the UL donor antenna port, wherein the UL donor antenna port is configured to be coupled to an UL donor antenna, as shown in block 1440. The apparatus can further comprise a DL amplification and filtering path coupled between the server port and the DL donor antenna port, wherein the DL donor antenna port is configured to be coupled to a DL donor antenna that is separate from the UL donor antenna, as shown in block 1450.

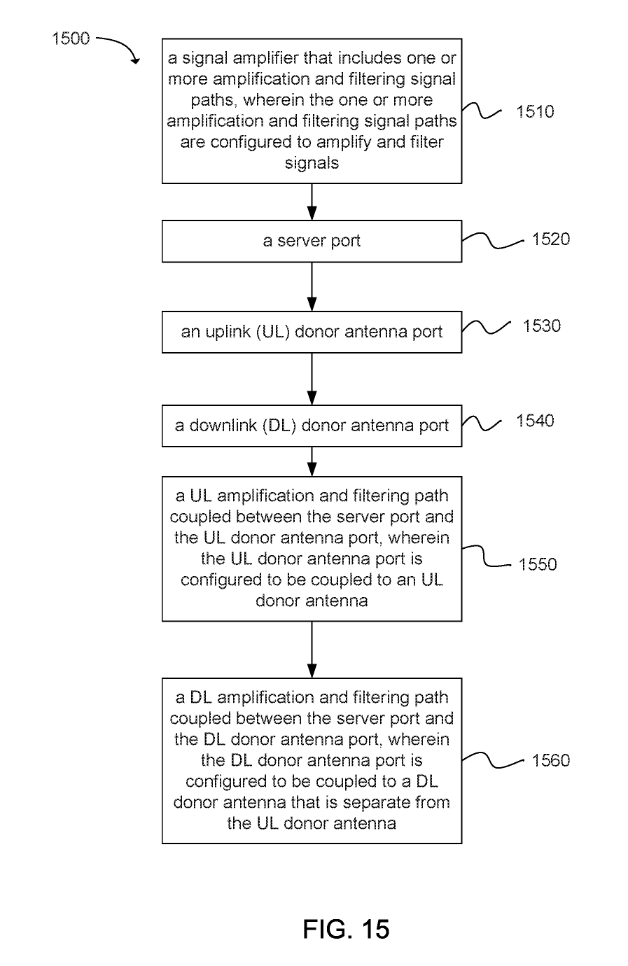

Another example provides an apparatus 1500 of a repeater, as shown in the flow chart in FIG. 15. The apparatus can comprise a signal amplifier that includes one or more amplification and filtering signal paths, wherein the one or more amplification and filtering signal paths are configured to amplify and filter signals, as shown in block 1510. The apparatus can further comprise a server port, as shown in block 1520. The apparatus can further comprise an uplink (UL) donor antenna port, as shown in block 1530. The apparatus can further comprise a downlink (DL) donor antenna port, as shown in block 1540. The apparatus can further comprise a UL amplification and filtering path coupled between the server port and the UL donor antenna port, wherein the UL donor antenna port is configured to be coupled to an UL donor antenna, as shown in block 1550. The apparatus can further comprise a DL amplification and filtering path coupled between the server port and the DL donor antenna port, wherein the DL donor antenna port is configured to be coupled to a DL donor antenna that is separate from the UL donor antenna, as shown in block 1560.

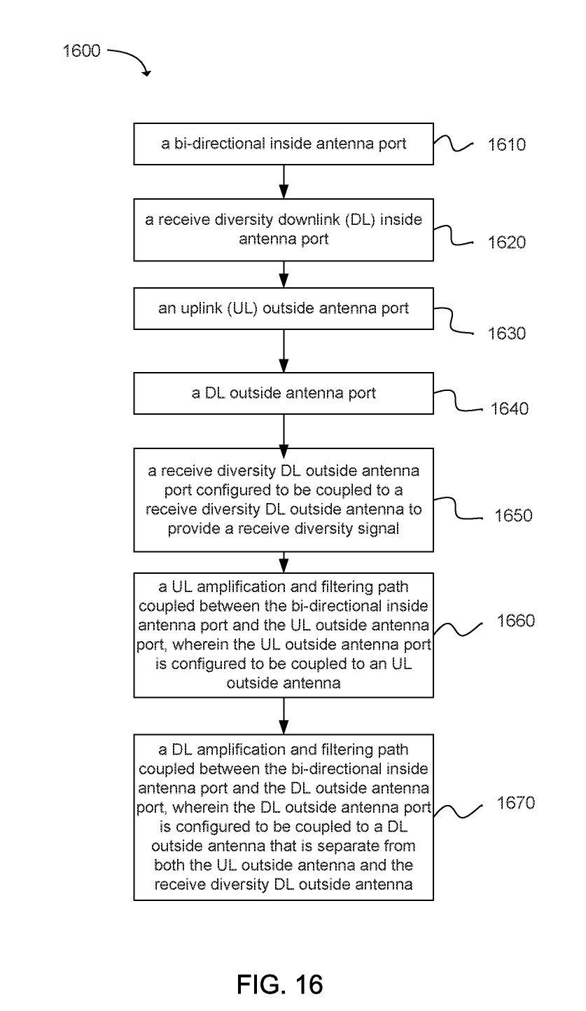

Another example provides an apparatus 1600 of a repeater, as shown in the flow chart in FIG. 16. The apparatus can comprise a bi-directional inside antenna port, as shown in block 1610. The apparatus can further comprise a receive diversity downlink (DL) inside antenna port, as shown in block 1620. The apparatus can further comprise an uplink (UL) outside antenna port, as shown in block 1630. The apparatus can further comprise a DL outside antenna port, as shown in block 1640. The apparatus can further comprise a receive diversity DL outside antenna port configured to be coupled to a receive diversity DL outside antenna to provide a receive diversity signal, as shown in block 1650. The apparatus can further comprise a UL amplification and filtering path coupled between the bi-directional inside antenna port and the UL outside antenna port, wherein the UL outside antenna port is configured to be coupled to an UL outside antenna, as shown in block 1660. The apparatus can further comprise a DL amplification and filtering path coupled between the bi-directional inside antenna port and the DL outside antenna port, wherein the DL outside antenna port is configured to be coupled to a DL outside antenna that is separate from both the UL outside antenna and the receive diversity DL outside antenna, as shown in block 1670.

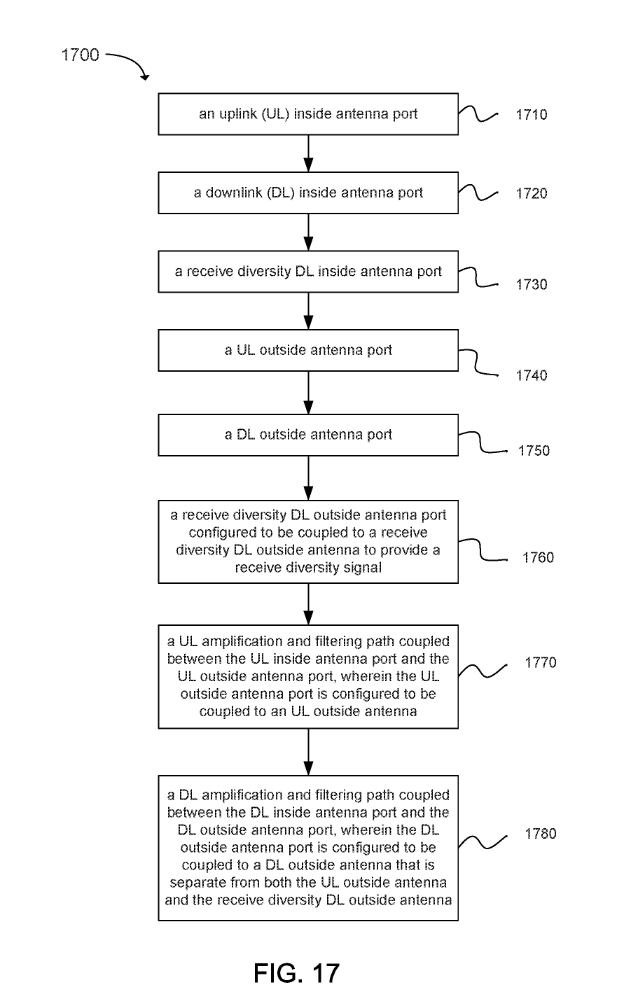

Another example provides an apparatus 1700 of a repeater, as shown in the flow chart in FIG. 17. The apparatus can comprise an uplink (UL) inside antenna port, as shown in block 1710. The apparatus can further comprise a downlink (DL) inside antenna port, as shown in block 1720. The apparatus can further comprise a receive diversity DL inside antenna port, as shown in block 1730. The apparatus can further comprise a UL outside antenna port, as shown in block 1740. The apparatus can further comprise a DL outside antenna port, as shown in block 1750. The apparatus can further comprise a receive diversity DL outside antenna port configured to be coupled to a receive diversity DL outside antenna to provide a receive diversity signal, as shown in block 1760. The apparatus can further comprise a UL amplification and filtering path coupled between the UL inside antenna port and the UL outside antenna port, wherein the UL outside antenna port is configured to be coupled to an UL outside antenna, as shown in block 1770. The apparatus can further comprise a DL amplification and filtering path coupled between the DL inside antenna port and the DL outside antenna port, wherein the DL outside antenna port is configured to be coupled to a DL outside antenna that is separate from both the UL outside antenna and the receive diversity DL outside antenna, as shown in block 1780.

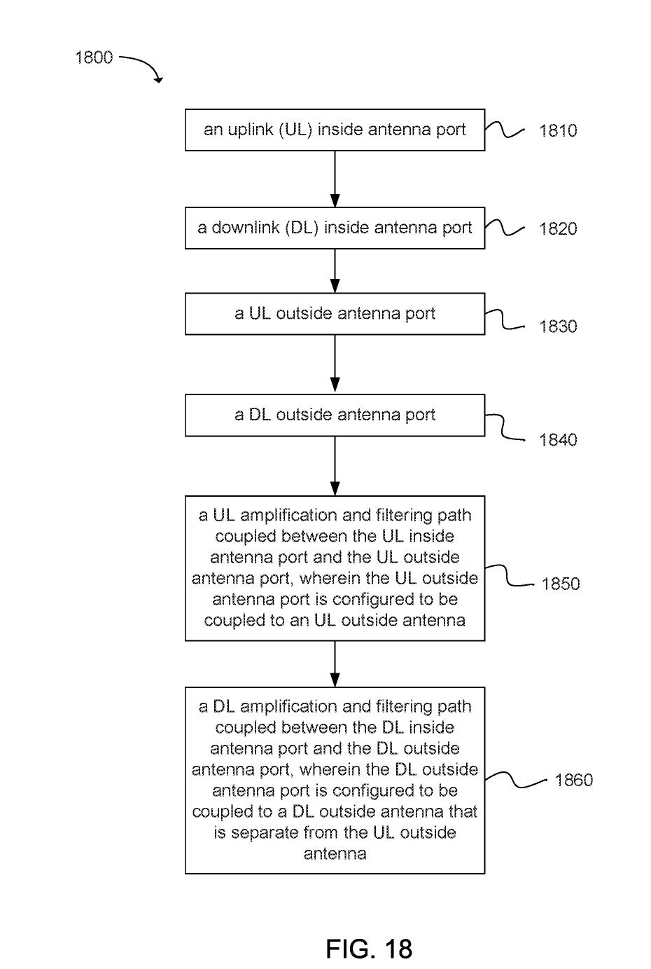

Another example provides an apparatus 1800 of a repeater, as shown in the flow chart in FIG. 18. The apparatus can comprise an uplink (UL) inside antenna port, as shown in block 1810. The apparatus can further comprise a downlink (DL) inside antenna port, as shown in block 1820. The apparatus can further comprise a UL outside antenna port, as shown in block 1830. The apparatus can further comprise a DL outside antenna port, as shown in block 1840. The apparatus can further comprise a UL amplification and filtering path coupled between the UL inside antenna port and the UL outside antenna port, wherein the UL outside antenna port is configured to be coupled to an UL outside antenna, as shown in block 1850. The apparatus can further comprise a DL amplification and filtering path coupled between the DL inside antenna port and the DL outside antenna port, wherein the DL outside antenna port is configured to be coupled to a DL outside antenna that is separate from the UL outside antenna, as shown in block 1860.

Embodiments of the repeater system advantageously integrate one or more donor antennas, one or more server antennas and a repeater into a pole. The one or more donor antennas can advantageously be located toward the top of the pole, and the one or more server antennas can be located toward the bottom of the pole. The one or more donor antennas can be advantageously located at the top of the pole to increase reception of uplink and downlink wireless communication signals between the repeater and one or more base stations. The one or more donor antennas located toward the top of the pole and the one or more server antennas located toward the bottom of the pole can also advantageously reduce oscillations in the repeater cause by signals transmitted by the one or more donor antennas being received at the one or more server antennas and feeding back to the repeater, and vice versa. Installation and setup can advantageously be simplified with the one or more donor antennas, the one or more server antennas and the repeater integrated with the pole. The pole with the one or more donor antennas, the one or more server antennas and the repeater integrated therein can also advantageously enable the repeater system to be portable.

### EXAMPLES

The following examples pertain to specific technology embodiments and point out specific features, elements, or actions that can be used or otherwise combined in achieving such embodiments.

Example 1 includes a repeater system, comprising: a pole; a server antenna carried by the pole; a donor antenna carried by the pole; and a repeater carried by the pole and electrically coupled to the server antenna and the donor antenna.

Example 2 includes the repeater system of Example 1, wherein a radiation pattern of the server antenna is configured to reduce radiation directed to the donor antenna to minimize feedback from the donor antenna, through the repeater, to the server antenna.

Example 3 includes the repeater system of Example 1, wherein a radiation pattern of the donor antenna is configured to reduce radiation directed to the server antenna to minimize feedback from the server antenna, through the repeater, to the donor antenna.

Example 4 includes the repeater system of Example 1, wherein the server antenna is fixably mounted to a first side of the pole and the donor antenna is fixably mounted to a second side of the pole that is opposite to the first side of the pole.

Example 5 includes the repeater system of Example 1, wherein the donor antenna and the repeater are fixably mounted to a first side of the pole and the server antenna is fixably mounted to a second side of the pole that is opposite to the first side of the pole.

Example 6 includes the repeater system of Example 1, wherein the server antenna and the repeater are fixably mounted to a first side of the pole, and the donor antenna is fixably mounted to a second side of the pole that is opposite to the first side of the pole.

Example 7 includes the repeater system of Example 1, wherein the donor antenna is comprised of a first downlink donor antenna and a second uplink donor antenna that are each carried by the pole.

Example 8 includes the repeater system of Example 1, further comprising a radiation shield carried by the pole and located between the server antenna and the donor antenna.

Example 9 includes the repeater system of Example 1, wherein the server antenna, the donor antenna, and the repeater are encompassed by the pole.

Example 10 includes the repeater system of Example 1, wherein the server antenna is detachably mounted to the pole to enable the server antenna to be detached from the pole and mounted adjacent to the pole.

Example 11 includes the repeater system of Example 1, wherein the pole is rotatably mounted to a marine vessel.

Example 12 includes the repeater system of Example 1, wherein the pole is rotatably mounted to an emergency response vehicle.

Example 13 includes the repeater system of Examples 11 and 12, wherein the rotatably mounted pole is configured to be rotated to a vertical direction with the donor antenna located near a top of the pole.

Example 14 includes the repeater system of Example 1, wherein the pole is mounted on a stand.

Example 15 includes the repeater system of Example 1, wherein the pole is mounted on a portable stand.

Example 16 includes the repeater system of Example 1, wherein the donor or server antenna is a directional antenna.

Example 17 includes the repeater system of Example 1, wherein the donor or server antenna is an electrically steered directional antenna.

Example 18 includes the repeater system of Example 1, wherein the donor or server antenna is a mechanically steered directional antenna.

Example 19 includes the repeater system of Example 1, wherein the donor antenna and the server antenna are omnidirectional antennas.

Example 20 includes the repeater system of Example 1, wherein the pole includes a plurality of sections configured to be removably couplable together.

Example 21 includes the repeater of Example 20, wherein the pole includes, the donor antenna carrier by a first section of the pole; the server antenna carried by a second section of the pole;

Example 22 includes the repeater of Example 21, wherein the pole includes, the repeater carried by the second section of the pole.

Example 23 includes the repeater of Example 22, wherein the pole includes, a third section of the pole disposed between the first and second section of the pole.

Example 24 includes the repeater of Example 21, wherein the pole includes, the repeater carried by a third section of the pole.

Example 25 includes the repeater of Example 24, wherein the pole includes, a fourth section of the pole disposed between the first and third section of the pole.

Example 26 includes a repeater system, comprising: a pole; a donor antenna carried by the pole; a server antenna located about the pole; and a repeater carried by the pole and electrically coupled to the server antenna and the donor antenna.

Example 27 includes the repeater system of Example 26, wherein the repeater is fixably mounted to a first side of the pole and the donor antenna is fixably mounted to a second side of the pole that is opposite to the first side of the pole.

Example 28 includes the repeater system of Example 26, wherein the repeater and the donor antenna are fixably mounted to a first side of the pole.

Example 29 includes the repeater system of Example 26, wherein the donor antenna is comprised of a first downlink donor antenna and a second uplink donor antenna.

Example 30 includes the repeater system of Example 26, wherein the donor antenna and the repeater are encompassed by the pole.

Example 31 includes the repeater system of Example 26, wherein the server antenna is mounted adjacent to the pole.

Example 32 includes the repeater system of Example 26, wherein the pole is rotatably mounted to a marine vessel.

Example 33 includes the repeater system of Example 26, wherein the pole is rotatably mounted to a first responder vehicle.

Example 34 includes the repeater system of Example 26, wherein the pole is a rotatably mounted pole that is configured to be rotated to a vertical direction with the donor antenna located near a top of the pole.

Example 35 includes the repeater system of Example 26, wherein the pole is mounted on a stand.

Example 36 includes the repeater system of Example 26, wherein the donor antenna is a directional antenna.

Example 37 includes the repeater system of Example 26, wherein the donor antenna and the server antenna are omnidirectional antennas.

Example 38 includes a repeater system, comprising: a pole; a donor antenna carried by the pole; a repeater carried by the pole and electrically coupled to a server antenna and the donor antenna; and a cradle carried about the pole, wherein the cradle has a first interface capable of selectively carrying a first user equipment and the server antenna that is configured to wirelessly couple one or more radio frequency (RF) communication signals to the first user equipment carried by the first interface of the cradle.

Example 39 includes the repeater system of Example 38, wherein the cradle is coupled to the pole.

Example 40 includes the repeater system of Example 38, wherein the cradle is located adjacent to the pole.

Example 41 includes the repeater system of Example 40, wherein the cradle is coupled to the repeater via a coaxial cable with a length of between 0.5 feet and 40 feet.

Example 42 includes the repeater system of Example 38, wherein a maximum gain of the repeater is one of 23 decibels (dB), 50 dB, 65 dB, or 72 dB at the server antenna.

Example 43 includes the repeater system of Example 38, wherein the maximum gain of the repeater automatically adjusts based on whether the UE is placed in the cradle or not.

Example 44 includes a repeater, comprising: a server port; an uplink (UL) donor antenna port; a downlink (DL) donor antenna port; a UL amplification and filtering path coupled between the server port and the UL donor antenna port, wherein the UL donor antenna port is configured to be coupled to an UL donor antenna; and a DL amplification and filtering path coupled between the server port and the DL donor antenna port, wherein the DL donor antenna port is configured to be coupled to a DL donor antenna that is separate from the UL donor antenna.

Example 45 includes the repeater of Example 44, further comprising: a receive diversity DL server port; and a receive diversity DL donor antenna port configured to be coupled to a receive diversity DL donor antenna to provide a receive diversity signal.

Example 46 includes the repeater of Example 45, further comprising: a receive diversity DL multiband filter on a receive diversity DL amplification and filtering path coupled between the receive diversity DL server port and the receive diversity DL donor antenna port, wherein the receive diversity DL multiband filter is configured to filter signals on two or more non-spectrally adjacent bands.

Example 47 includes the repeater of Example 46, wherein the receive diversity DL multiband filter comprises a plurality of bandpass filters in a single package, wherein the plurality of bandpass filters are impedance matched to enable operation in the single package.

Example 48 includes the repeater of Example 47, wherein the receive diversity DL multiband filter is a dual-common port multi-bandpass filter.

Example 49 includes the repeater of Example 45, wherein one or more of the UL amplification and filtering path or the DL amplification and filtering path or a receive diversity DL amplification and filtering path coupled between the receive diversity DL server port and the receive diversity DL donor antenna port is configured to switch between one or more of: the UL donor antenna port; the DL donor antenna port; or the receive diversity DL donor antenna port.

Example 50 includes the repeater of Example 45, wherein: the receive diversity DL donor antenna port is coupled to a receive diversity DL amplification and filtering path coupled between the receive diversity DL server port and the receive diversity DL donor antenna port.

Example 51 includes the repeater of Example 45, wherein the UL donor antenna port, the DL donor antenna port, or the receive diversity DL donor antenna port are configured to be coupled to one or more of an omnidirectional antenna or a directional antenna.

Example 52 includes the repeater of Example 44, wherein the UL donor antenna port is connected to a power amplifier without filtering between the power amplifier and the UL donor antenna port.

Example 53 includes the repeater of Example 44, wherein the UL donor antenna port is coupled to a power amplifier with low-order filtering coupled between the UL donor antenna port and the power amplifier to filter harmonics emitted by the power amplifier.

Example 54 includes the repeater of Example 44, wherein: the DL donor antenna port is connected to a low-noise amplifier without filtering between the low-noise amplifier and the DL donor antenna port; or the DL donor antenna port is coupled to a low-noise amplifier with a switchable filter between the low-noise amplifier and the DL donor antenna port.

Example 55 includes the repeater of Example 44, further comprising one or more of: a low-noise amplifier on the UL amplification and filtering path; a low-noise amplifier on the DL amplification and filtering path; a power amplifier on the UL amplification and filtering path; a power amplifier on the DL amplification and filtering path; a variable attenuator on the UL amplification and filtering path; a variable attenuator on the DL amplification and filtering path; a band-pass filter on the UL amplification and filtering path; or a band-pass filter on the DL amplification and filtering path.

Example 56includes the repeater of Example 44, wherein the repeater is configured to amplify signals in up to six bands, wherein each band comprises a separate amplification and filtering path.

Example 57 includes the repeater of Example 56, wherein the up to six bands are selected from one or more of: Third Generation Partnership Project (3GPP) Long Term Evolution (LTE) frequency bands 1 through 85, 3GPP 5G frequency bands 1 through 86, or 3GPP 5G frequency bands 257 through 261.

Example 58 includes the repeater of Example 44, wherein the repeater is a Federal Communications Commission (FCC)-compatible consumer signal booster.

Example 59 includes the repeater of Example 44, wherein one or more of the UL amplification and filtering path or the DL amplification and filtering path is configured to switch between one or more of: the UL donor antenna port; or the DL donor antenna port.

Example 60 includes the repeater of Example 44, further comprising one or more of: an UL multiband filter on the UL amplification and filtering path, wherein the UL multiband filter is configured to filter signals on two or more non-spectrally adjacent bands; or a DL multiband filter on the DL amplification and filtering path, wherein the DL multiband filter is configured to filter signals on two or more non-spectrally adjacent bands.

Example 61 includes the repeater of Example 60, wherein the UL multiband filter or the DL multiband filter comprises a plurality of bandpass filters in a single package, wherein the plurality of bandpass filters are impedance matched to enable operation in the single package.

Example 62 includes the repeater of Example 61, wherein the UL multiband filter or the DL multiband filter is a dual-common port multi-bandpass filter.

Example 63 includes the repeater of Example 44, further comprising a multiplexer configured to: couple the UL amplification and filtering path to the server port; and couple the DL amplification and filtering path to the server port.

Example 64 includes the repeater of Example 63, wherein the multiplexer is a diplexer, a duplexer, a multiplexer, a circulator, or a multi-common port multi-filter package.

Example 65 includes a repeater, comprising: a signal amplifier that includes one or more amplification and filtering signal paths, wherein the one or more amplification and filtering signal paths are configured to amplify and filter signals; a server port; an uplink (UL) donor antenna port; a downlink (DL) donor antenna port; a UL amplification and filtering path coupled between the server port and the UL donor antenna port, wherein the UL donor antenna port is configured to be coupled to an UL donor antenna; and a DL amplification and filtering path coupled between the server port and the DL donor antenna port, wherein the DL donor antenna port is configured to be coupled to a DL donor antenna that is separate from the UL donor antenna.

Example 66 includes the repeater of Example 65, further comprising: a receive diversity DL server port; and a receive diversity DL donor antenna port configured to be coupled to a receive diversity DL donor antenna to provide a receive diversity signal.

Example 67 includes the repeater of Example 66, wherein: the receive diversity DL donor antenna port is coupled to a receive diversity DL amplification and filtering path coupled between the receive diversity DL server port and the receive diversity DL donor antenna port.

Example 68 includes the repeater of Example 66, wherein the UL donor antenna port, the DL donor antenna port, or the receive diversity DL donor antenna port are configured to be coupled to one or more of an omnidirectional antenna or a directional antenna.

Example 69 includes the repeater of Example 65, wherein the UL donor antenna port is connected to a power amplifier without filtering between the power amplifier and the UL donor antenna port.

Example 70 includes the repeater of Example 65, wherein the UL donor antenna port is coupled to a power amplifier with low-order filtering coupled between the UL donor antenna port and the power amplifier to filter harmonics emitted by the power amplifier.

Example 71 includes the repeater of Example 65, wherein: the DL donor antenna port is connected to a low-noise amplifier without filtering between the low-noise amplifier and the DL donor antenna port; or the DL donor antenna port is coupled to a low-noise amplifier with a switchable filter between the low-noise amplifier and the DL donor antenna port.

Example 72 includes the repeater of Example 65, wherein the repeater is configured to amplify signals in up to six bands, wherein each band comprises a separate amplification and filtering path, and wherein the up to six bands are selected from one or more of: Third Generation Partnership Project (3GPP) Long Term Evolution (LTE) frequency bands 1 through 85, 3GPP 5G frequency bands 1 through 86, or 3GPP 5G frequency bands 257 through 261.

Example 73 includes the repeater of Example 65, wherein one or more of the UL amplification and filtering path or the DL amplification and filtering path is configured to switch between one or more of: the UL donor antenna port; or the DL donor antenna port.

Example 74 includes a repeater, comprising: a bi-directional inside antenna port; a receive diversity downlink (DL) inside antenna port; an uplink (UL) outside antenna port; a DL outside antenna port; a receive diversity DL outside antenna port configured to be coupled to a receive diversity DL outside antenna to provide a receive diversity signal; a UL amplification and filtering path coupled between the bi-directional inside antenna port and the UL outside antenna port, wherein the UL outside antenna port is configured to be coupled to an UL outside antenna; and a DL amplification and filtering path coupled between the bi-directional inside antenna port and the DL outside antenna port, wherein the DL outside antenna port is configured to be coupled to a DL outside antenna that is separate from both the UL outside antenna and the receive diversity DL outside antenna.

Example 75 includes the repeater of Example 74, wherein the receive diversity DL outside antenna port is coupled to a receive diversity DL amplification and filtering path coupled between the receive diversity DL inside antenna port and the receive diversity DL outside antenna port.

Example 76 includes the repeater of Example 75, further comprising: a receive diversity DL multiband filter on the receive diversity DL amplification and filtering path, wherein the receive diversity DL multiband filter is configured to filter signals on two or more non-spectrally adjacent bands.

Example 77 includes the repeater of Example 76, wherein the receive diversity DL multiband filter comprises a plurality of bandpass filters in a single package, wherein the plurality of bandpass filters are impedance matched to enable operation in the single package.

Example 78 includes the repeater of Example 77, wherein the receive diversity DL multiband filter is a dual-common port multi-bandpass filter.

Example 79 includes the repeater of Example 74, wherein the UL outside antenna port, the DL outside antenna port, or the receive diversity DL outside antenna port are configured to be coupled to one or more of an omnidirectional antenna or a directional antenna.

Example 80 includes the repeater of Example 74, wherein the UL outside antenna port is connected to a power amplifier without filtering between the power amplifier and the UL outside antenna port.

Example 81 includes the repeater of Example 74, wherein the UL outside antenna port is coupled to a power amplifier with a low-order filtering coupled between the UL outside antenna port and the power amplifier to filter harmonics emitted by the power amplifier.

Example 82 includes the repeater of Example 74, wherein: the DL outside antenna port is connected to a low-noise amplifier without filtering between the low-noise amplifier and the DL outside antenna port; or the DL outside antenna port is coupled to a low-noise amplifier with a switchable filter between the low-noise amplifier and the DL outside antenna port.

Example 83 includes the repeater of Example 74, further comprising one or more of: a low-noise amplifier on the UL amplification and filtering path; a low-noise amplifier on the DL amplification and filtering path; a power amplifier on the UL amplification and filtering path; a power amplifier on the DL amplification and filtering path; a variable attenuator on the UL amplification and filtering path; a variable attenuator on the DL amplification and filtering path; a band-pass filter on the UL amplification and filtering path; or a band-pass filter on the DL amplification and filtering path.

Example 84 includes the repeater of Example 74, wherein the repeater is configured to amplify signals in up to six bands, wherein each band comprises a separate amplification and filtering path.

Example 85 includes the repeater of Example 84, wherein the up to six bands are selected from one or more of: Third Generation Partnership Project (3GPP) Long Term Evolution (LTE) frequency bands 1 through 85, 3GPP 5G frequency bands 1 through 86, or 3GPP 5G frequency bands 257 through 261.

Example 86 includes the repeater of Example 74, wherein the repeater is a Federal Communications Commission (FCC)-compatible consumer signal booster.

Example 87 includes the repeater of Example 74, wherein one or more of the UL amplification and filtering path, the DL amplification and filtering path, or a receive diversity DL amplification and filtering path is configured to switch between one or more of: the UL outside antenna port; the DL outside antenna port; or the receive diversity DL outside antenna port.

Example 88 includes the repeater of Example 74, further comprising one or more of: an UL multiband filter on the UL amplification and filtering path, wherein the UL multiband filter is configured to filter signals on two or more non-spectrally adjacent bands; or a DL multiband filter on the DL amplification and filtering path, wherein the DL multiband filter is configured to filter signals on two or more non-spectrally adjacent bands.

Example 89 includes the repeater of Example 88, wherein the UL multiband filter or the DL multiband filter comprises a plurality of bandpass filters in a single package, wherein the plurality of bandpass filters are impedance matched to enable operation in the single package.

Example 90 includes the repeater of Example 89, wherein the UL multiband filter or the DL multiband filter is a dual-common port multi-bandpass filter.

Example 91 includes the repeater of Example 74, further comprising a multiplexer configured to: couple the UL amplification and filtering path to the bi-directional inside antenna port; and couple the DL amplification and filtering path to the bi-directional inside antenna port.

Example 92 includes the repeater of Example 91, wherein the multiplexer can be a diplexer, a duplexer, a multiplexer, a circulator, or a multi-common port multi-filter package.

Example 93 includes a repeater, comprising: an uplink (UL) inside antenna port; a downlink (DL) inside antenna port; a receive diversity DL inside antenna port; a UL outside antenna port; a DL outside antenna port; a receive diversity DL outside antenna port configured to be coupled to a receive diversity DL outside antenna to provide a receive diversity signal; a UL amplification and filtering path coupled between the UL inside antenna port and the UL outside antenna port, wherein the UL outside antenna port is configured to be coupled to an UL outside antenna; and a DL amplification and filtering path coupled between the DL inside antenna port and the DL outside antenna port, wherein the DL outside antenna port is configured to be coupled to a DL outside antenna that is separate from both the UL outside antenna and the receive diversity DL outside antenna.

Example 94 includes the repeater of Example 93, wherein the receive diversity DL outside antenna port is coupled to a receive diversity DL amplification and filtering path coupled between the receive diversity DL inside antenna port and the receive diversity DL outside antenna port.

Example 95 includes the repeater of Example 94, further comprising one or more of: a receive diversity DL multiband filter on the receive diversity DL amplification and filtering path, wherein the receive diversity DL multiband filter is configured to filter signals on two or more non-spectrally adjacent bands.

Example 96 includes the repeater of Example 95, wherein the receive diversity DL multiband filter comprises a plurality of bandpass filters in a single package, wherein the plurality of bandpass filters are impedance matched to enable operation in the single package.

Example 97 includes the repeater of Example 96, wherein the receive diversity DL multiband filter is a dual-common port multi-bandpass filter.

Example 98 includes the repeater of Example 93, wherein the UL outside antenna port, the DL outside antenna port, or the receive diversity DL outside antenna port are configured to be coupled to one or more of an omnidirectional antenna or a directional antenna.

Example 99 includes the repeater of Example 93, wherein the UL outside antenna port is connected to a power amplifier without filtering between the power amplifier and the UL outside antenna port.

Example 100 includes the repeater of Example 93, wherein the UL outside antenna port is coupled to a power amplifier with low-order filtering coupled between the UL outside antenna port and the power amplifier to filter harmonics emitted by the power amplifier.

Example 101 includes the repeater of Example 93, wherein: the DL outside antenna port is connected to a low-noise amplifier without filtering between the low-noise amplifier and the DL outside antenna port; or the DL outside antenna port is coupled to a low-noise amplifier with a switchable filter between the low-noise amplifier and the DL outside antenna port.

Example 102 includes the repeater of Example 93, further comprising one or more of: a low-noise amplifier on the UL amplification and filtering path; a low-noise amplifier on the DL amplification and filtering path; a power amplifier on the UL amplification and filtering path; a power amplifier on the DL amplification and filtering path; a variable attenuator on the UL amplification and filtering path; a variable attenuator on the DL amplification and filtering path; a band-pass filter on the UL amplification and filtering path; or a band-pass filter on the DL amplification and filtering path.

Example 103 includes the repeater of Example 93, wherein the repeater is configured to amplify signals in up to six bands, wherein each band comprises a separate amplification and filtering path.

Example 104 includes the repeater of Example 103, wherein the up to six bands are selected from one or more of: Third Generation Partnership Project (3GPP) Long Term Evolution (LTE) frequency bands 1 through 85, 3GPP 5G frequency bands 1 through 86, or 3GPP 5G frequency bands 257 through 261.

Example 105 includes the repeater of Example 93, wherein the repeater is a Federal Communications Commission (FCC)-compatible consumer signal booster.

Example 106 includes the repeater of Example 93, wherein one or more of the UL amplification and filtering path, the DL amplification and filtering path, or a receive diversity DL amplification and filtering path is configured to switch between one or more of: the UL outside antenna port; the DL outside antenna port; or the receive diversity DL outside antenna port.

Example 107 includes the repeater of Example 93, further comprising one or more of: an UL multiband filter on the UL amplification and filtering path, wherein the UL multiband filter is configured to filter signals on two or more non-spectrally adjacent bands; or a DL multiband filter on the DL amplification and filtering path, wherein the DL multiband filter is configured to filter signals on two or more non-spectrally adjacent bands.

Example 108 includes the repeater of Example 107, wherein the UL multiband filter or the DL multiband filter comprises a plurality of bandpass filters in a single package, wherein the plurality of bandpass filters are impedance matched to enable operation in the single package.

Example 109 includes the repeater of Example 108, wherein the UL multiband filter or the DL multiband filter is a dual-common port multi-bandpass filter.

Example 110 includes a repeater, comprising: an uplink (UL) inside antenna port; a downlink (DL) inside antenna port; a UL outside antenna port; a DL outside antenna port; a UL amplification and filtering path coupled between the UL inside antenna port and the UL outside antenna port, wherein the UL outside antenna port is configured to be coupled to an UL outside antenna; and a DL amplification and filtering path coupled between the DL inside antenna port and the DL outside antenna port, wherein the DL outside antenna port is configured to be coupled to a DL outside antenna that is separate from the UL outside antenna.

Example 111 includes the repeater of Example 110, further comprising: a receive diversity DL inside antenna port; and a receive diversity DL outside antenna port configured to be coupled to a receive diversity DL outside antenna to provide a receive diversity signal.

Example 112 includes the repeater of Example 111, wherein: the receive diversity DL outside antenna port is coupled to a receive diversity DL amplification and filtering path coupled between the receive diversity DL inside antenna port and the receive diversity DL outside antenna port.

Example 113 includes the repeater of Example 111, wherein the UL outside antenna port, the DL outside antenna port, or the receive diversity DL outside antenna port are configured to be coupled to one or more of an omnidirectional antenna or a directional antenna.

Example 114 includes the repeater of Example 110, wherein the UL outside antenna port is connected to a power amplifier without filtering between the power amplifier and the UL outside antenna port.

Example 115 includes the repeater of Example 110, wherein the UL outside antenna port is coupled to a power amplifier with low-order filtering coupled between the UL outside antenna port and the power amplifier to filter harmonics emitted by the power amplifier.

Example 116 includes the repeater of Example 110, wherein: the DL outside antenna port is connected to a low-noise amplifier without filtering between the low-noise amplifier and the DL outside antenna port; or the DL outside antenna port is coupled to a low-noise amplifier with a switchable filter between the low-noise amplifier and the DL outside antenna port.

Example 117 includes the repeater of Example 110, further comprising one or more of: a low-noise amplifier on the UL amplification and filtering path; a low-noise amplifier on the DL amplification and filtering path; a power amplifier on the UL amplification and filtering path; a power amplifier on the DL amplification and filtering path; a variable attenuator on the UL amplification and filtering path; a variable attenuator on the DL amplification and filtering path; a band-pass filter on the UL amplification and filtering path; or a band-pass filter on the DL amplification and filtering path.

Example 118 includes the repeater of Example 110, wherein the repeater is configured to amplify signals in up to six bands, wherein each band comprises a separate amplification and filtering path.

Example 119 includes the repeater of Example 118, wherein the up to six bands are selected from one or more of: Third Generation Partnership Project (3GPP) Long Term Evolution (LTE) frequency bands 1 through 85, 3GPP 5G frequency bands 1 through 86, or 3GPP 5G frequency bands 257 through 261.

Example 120 includes the repeater of Example 110, wherein the repeater is a Federal Communications Commission (FCC)-compatible consumer signal booster.

Example 121 includes the repeater of Example 110, wherein one or more of the UL amplification and filtering path or the DL amplification and filtering path is configured to switch between one or more of: the UL outside antenna port; or the DL outside antenna port.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

Various techniques, or certain aspects or portions thereof, may take the form of program code (i.e., instructions) embodied in tangible media, such as floppy diskettes, compact disc-read-only memory (CD-ROMs), hard drives, transitory or non-transitory computer readable storage medium, or any other machine-readable storage medium wherein, when the program code is loaded into and executed by a machine, such as a computer, the machine becomes an apparatus for practicing the various techniques. Circuitry may include hardware, firmware, program code, executable code, computer instructions, and/or software. A non-transitory computer readable storage medium may be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term processor may include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module cannot be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology may be referred to herein along with alternatives for the various components thereof. It is understood that such embodiments, examples, and alternatives are not to be construed as de facto equivalents of one another, but are to be considered as separate and autonomous representations of the present technology.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology may be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation may be made without the exercise of inventive faculty, and without departing from the principles and concepts of the technology. Accordingly, it is not intended that the technology be limited, except as by the claims set forth below.

What is claimed is:

1. A repeater, comprising:
a server port;
an uplink (UL) donor antenna port;
a downlink (DL) donor antenna port;
a UL amplification and filtering path coupled between the server port and the UL donor antenna port, wherein the UL donor antenna port is configured to be coupled to an UL donor antenna; and
a DL amplification and filtering path coupled between the server port and the DL donor antenna port, wherein the DL donor antenna port is configured to be coupled to a DL donor antenna that is separate from the UL donor antenna.

2. The repeater of claim 1, further comprising:
a receive diversity DL server port; and
a receive diversity DL donor antenna port configured to be coupled to a receive diversity DL donor antenna to provide a receive diversity signal.

3. The repeater of claim 2, further comprising:
a receive diversity DL multiband filter on a receive diversity DL amplification and filtering path coupled between the receive diversity DL server port and the receive diversity DL donor antenna port, wherein the receive diversity DL multiband filter is configured to filter signals on two or more non-spectrally adjacent bands.

4. The repeater of claim 3, wherein the receive diversity DL multiband filter comprises a plurality of bandpass filters in a single package, wherein the plurality of bandpass filters are impedance matched to enable operation in the single package.

5. The repeater of claim 4, wherein the receive diversity DL multiband filter is a dual-common port multi-bandpass filter.

6. The repeater of claim 2, wherein one or more of the UL amplification and filtering path or the DL amplification and filtering path or a receive diversity DL amplification and filtering path coupled between the receive diversity DL server port and the receive diversity DL donor antenna port is configured to switch between one or more of:
the UL donor antenna port;
the DL donor antenna port; or
the receive diversity DL donor antenna port.

7. The repeater of claim 2, wherein:
the receive diversity DL donor antenna port is coupled to a receive diversity DL amplification and filtering path coupled between the receive diversity DL server port and the receive diversity DL donor antenna port.

8. The repeater of claim 2, wherein the UL donor antenna port, the DL donor antenna port, or the receive diversity DL donor antenna port are configured to be coupled to one or more of an omnidirectional antenna or a directional antenna.

9. The repeater of claim 1, wherein the UL donor antenna port is connected to a power amplifier without filtering between the power amplifier and the UL donor antenna port.

10. The repeater of claim 1, wherein the UL donor antenna port is coupled to a power amplifier with low-order filtering coupled between the UL donor antenna port and the power amplifier to filter harmonics emitted by the power amplifier.

11. The repeater of claim 1, wherein:
the DL donor antenna port is connected to a low-noise amplifier without filtering between the low-noise amplifier and the DL donor antenna port; or
the DL donor antenna port is coupled to a low-noise amplifier with a switchable filter between the low-noise amplifier and the DL donor antenna port.

12. The repeater of claim 1, further comprising one or more of:
a low-noise amplifier on the UL amplification and filtering path;
a low-noise amplifier on the DL amplification and filtering path;
a power amplifier on the UL amplification and filtering path;
a power amplifier on the DL amplification and filtering path;
a variable attenuator on the UL amplification and filtering path;
a variable attenuator on the DL amplification and filtering path;
a band-pass filter on the UL amplification and filtering path; or
a band-pass filter on the DL amplification and filtering path.

13. The repeater of claim 1, wherein the repeater is configured to amplify signals in up to six bands, wherein each band comprises a separate amplification and filtering path.

14. The repeater of claim 13, wherein the up to six bands are selected from one or more of: Third Generation Partnership Project (3GPP) Long Term Evolution (LTE) frequency bands 1 through 85, 3GPP 5G frequency bands 1 through 86, or 3GPP 5G frequency bands 257 through 261.

15. The repeater of claim 1, wherein the repeater is a Federal Communications Commission (FCC)-compatible consumer signal booster.

16. The repeater of claim 1, wherein one or more of the UL amplification and filtering path or the DL amplification and filtering path is configured to switch between one or more of:
the UL donor antenna port; or
the DL donor antenna port.

17. The repeater of claim 1, further comprising one or more of:
an UL multiband filter on the UL amplification and filtering path, wherein the UL multiband filter is configured to filter signals on two or more non-spectrally adjacent bands; or
a DL multiband filter on the DL amplification and filtering path, wherein the DL multiband filter is configured to filter signals on two or more non-spectrally adjacent bands.

18. The repeater of claim 17, wherein the UL multiband filter or the DL multiband filter comprises a plurality of bandpass filters in a single package, wherein the plurality of bandpass filters are impedance matched to enable operation in the single package.

19. The repeater of claim 18, wherein the UL multiband filter or the DL multiband filter is a dual-common port multi-bandpass filter.

20. The repeater of claim 1, further comprising a multiplexer configured to:
couple the UL amplification and filtering path to the server port; and
couple the DL amplification and filtering path to the server port.

21. The repeater of claim 20, wherein the multiplexer is a diplexer, a duplexer, a multiplexer, a circulator, or a multi-common port multi-filter package.

22. A repeater, comprising:
a signal amplifier that includes one or more amplification and filtering signal paths, wherein the one or more amplification and filtering signal paths are configured to amplify and filter signals;
a server port;
an uplink (UL) donor antenna port;
a downlink (DL) donor antenna port;
a UL amplification and filtering path coupled between the server port and the UL donor antenna port, wherein the UL donor antenna port is configured to be coupled to an UL donor antenna; and
a DL amplification and filtering path coupled between the server port and the DL donor antenna port, wherein the DL donor antenna port is configured to be coupled to a DL donor antenna that is separate from the UL donor antenna.

23. The repeater of claim 22, further comprising:
a receive diversity DL server port; and
a receive diversity DL donor antenna port configured to be coupled to a receive diversity DL donor antenna to provide a receive diversity signal.

24. The repeater of claim 23, wherein:
the receive diversity DL donor antenna port is coupled to a receive diversity DL amplification and filtering path coupled between the receive diversity DL server port and the receive diversity DL donor antenna port.

25. The repeater of claim 23, wherein the UL donor antenna port, the DL donor antenna port, or the receive diversity DL donor antenna port are configured to be coupled to one or more of an omnidirectional antenna or a directional antenna.

26. The repeater of claim 22, wherein the UL donor antenna port is connected to a power amplifier without filtering between the power amplifier and the UL donor antenna port.

27. The repeater of claim 22, wherein the UL donor antenna port is coupled to a power amplifier with low-order filtering coupled between the UL donor antenna port and the power amplifier to filter harmonics emitted by the power amplifier.

28. The repeater of claim 22, wherein:
the DL donor antenna port is connected to a low-noise amplifier without filtering between the low-noise amplifier and the DL donor antenna port; or
the DL donor antenna port is coupled to a low-noise amplifier with a switchable filter between the low-noise amplifier and the DL donor antenna port.

29. The repeater of claim 22, wherein the repeater is configured to amplify signals in up to six bands, wherein each band comprises a separate amplification and filtering path, and wherein the up to six bands are selected from one or more of: Third Generation Partnership Project (3GPP) Long Term Evolution (LTE) frequency bands 1 through 85, 3GPP 5G frequency bands 1 through 86, or 3GPP 5G frequency bands 257 through 261.

30. The repeater of claim 22, wherein one or more of the UL amplification and filtering path or the DL amplification and filtering path is configured to switch between one or more of:
the UL donor antenna port; or
the DL donor antenna port.
